(19) United States
(12) Patent Application Publication
(10) Pub. No.: US 2007/0085227 A1
(43) Pub. Date: Apr. 19, 2007

(54) Multi-phase contacting process using microchannel technology

(76) Inventors: Anna Lee Tonkovich, Dublin, OH (US); Maddalena Fanelli, Columbus, OH (US); Ravi Arora, New Albany, OH (US); Timothy J. Sullivan, Dublin, OH (US); Steven T. Perry, Galloway, OH (US); David J. Kuhlmann, Powell, OH (US)

Correspondence Address: NEIL A. DUCHEZ (VELOCYS);RENNER, OTTO, BOISSELLE & SKLAR, LLP, 1621 EUCLID AVENUE, 19TH FLOOR, CLEVELAND, OH, 44115, US

(21) Appl. No.: 11/483,136

(22) Filed: Jul. 7, 2006

Related U.S. Application Data
(60) Provisional application No. 60/727,126, filed on Oct. 13, 2005.
(60) Provisional application No. 60/731,596, filed on Oct. 27, 2005.
(60) Provisional application No. 60/785,732, filed on Mar. 23, 2006.

(51) Int. Cl. B01F 3/04; F28D 7/00

(52) U.S. Cl. 261/127; 422/200

(57) ABSTRACT

The disclosed technology relates to a process for contacting a liquid phase and a second fluid phase, comprising: flowing the liquid phase and/or second fluid phase in a process microchannel in contact with surface features in the process microchannel, the contacting of the surface features with the liquid phase and/or second fluid phase imparting a disruptive flow to the liquid phase and/or second fluid phase; contacting the liquid phase with the second fluid phase in the process microchannel; and transferring mass from the liquid phase to the second fluid phase and/or from the second fluid phase to the liquid phase.

This application claims the benefit under 35 U.S.C. §120 to U.S. application Ser. No. 11/177,941, filed Jul. 8, 2005. This application claims the benefit under 35 U.S.C. §119(e) to U.S. Provisional Application Ser. No. 60/727,126, filed Oct. 13, 2005, U.S. Provisional Application Ser. No. 60/731,596, filed Oct. 27, 2005, and U.S. Provisional Application Ser. No. 60/785,732, filed Mar. 23, 2006. These applications are incorporated herein by reference in their entireties.

This invention was made with Government support under Contract DE-FC36-04G014271 awarded by the United States Department of Energy. The Government has certain rights in this invention.

### TECHNICAL FIELD

The disclosed technology relates to a multi-phase contacting process conducted in a microchannel. The process may comprise any multi-phase contacting process wherein mass transfer between a liquid phase and a second fluid phase occurs. The second fluid phase may comprise a liquid, gas, or mixture thereof. The process may be a distillation process, absorption process, stripping process, or rectification process, or a combination of two or more thereof.

### BACKGROUND

Mass transfer may involve the transfer of one or more components from one discrete phase (e.g., a gas phase) to another discrete phase (e.g., a liquid phase). Processes involving the use of mass transfer may include distillation, absorption, extraction, and the like. A problem with many of these mass transfer processes is that they employ relatively large pieces of equipment that are highly inefficient with respect to energy consumption. For example, distillation accounts for about a quadrillion BTUs of energy consumption per year in the United States. Conventional distillation systems may reduce lost work and increase plant energy efficiency by incorporating capital-intensive reboilers at multiple sections. However, the capital cost of adding multiple reboilers to conventional distillation columns is typically prohibitive. The trade-off between energy and capital often results in favoring the lower cost solution. The efficiency of mass transfer stages in distillation columns may be set by the effectiveness of trays or packing, which have not changed significantly in many years. For the separation of components with similar boiling points, such as ethane from ethylene, commercial distillation columns may be hundreds of feet high, due to the need to use many mass transfer stages. Another problem relates to the fact that the equipment (e.g., distillation columns, reboilers, condensers, etc.) used in many distillation processes requires relatively large internal volumes for processing the materials being treated. These large internal volumes may render the equipment slow to respond to changes in operating conditions (e.g., temperature, etc.). This may make the processes using this equipment slow to start up and subject to imprecise control.

### SUMMARY

The disclosed technology, in at least one embodiment, may provide a solution to one or more of these problems by using microchannel technology. With the present invention, in one embodiment, process intensification may be achieved through the use of stacked layers of thin sheets of material with stamped, etched or piece-wise assembled channels, that is, microchannels, providing narrow flow paths with short diffusion distances for mass transfer. The use of these microchannels may provide for reductions in the required flow length of process sections dominated by mass transfer, resulting in relatively short processing units. Heat inputs and outputs may be closely integrated with the flow of the liquid and gas in the process microchannel.

The disclosed technology relates to a process for contacting a liquid phase and a second fluid phase, comprising: flowing the liquid phase and/or second fluid phase in a process microchannel in contact with surface features in the process microchannel, the contacting of the surface features with the liquid phase and/or the second fluid phase imparting a disruptive flow to the liquid phase and/or second fluid phase; contacting the liquid phase with the second fluid phase in the process microchannel; and transferring mass from the liquid phase to the second fluid phase and/or from the second fluid phase to the liquid phase.

In one embodiment, the liquid phase is in the form of a contiguous liquid phase over at least part of the length of the process microchannel, the second fluid phase is in the form of a contiguous fluid phase over at least part of the length of the process microchannel, the contacting between the liquid phase and the second fluid phase occurring at an interface between the liquid phase and the second fluid phase.

In one embodiment, the process microchannel comprises a first interior wall, a second opposite interior wall, and a gap positioned between the first interior wall and the second interior wall, the surface features being positioned on and/or in the first interior wall, the liquid phase being in the form of a contiguous liquid phase over at least part of the length of the process microchannel, the second fluid phase being in the form of a contiguous fluid phase over at least part of the length of the process microchannel, the second fluid phase contacting the liquid phase at an interface, the bulk flow of the liquid phase being in the gap between the surface features and the interface, the contacting of the surface features by the liquid phase causing at least part of the liquid phase to flow towards the interface.

In one embodiment, the process microchannel comprises a first interior wall, a second opposite interior wall, and a gap positioned between the first interior wall and the second interior wall, the surface features being positioned on and/or in the second interior wall, the liquid phase being in the form of a contiguous liquid phase over at least part of the length of the process microchannel, the second fluid phase being in the form of a contiguous fluid phase over at least part of the length of the process microchannel, the second fluid phase contacting the liquid phase at an interface, the bulk flow of the second fluid phase being in the gap between the surface features and the interface, the contacting of the surface features by the second fluid phase causing at least part of the second fluid phase to flow towards the interface.

In one embodiment, the process microchannel comprises a first interior wall, a second opposite interior wall, and a gap positioned between the first interior wall and the second interior wall, the surface features being positioned on and/or in the first interior wall and the second interior wall, the liquid phase being in the form of a contiguous liquid phase over at least part of the length of the process microchannel, the second fluid phase being in the form of a contiguous fluid phase over at least part of the length of the process microchannel, the second fluid phase contacting the liquid phase at an interface, the bulk flow of the liquid phase being in the gap and being between the first interior wall and the interface, the bulk flow of the second fluid phase being in the gap and being between the second interior wall and the interface, the liquid phase contacting the surface features on and/or in the first interior wall, the contacting of the surface features on and/or in the first interior wall by the liquid phase causing at least part of the liquid phase to flow towards the interface, the second fluid phase contacting the surface features on and/or in the second interior wall, the contacting of the surface features on and/or in the second interior wall by the second fluid phase causing at least part of the second fluid phase to flow towards the interface.

In one embodiment, the liquid phase is in the form of a contiguous liquid phase over at least part of the length of the process microchannel, the second fluid phase is in the form of a contiguous fluid phase over at least part of the length of the process microchannel, a contactor is positioned between the liquid phase and the second fluid phase.

In one embodiment, the contactor has a first surface facing the liquid phase and a second surface facing the second fluid phase, the first and/or second surface of the contactor containing surface features in the form of depressions in and/or projections from the first surface and/or second surface.

In one embodiment, the first surface of the contactor contains surface features in the form of depressions in and/or projections from the first surface.

In one embodiment, the second surface of the contactor contains surface features in the form of depressions in and/or projections from the second surface.

In one embodiment, the liquid phase and the second fluid phase are mixed with each other in the process microchannel.

In one embodiment, the process may be conducted in a microchannel processing unit, the microchannel processing unit comprising a plurality of the process microchannels, at least one header, and at least one footer. In one embodiment, the header and/or footer may have only one phase in it.

In one embodiment, the process may be conducted in a distillation unit, the distillation unit comprising a plurality of the process microchannels. The distillation unit may be used with at least one condenser, and/or at least one reboiler. The condenser and/or reboiler may be contained within the microchannel distillation unit, or either or both may be added as separate discrete hardware.

In one embodiment, a mixture of the liquid and the second fluid flow into the process microchannel, and separate phases flow out of the process microchannel, one of the separate phases comprising the liquid and one of the separate phases comprising the second fluid.

In one embodiment, a mixture of the liquid and the second fluid flow into the process microchannel, and separate outlet streams flow out of the process microchannel, one of the outlet streams comprising the liquid and one of the outlet streams comprising the second fluid.

The liquid phase may comprise any liquid. The second fluid phase may comprise any gas, liquid or mixture thereof. The liquid of the liquid phase and the liquid of the second fluid phase may be partly miscible or immiscible with each other. The liquid phase and/or second fluid phase may comprise a phase transfer catalyst.

In one embodiment, a chemical reaction may be conducted in the process microchannel.

In one embodiment, the disclosed technology relates to a process for contacting a liquid phase and a second fluid phase, comprising: flowing the liquid phase and/or second fluid phase in a process microchannel in contact with surface features in the process microchannel, the superficial velocity of the liquid phase being at least about 0.1 m/s, the contacting of the surface features with the liquid phase and/or the second fluid phase imparting a disruptive flow to the liquid phase and/or second fluid phase; contacting the liquid phase with the second fluid phase in the process microchannel; and transferring mass from the liquid phase to the second fluid phase and/or from the second fluid phase to the liquid phase.

In one embodiment, the disclosed technology relates to a process for contacting a liquid and a second fluid, comprising: flowing a mixture of the liquid and the second fluid in a process microchannel in contact with surface features in the process microchannel, the contacting of the surface features with the liquid and the second fluid imparting a disruptive flow to the liquid and the second fluid; and transferring mass from the liquid to the second fluid phase and/or from the second phase to the liquid.

In one embodiment, the disclosed technology relates to a process for contacting a liquid and a second fluid, comprising: flowing a mixture of the liquid the second fluid in a process microchannel in contact with surface features in the process microchannel, the contacting of the surface features with the liquid and the second fluid imparting a disruptive flow to the liquid and second fluid; transferring mass from the liquid to the second fluid and from the second fluid to the liquid; and removing separate streams from the process microchannel, one of the separate streams comprising the liquid, and one of the separate streams comprising the second fluid.

### BRIEF DESCRIPTION OF THE DRAWINGS

In the annexed drawings, like parts and features have like designations. A number of the drawings provided herein are schematic illustrations which may not be drawn to scale or proportioned accurately.

FIG. 1 is a schematic illustration of a process microchannel that may be used with the disclosed process.

FIGS. 2A-2D are schematic illustrations of microchannel processing units that may be used in accordance with the disclosed process. The microchannel processing units illustrated in FIGS. 2A, 2B and 2C comprise a microchannel processing unit core, at least one header, and at least one footer. The microchannel processing unit illustrated in FIG. 2D is a microchannel distillation assembly which comprises a microchannel distillation unit which may include a condenser and/or reboiler.

FIG. 3 is a schematic illustration of a process microchannel that may be used in accordance with the disclosed process.

FIG. 4 is a schematic illustration of an alternate embodiment of a process microchannel that may be used in accordance with the disclosed process.

FIGS. 5-23 are schematic illustrations of surface features that may be employed in the process microchannel used with the disclosed process.

FIGS. 24-27 are schematic illustrations of microchannel repeating units that may be used in the microchannel processing units illustrated in FIGS. 2A-2D.

FIG. 28 is a schematic illustration of a wall of a process microchannel that may employ dual depth surface features that promote capillary retention and mixing.

FIGS. 29-35 are schematic illustrations of surface features that may be employed in the process microchannel used with the disclosed process.

FIGS. 36-39 are schematic illustrations of shims that may be used to form a microchannel processing unit core for use with the disclosed process.

FIG. 40 is a schematic illustration of a shim stacking orientation that may be used with the shims illustrated in FIGS. 36-39.

FIG. 41 is a schematic illustration of an alternate embodiment of the shim illustrated in FIG. 38.

FIGS. 42-45 are schematic illustrations of shims that may be stacked to form a process microchannel for use with the disclosed process.

FIG. 46 is a schematic illustration of the shims illustrated in FIGS. 42-45 stacked to form part of a process microchannel which may be used with the disclosed process.

FIGS. 47-48 are schematic illustrations of shims that may be stacked to form a process microchannel for use with the disclosed process.

FIG. 49 is a schematic illustration of a microchannel processing unit formed using the shims illustrated in FIGS. 47 and 48.

FIG. 50 is a schematic illustration of an exploded view of the microchannel processing unit disclosed in Example 1.

FIG. 51 is a schematic illustration of the flow distribution feature section for the microchannel processing unit disclosed in Example 1. In this figure all dimensions are in inches.

FIGS. 52-53 are schematic illustrations of surface feature patterns used in the microchannel processing unit disclosed in Example 1. In these figures, all dimensions are in inches.

FIG. 54 is a schematic illustration of a first channel configuration which is disclosed in Example 1.

FIG. 55 is a schematic illustration of a second channel configuration which is disclosed in Example 1.

FIG. 56 is a top surface view of the channel configuration illustrated in FIG. 55.

FIGS. 57-60 are plots that show the relative residence time of tracer particles in the surface features for test runs disclosed in Example 1.

FIGS. 61-74 are representative profiles for the test runs 1-14, respectively, disclosed in Table 1 for Example 2. The results are shown in terms of path lines released from the vertical and horizontal inlet center lines, a and c and b and d, respectively. Figs a and b show the path lines viewed from the channel side. Figs c and d show the path lines viewed from the exit plane of the channel. All views are orthographic. The channel inlet is shown for reference.

FIGS. 75 and 76 are plots showing concentration measurements indicating the degree of conversion of material A in response to contact with the upper channel wall for the test runs disclosed in Table 1 of Example 2. Measurements begin after the initial 2.54 mm featureless section, which is taken as the 0 point of the normalized channel length. The channel length is normalized upon division by 25.4 mm which is the channel length. The legend numbers correspond to mole fraction of A numbers in Table 1 of Example 2.

FIG. 77 is a plan view of the geometry of the surface features simulated by Computational Fluid Dynamics (CFD) in Example 3.

FIG. 78 is an isometric view of the microchannel with surface features simulated by CFD in Example 3.

FIG. 79 shows the path lines of flow beginning along the horizontal center line of the inlet plane looking down the access of flow from the inlet plane for the process disclosed in Example 3.

FIG. 80 discloses path lines of flow beginning along the horizontal center line of the inlet plane as viewed from the side for the process disclosed in Example 3.

FIG. 81 discloses path lines of flow beginning along the vertical center line of the inlet plane looking down the access of flow from the inlet plane for the process disclosed in Example 3. Flow rotates (spirals) along the channel length.

FIG. 82 is an isometric view of the process microchannel, which contains surface features, that is simulated in Example 4.

FIG. 83 shows path lines of flow beginning along the horizontal center line of the inlet plane for the process disclosed in Example 4.

FIG. 84 discloses path lines of flow along the horizontal center line of the inlet plane looking down the access of flow from the inlet plane for the process disclosed in Example 4.

FIG. 85 discloses path lines of flow beginning along the vertical center line of the inlet plane looking down the access of flow from the inlet plane for the process disclosed in Example 4.

FIG. 86 discloses one-sided (FIG. 86a) and two-sided (FIG. 86b) surface feature configurations for the test runs disclosed in Example 5.

FIG. 87 discloses representative rib orientations for the test runs disclosed in Example 5. The rib orientations are trans (FIG. 87a), cis A (FIG. 87b), and cis B (FIG. 87c).

FIGS. 88-96 show representative profiles for the test runs disclosed in Example 5. Results are shown in terms of path lines released from the vertical and horizontal inlet center-lines, a and b and c and d, respectively. Figs. a and c of each of FIGS. 88-96 show the path lines viewed from the exit plane of the channel. Figs. b and d show the path lines viewed from the channel side. All views are orthographic. The channel inlet is shown for reference.

FIG. 97 discloses channel geometry, which includes chevron shaped surface features (FIG. 97a) and path line profiles (FIGS. 97b and 97c) for the test runs disclosed in Example 6. FIGS. 97b and 97c show the formation of vortices spanning the chevron legs of the surface features. FIG. 97b shows the path lines released at the center line of the inlet plane gap viewed from an angle. FIG. 97c shows the same path lines viewed from the exit plane.

FIG. 98 discloses channel geometry, which includes chevron shaped surface features (FIG. 98a) and path line profiles (FIGS. 98b and 98c) which show the formation of vortices centered about the chevron apex in each surface feature. FIG. 98b shows path lines released at the center line of the inlet plane gap viewed from an angle. FIG. 98c shows the same path lines viewed from the exit plane.

FIGS. 99a-99g show various continuous chevron surface feature designs that may be used in the disclosed process microchannel. All of these figures, except for FIG. 99b, have a 90° subtending angle. FIG. 99b has a subtending angle of 60°.

### DETAILED DESCRIPTION

The term “microchannel” may refer to a channel having at least one internal dimension of height or width of up to about 50 millimeters (mm), and in one embodiment up to about 10 mm, and in one embodiment up to about 5 mm, and in one embodiment up to about 2 mm, and in one embodiment up to about 1 mm. In one embodiment, the height or width is in the range of about 0.01 to about 10 mm, and in one embodiment about 0.05 to about 5 mm, and in one embodiment about 0.05 to about 2 mm, and in one embodiment about 0.05 to about 1.5 mm, and in one embodiment about 0.05 to about 1 mm, and in one embodiment about 0.05 to about 0.75 mm, and in one embodiment about 0.05 to about 0.5 mm. Both height and width are perpendicular to the bulk flow direction of flow through the microchannel. The microchannel may comprise at least one inlet and at least one outlet wherein the at least one inlet is distinct from the at least one outlet. The microchannel may not be merely an orifice. The microchannel may not be merely a channel through a zeolite or a mesoporous material.

The term “process microchannel” may refer to a microchannel wherein a process is conducted. The process may be any process wherein a gas contacts a liquid. Examples of these processes may include distillation, absorption, extraction, and the like.

The term “adjacent” when referring to the position of one channel relative to the position of another channel may mean directly adjacent such that a wall or walls separate the two channels. In one embodiment, the two channels may have a common wall. The common wall may vary in thickness. However, “adjacent” channels may not be separated by an intervening channel that may interfere with heat transfer between the channels. One channel may be adjacent to another channel over only part of the dimension of the another channel. For example, a process microchannel may be longer than and extend beyond one or more adjacent heat exchange channels.

The term “thermal contact” may refer to two bodies, for example, two channels, that may or may not be in physical contact with each other or adjacent to each other but still exchange heat with each other. One body in thermal contact with another body may heat or cool the other body.

The term “fluid” may refer to a gas, a liquid, a mixture of a gas and a liquid, or a gas or a liquid containing dispersed solids, liquid droplets and/or gaseous bubbles. The droplets and/or bubbles may be irregularly or regularly shaped and may be of similar or different sizes.

The terms “gas” and “vapor” may have the same meaning and are sometimes used interchangeably.

The term “partially miscible” may refer to one fluid being soluble in another fluid to the extent of up to about 90% dissolution of the one fluid in the another fluid at 25° C.

The term “residence time” or “average residence time” may refer to the internal volume of a space within a microchannel processing unit occupied by a fluid flowing in the space divided by the average volumetric flow rate for the fluid flowing in the space at the temperature and pressure being used.

The term “volume” with respect to volume within a microchannel may include all volume in the microchannel for which a process fluid may flow-through or flow-by. This volume may include the volume within surface features that may be positioned in the microchannel.

The terms “upstream” and “downstream” may refer to positions within a channel (e.g., a process microchannel) that is relative to the direction of flow of a fluid stream in the channel. For example, a position within the channel not yet reached by a portion of a fluid stream flowing toward that position would be downstream of that portion of the fluid stream. A position within the channel already passed by a portion of a fluid stream flowing away from that position would be upstream of that portion of the fluid stream. The terms “upstream” and “downstream” do not necessarily refer to a vertical position since the channel used herein may be oriented horizontally, vertically or at an inclined angle.

The term “shim” may refer to a planar or substantially planar sheet or plate. The thickness of the shim may be the smallest dimension of the shim and may be up to about 4 mm, and in one embodiment in the range from about 0.05 to about 2 mm, and in one embodiment in the range of about 0.05 to about 1 mm, and in one embodiment in the range from about 0.05 to about 0.5 mm. The shim may have any length and width.

The term “surface feature” may refer to a depression in a microchannel wall and/or a projection from a microchannel wall that disrupts flow within the microchannel. The surface features may be in the form of circles, spheres, frustrums, oblongs, squares, rectangles, angled rectangles, checks, chevrons, vanes, airfoils, wavy shapes, and the like, and combinations of two or more thereof. The surface features may contain subfeatures where the major walls of the surface features further contain smaller surface features that may take the form of notches, waves, indents, holes, burrs, checks, scallops, and the like. The surface features may have a depth, a width, and for non-circular surface features a length. The surface features may be formed on or in one or more of the interior walls of the process microchannels used in accordance with the disclosed process. The surface features may be formed on or in one or more of the interior walls of heat exchange channels that may be used in the disclosed process. The surface features may be referred to as passive surface features or passive mixing features. The surface features may be used to disrupt laminar flow streamlines and create advective flow at an angle to the bulk flow direction.

The term “SFG” may be used to refer to surface feature geometry.

The term “main channel” may refer to an open path for flow having a single inlet and a single outlet.

The term “channel width” may refer to the largest dimension of the cross section of a channel.

The term “main channel gap” may refer to the smallest dimension of the cross section of a channel.

The term “main channel mean bulk flow direction” may refer to the average direction of flow along a portion of the main channel for flow traveling from an inlet to an outlet.

The term “depth of surface feature” may refer to the mean (or average) distance from the plane where the surface feature intersects the main channel to the bottom of the surface feature (the bottom being the plane tangent to the surface feature edge which may be farthest from and parallel to the plane where the surface feature intersects the main channel).

The term “width or span of surface feature” may be the nominal value of the shortest dimension of the surface feature in the plane where the surface feature intersects the main channel, or distance from surface feature edge to surface feature edge.

The term “run length of surface feature leg” may refer to the nominal value of the longest dimension of the surface feature leg in the plane where the surface feature intersects the main channel.

The term “surface feature leg” may refer to a portion of the surface feature having no discontinuity or change in slope along the run length relative to the main channel mean bulk flow direction.

The term “spacing of repeated surface features” may refer to the distance between repeated surface features in the direction perpendicular to the run length of the feature leg .

The term “angle of surface feature” may refer to the angle between the direction of the run length of the surface feature leg and the plane orthogonal to the mean bulk flow direction in the main channel. A surface feature may have more than one angle. The angle may change from one greater than zero to one less than zero. The angle may change continuously along the surface feature in either a continuous or discontinuous manner. The angle may change from surface feature to surface feature along the length or width of the process microchannel.

The term “orientation of surface feature” may refer to the orientation of a section of repeated surface features relative to identical surface features on an adjacent or opposite wall in the main channel.

The term “flow orientation relative to surface feature” may refer to the direction of the mean bulk flow in the main channel relative to the orientation of a surface feature recessed in a given wall of the main channel. The designation A may be used to designate a mean bulk flow direction in the main channel for which the run length of each leg of a two-legged surface feature tend to converge or come closer together along the main channel mean bulk flow direction. The designation B may be used to designate the opposite flow direction relative to the surface feature. For surface features with more than two-legs, an A orientation may refer to a mean or average or net feature run length that is more converging than diverging with respect to the mean direction of flow. Conversely, a B orientation may refer to a mean or average or net feature run length that is more diverging than converging with respect to the mean direction of flow.

The term “heat source” may refer to a substance or device that gives off heat and may be used to heat another substance or device. The heat source may be in the form of a heat exchange channel having a heat exchange fluid in it that transfers heat to another substance or device; the another substance or device being, for example, a channel that is adjacent to and/or in thermal contact with the heat exchange channel. The heat exchange fluid may be in the heat exchange channel and/or it may flow through the heat exchange channel. The heat source may be in the form of a non-fluid heating element, for example, an electric heating element or a resistance heater.

The term “heat sink” may refer to a substance or device that absorbs heat and may be used to cool another substance or device. The heat sink may be in the form of a heat exchange channel having a heat exchange fluid in it that receives heat transferred from another substance or device; the another substance or device being, for example, a channel that is adjacent to and/or in thermal contact with the heat exchange channel. The heat exchange fluid may be in the heat exchange channel and/or it may flow through the heat exchange channel. The heat sink may be in the form of a cooling element, for example, a non-fluid cooling element. The heat sink may be in the form of a Peltier electronic element.

The term “heat source and/or heat sink” may refer to a substance or a device that may give off heat and/or absorb heat. The heat source and/or heat sink may be in the form of a heat exchange channel having a heat exchange fluid in it that transfers heat to another substance or device adjacent to and/or in thermal contact with the heat exchange channel when the another substance or device is to be heated, or receives heat transferred from the another substance or device adjacent to or in thermal contact with the heat exchange channel when the another substance or device is to be cooled. The heat exchange channel functioning as a heat source and/or heat sink may function as a heating channel at times and a cooling channel at other times. A part or parts of the heat exchange channel may function as a heating channel while another part or parts of the heat exchange channel may function as a cooling channel.

The term “heat exchange channel” may refer to a channel having a heat exchange fluid in it that may give off heat and/or absorb heat. The heat exchange channel may accept heat from or provide heat to an adjacent process microchannel and optionally from or to additional process microchannels that are adjacent to each other but not adjacent to the heat exchange channel. By this manner, one, two, three or more process microchannels may be adjacent to each other and interspersed between heat exchange channels.

The term “heat transfer wall” may refer to a common wall between a process microchannel and an adjacent heat exchange channel where heat transfers from one channel to the other through the common wall.

The term “heat exchange fluid” may refer to a fluid that may give off heat and/or absorb heat.

The term “liquid film” may refer to a liquid phase on a solid phase. A gas phase may overlie the liquid film. The term “liquid film thickness” may refer to the distance from the solid phase-liquid film interface to the liquid film-gas phase interface.

The term “bulk flow direction” may refer to the vector through which fluid may travel in an open path in a channel.

The term “bulk flow region” may refer to open areas within a microchannel. A contiguous bulk flow region may allow rapid fluid flow through a microchannel without significant pressure drops. In one embodiment there may be laminarflow in the bulk flow region. A bulk flow region may comprise at least about 5% of the internal volume and/or cross-sectional area of a microchannel, and in one embodiment from about 5% to about 100%, and in one embodiment from about 5% to about 99%, and in one embodiment about 5% to about 95%, and in one embodiment from about 5% to about 90%, and in one embodiment from about 30% to about 80% of the internal volume and/or cross-sectional area of the microchannel.

The terms “open channel” or “flow-by channel” or “open path” may refer to a channel (e.g., a microchannel) with a gap of at least about 0.01 mm that extends all the way through the channel such that fluid may flow through the channel without encountering a barrier to flow. The gap may extend up to about 10 mm.

The term “cross-sectional area” of a channel (e.g., process microchannel) may refer to an area measured perpendicular to the direction of the bulk flow of fluid in the channel and may include all areas within the channel including any surface features that may be present, but does not include the channel walls. For channels that curve along their length, the cross-sectional area may be measured perpendicular to the direction of bulk flow at a selected point along a line that parallels the length and is at the center (by area) of the channel. Dimensions of height and width may be measured from one channel wall to the opposite channel wall. These dimensions may not be changed by application of a coating to the surface of the wall. These dimensions may be average values that account for variations caused by surface features, surface roughness, and the like.

The term “open cross-sectional area” of a channel (e.g., process microchannel) may refer to an area open for bulk fluid flow in a channel measured perpendicular to the direction of the bulk flow of fluid flow in the channel. The open cross-sectional area may not include internal obstructions such as surface features and the like which may be present.

The term “superficial velocity” for the velocity of a fluid flowing in a channel may refer to the velocity resulting from dividing the volumetric flow rate of the fluid at the inlet temperature and pressure of the channel divided by the cross-sectional area of the channel.

The term “free stream velocity” may refer to the velocity of a stream flowing in a channel at a sufficient distance from the sidewall of the channel such that the velocity is at a maximum value. The velocity of a stream flowing in a channel is zero at the sidewall if a no slip boundary condition is applicable, but increases as the distance from the sidewall increases until a constant value is achieved. This constant value is the “free stream velocity.” The term “local velocity” for the velocity of a fluid flowing in a channel may refer to the volumetric flow rate of the fluid at the inlet temperature and pressure divided by the open cross-sectional area of the channel at a specific location along the length of the channel.

The term “dynamic pressure” may refer to the energy of a fluid flowing in a channel and may be defined as the square of the mass flux rate over the cross-sectional area divided by twice the density of the fluid at the inlet temperature and pressure.

The term “capture structure” may refer to a structure positioned within a channel that captures liquid.

The term “capillary features” may refer to features associated with a microchannel that are used to hold liquid substances. These features may be either recessed within a wall of a microchannel or protrude from a wall of the microchannel into the flow path that is adjacent to the microchannel wall. The capillary features may create a spacing that is less than about 1 mm, and in one embodiment less than about 250 microns, and in one embodiment less than about 100 microns. The capillary features may have at least one dimension that is smaller than any dimension of the microchannel in which they are situated. The capillary features may be referred to as surface features.

The term “wicking material” may refer to a material that draws off liquid by capillary action.

The term “mm” may refer to millimeter. The term “nm” may refer to nanometer. The term “ms” may refer to millisecond. The term “μs” may refer to microsecond. The term “μm” may refer to micron or micrometer. The terms “micron” and “micrometer” have the same meaning and may be used interchangeably.

Unless otherwise indicated, all pressures are expressed in terms of absolute pressure.

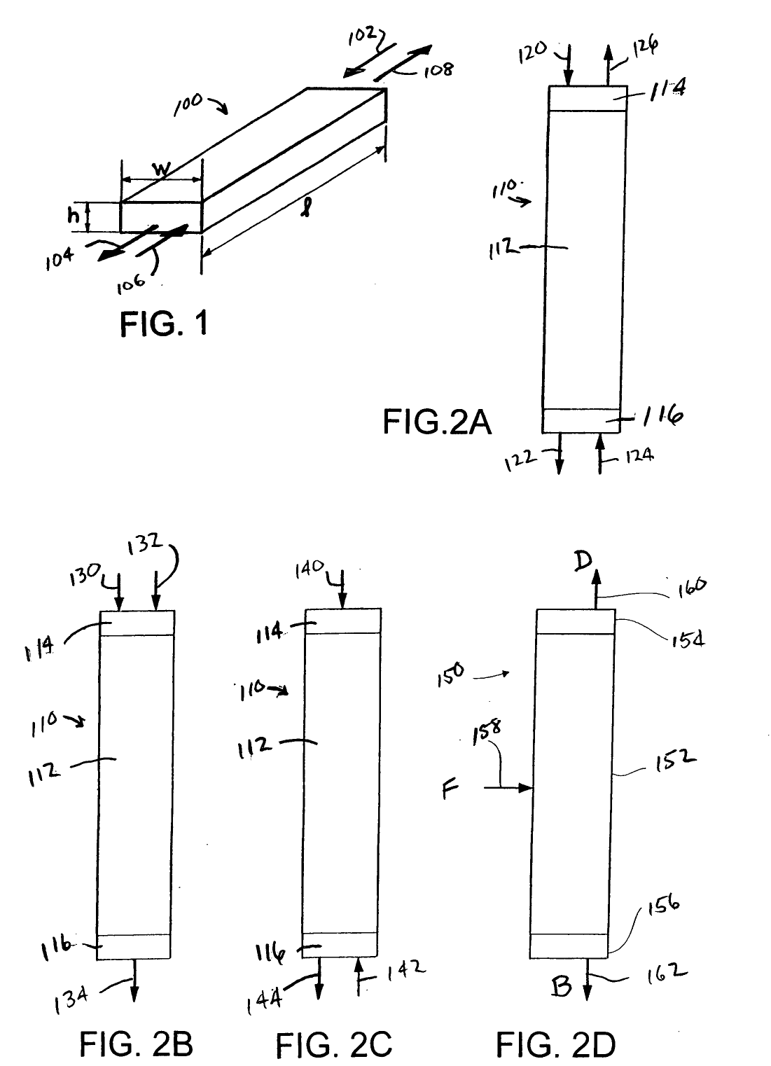

The process microchannel may have at least one internal dimension of height or width of up to about 50 millimeters (mm), and in one embodiment up to about 10 mm, and in one embodiment up to about 5 mm, and in one embodiment up to about 2 mm, and in one embodiment up to about 1 mm. The height or width may be referred to as a gap. The bulk flow of fluid in the process microchannel may proceed along the length of the microchannel normal to the height and width of the microchannel. The length of the process microchannel may not be the shortest dimension of the microchannel. The process microchannel may comprise at least one inlet and at least one outlet wherein the at least one inlet is distinct from the at least one outlet. The process microchannel may not be merely a channel through a zeolite or a mesoporous material. The process microchannel may not be merely an orifice. An example of a process microchannel that may be used with the disclosed process is illustrated in FIG. 1. Referring to FIG. 1, microchannel 100 has a height (h), width (w) and length (l). A liquid phase may flow in the microchannel 100 along the length of the process microchannel in the direction indicated by arrows 102 and 104. Similarly, a gas phase may flow in the process microchannel in the direction indicated by arrows 106 and 108. Alternatively, the gas phase and the liquid phase may flow in the directions opposite those shown in FIG. 1. In each of these cases, the gas phase and the liquid phase are flowing in directions that are counter current to one another. Alternatively, the gas phase and the liquid phase may flow in directions that are cocurrent relative to one another.

The height (h) or width (w) of the process microchannel may be in the range from about 0.05 to about 50 mm, and in one embodiment from about 0.05 to about 10 mm, and in one embodiment from about 0.05 to about 5 mm, and in one embodiment from about 0.05 to about 2 mm, and in one embodiment from about 0.05 to about 1.5 mm, and in one embodiment from about 0.05 to about 1 mm, and in one embodiment about from 0.05 to about 0.75 mm, and in one embodiment from about 0.05 to about 0.5 mm. The other dimension of height or width may be of any dimension, for example, up to about 3 meters, and in one embodiment from about 0.01 to about 3 meters, and in one embodiment about 0.1 to about 3 meters. The length (l) of the process microchannel may be of any dimension, for example, up to about 10 meters, and in one embodiment from about 0.2 to about 10 meters, and in one embodiment from about 0.2 to about 6 meters, and in one embodiment from about 0.2 to about 3 meters. Although the process microchannel 100 illustrated in FIG. 1 has a cross section that is rectangular, it is to be understood that the microchannel may have a cross section having any shape, for example, a square, circle, semi-circle, oval, trapezoid, etc. The shape and/or size of the cross section of the microchannel may vary over its length. For example, the height or width may taper from a relatively large dimension to a relatively small dimension, or vice versa, over the length of the microchannel.

The process may be described initially with reference to FIGS. 2A-2C. Referring to FIGS. 2A-2C, the process may be conducted using microchannel processing unit 110, which comprises microchannel processing unit core 112, header 104, and footer 106. The microchannel processing unit core 112 may comprise one or more repeating units. Each of the repeating units may comprise one or more of the process microchannels. The header 114 may be used to provide for the flow of fluid to or from the process microchannels in the microchannel processing unit core 112. The footer 116 may also be used to provide for the flow of fluid to or from the process microchannels in the microchannel processing unit core 112. The header 114 and the footer 116 may comprise one or more manifolds for distributing fluids to the process microchannels or receiving fluids from the process microchannels.

Referring to FIG. 2A, a liquid phase may flow through header 114, as indicated by arrow 120, and from header 114 into the microchannel processing unit core 112 where it flows through a plurality of process microchannels, contacts a second fluid phase flowing counter currently to it in the process microchannels, and then flows through footer 116 and out of the microchannel processing unit 110, as indicated by arrow 122. Similarly, a second fluid phase may flow through footer 116, as indicated by arrow 124, and from footer 116 into the microchannel processing unit core 112 where it flows through a plurality of process microchannels, contacts the liquid phase flowing counter currently to it in the process microchannels, and then flows through header 114 and out of the microchannel processing unit 110, as indicated by arrow 126. Mass transfer between the liquid phase and second fluid phase may occur in the process microchannels. When mass transfer between the second fluid phase and the liquid phase occurs, one or more parts or components of one or both of the phases may transfer to the other phase. In one embodiment, the second fluid phase may completely or partially transfer to the liquid phase. In one embodiment, the liquid phase may completely or partially transfer to the gas phase.

Referring to FIG. 2B, a liquid phase may flow through header 114, as indicated by arrow 130, and from header 114 into the microchannel processing unit core 112. Similarly, a second fluid phase may flow through header 114, as indicated by arrow 132, and from header 114 into the microchannel processing unit core 112. In the microchannel processing unit core 112, the liquid phase and the second fluid phase may flow co-currently through a plurality of process microchannels, and contact each other in the process microchannels. Mass transfer between the liquid phase and the second fluid phase may occur in the process microchannels. The liquid and second fluid phases may then flow through footer 116 and out of the microchannel processing unit 110, as indicated by arrow 134. The liquid and second fluid phases may combine with each other in the process microchannels to form a fluid stream. In one embodiment, the second fluid phase may completely or partially transfer to the liquid phase. In one embodiment, the liquid phase may completely or partially transfer to the second fluid phase. The liquid and second fluid may flow through footer 116 and out of the microchannel processing unit 110, as indicated by arrow 134.

Referring to FIG. 2C, a liquid phase may flow through header 114, as indicated by arrow 140, and from header 114 into the microchannel processing unit core 112 where it flows through a plurality of process microchannels, contacts a second fluid phase flowing counter currently to it in the process microchannels, and then flows through footer 116 and out of the microchannel processing unit 110, as indicated by arrow 144. Similarly, a second fluid phase may flow through footer 116, as indicated by arrow 142, and from footer 116 into the microchannel processing unit core 112 where it flows in the plurality of process microchannels and contacts the liquid phase flowing counter currently to it in the process microchannels. Mass transfer between the liquid phase and the second fluid phase may occur in the process microchannels. The liquid and second fluid phases may combine to form a fluid stream. This fluid stream may flow through footer 116 and out of the microchannel processing unit 110, as indicated by arrow 144. In one embodiment, the second fluid phase may completely or partially transfer to the liquid phase. In one embodiment, the liquid phase may completely or partially transfer to the second fluid phase. In either case, a liquid phase may flow through footer 116 and then out of the microchannel processing unit 110, as indicated by arrow 144, and a second fluid phase may flow through header 114 and out of the microchannel processing unit 110.

The process may be a distillation process which may be described with reference to FIG. 2D. Referring to FIG. 2D, a microchannel distillation assembly 150 is provided for distilling a fluid mixture containing components X and Y. Component Y is more volatile than component X. The microchannel distillation assembly 150 includes microchannel distillation unit 152, condenser 154, and reboiler 156. The condenser may be a microchannel condenser. The reboiler may be a microchannel reboiler. The microchannel distillation unit 152 contains one or more process microchannels which are provided for contacting a gas or vapor phase and a liquid phase and for separating component X from component Y. In operation, a feed F comprising a fluid (i.e., gas, liquid, or mixture of gas and liquid) comprising components X and Y enters a microchannel distillation unit 152, as indicated by arrow 158. Within the microchannel distillation unit 152 a vapor phase flows in a direction towards the condenser 154 and a liquid phase flows in a direction towards the reboiler 156. In the process microchannels the vapor phase and the liquid phase contact each other with the result being a mass transfer between the phases. The vapor phase, which may become enriched with the more volatile component Y, flows through microchannel distillation unit 152 towards the condenser 154 and into the condenser 154. The liquid phase, which may become enriched with the less volatile component X, flows through the microchannel distillation unit 152 towards the reboiler 156 and into the reboiler 156. The vapor phase may be condensed in the condenser 154 to form distillate product D. Part of the distillate product D, which may be referred to as an overhead product (sometimes called a head or a make), may be withdrawn from the system, as indicated by arrow 160. Part of the distillate product D may be returned to the microchannel distillation unit 152 where it flows through the microchannel distillation unit in the form of a liquid phase. The liquid phase, in the form of bottoms product B, flows into the reboiler 156. Part of the bottoms product B may be withdrawn from the system, as indicated by arrow 162. Part of the bottoms product may be vaporized in the reboiler 156 and returned to the microchannel distillation unit 152 where it flows through the microchannel distillation unit 152 in the form of a vapor phase. The ratio between the amount of distillate product D that is removed from the system and the amount that is returned to the system may be referred to as the reflux ratio. The ratio between the amount of bottoms product B that is removed from the system and the amount that is returned to the system may be referred to as the boil-up ratio. These ratios can vary and can be determined by those skilled in the art.

In one embodiment, the microchannel distillation assembly 150 may be constructed without the condenser 154. In this embodiment, the microchannel distillation assembly 150 would comprise the microchannel distillation unit 152 and the reboiler 156. In this embodiment the microchannel distillation assembly 150 may be used as a stripping column.

In one embodiment, the microchannel distillation assembly 150 may be constructed without the reboiler 162. In this embodiment, the microchannel distillation assembly 150 would comprise the microchannel distillation unit 152 and the microchannel condenser 154. In this embodiment the microchannel distillation assembly 150 may be used in operations where a relatively hot fluid is added in a lower section or stage. An example of such a use may be a steam stripper.

In addition to the distillation process illustrated in FIG. 2D, there are other distillation processes that may be used for separating fluids for which the disclosed microchannel distillation process may be employed. For example, distillation processes with any number of microchannel distillation units or assemblies, for example, ten, twenty, thirty, etc., may be employed similarly to those illustrated. Distillation processes that may be conducted in accordance with the disclosed process may include: processes employing partitioned columns; topping and tailing processes or tailing and topping processes, which may employ two distillation columns; easiest separation first processes, which may employ three distillation columns; and full thermal coupling processes which employ two distillation columns. These distillation processes are described in Becker et al., “The World's Largest Partitioned Column with Trays—Experiences from Conceptual Development to Successful Start-Up,” Reports on Science and Technology 62/2000, pages 42-48. The microchannel distillation units used with the disclosed process may be employed in these distillation processes. An advantage of using the disclosed process is that microchannel distillation units disclosed herein can be built on smaller scales that consume significantly less energy and still produce the same level of product output as conventional distillation systems. Another advantage of using the microchannel distillation units disclosed herein relates to the ability to closely space partitions within these microchannel distillation units or to closely space thermally coupled streams by integration of such thermally coupled streams with adjacent channels or within adjacent or nearly adjacent layers in the same microchannel distillation assembly. The close spacing of the thermally coupled streams may reduce one or more of thermal response times, control feedback times, and start-up times needed for achieving steady-state operations for continuous distillation processes.

The height of an equivalent theoretical plate (HETP) ratio may be used for calculating the mass transfer efficiency of hardware for effecting gas-liquid contacting processes. In conventional distillation processes, the HETP is typically on the order of about 2 feet (about 61 cm) for trays and packing. On the other hand, with the disclosed process the HETP may be less than about 1 foot (about 30.5 cm), and in one embodiment less than about 6 inches (15.24 cm), and in one embodiment less than about 2 inches (5.08 cm), and in one embodiment less than about 1 inch (about 2.54 cm), and in one embodiment in the range from about 0.01 to about 1 cm. This provides the disclosed process with the advantage of employing more theoretical distillation stages in a more compact system than conventional processes and yet achieve similar separation and product throughput results. In one embodiment, at least one theoretical distillation stage for separating two or more components may be provided in each process microchannel. For example, for the separation of ethane from ethylene in the production of >99% by volume pure ethylene, the microchannel distillation unit used with the disclosed process may be less than about 20 meters (about 65 feet) high, and in one embodiment less than about 3 meters (about 9.8 feet) high, while with conventional processes the same separation may require a distillation column that may be hundreds of feet high.

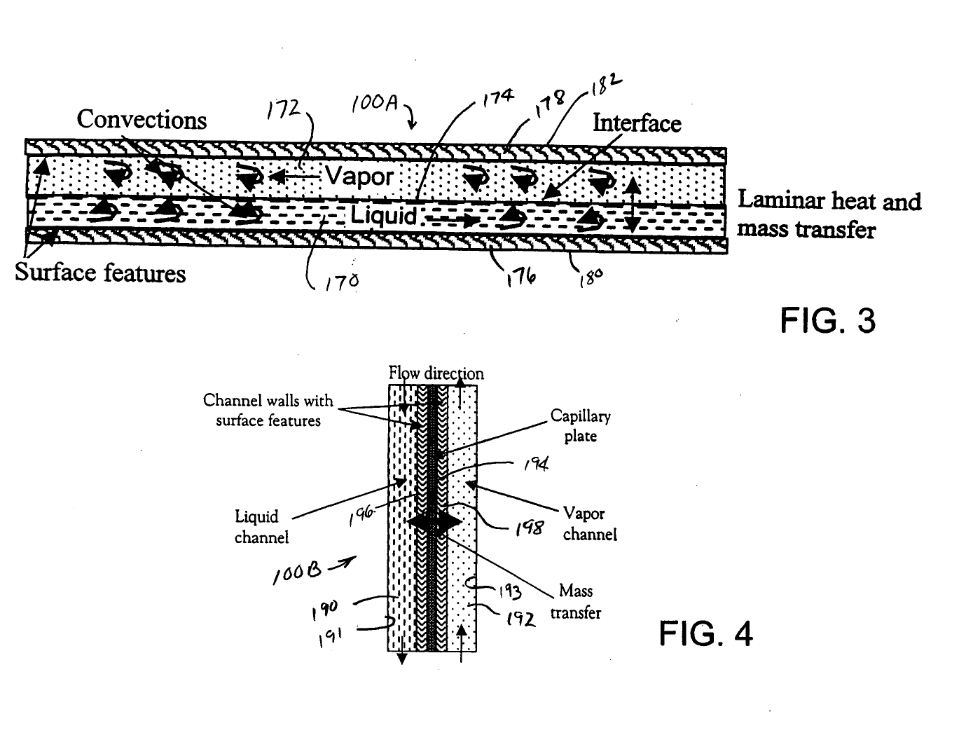

The microchannel processing unit core 112 (FIGS. 2A-2C) and the microchannel distillation unit 152 (FIG. 2D) may contain a plurality of process microchannels wherein the liquid phase and the second fluid phase contact each other. In one embodiment, these process microchannels may have the construction illustrated in FIG. 3. Referring to FIG. 3, process microchannel 100A comprises liquid phase region 170 and second fluid phase region 172. FIG. 3 shows a “vapor” flowing in the second fluid phase region 172, however, it is to be understood that any second fluid may flow in the region 172. The liquid and second fluid phases may contact each other at interface 174. The liquid phase flows counter current to second fluid phase. Heat and/or mass transfer may occur between the phases. Mass may be transferred from the second fluid phase to the liquid phase via the interface 174, and/or mass may be transferred from the liquid phase to the second fluid phase via the interface. A layer of a wicking material at the interface 174 may be included to assure that the liquid velocity is not impeded by drag from the flow of the second fluid phase. The wicking material layer may promote good contact between the second fluid phase and the liquid phase. Convective mixing induced by surface features 176 and 178 on the walls 180 and 182, respectively, opposite the interface 174 may be used to overcome mass transport resistance in both the liquid and second fluid phases and thereby improve mixing between the liquid and the second fluid. Different surface feature geometries may be used forthe liquid and second fluid phase regions. In an alternate embodiment, the surface features may be used in only the liquid region 170 or only the second fluid phase region 172.

An alternate embodiment of the process microchannels that may be used is illustrated in FIG. 4. Referring to FIG. 4, process microchannel 100B comprises liquid phase region 190 and second fluid phase region 192 which are separated by capillary plate 194. FIG. 4 shows a “vapor channel,” however it is to be understood that the vapor channel is provided for flowing any second fluid phase. The capillary plate 194 may be referred to as a contactor. The capillary plate 194 may be in the form of thin porous material such as a thin screen. The capillary plate 194 includes surface features 196 on the wall of the capillary plate facing the liquid region 190, and surface features 198 on the wall of the capillary plate facing the second fluid phase region 192. The surface features 196 and 198 are through-surface features which permit mass transfer through the surface features. Mass from the liquid phase may flow through the surface features 196, then through the capillary plate 194, then through surface features 198 into the second fluid phase region. Mass transfer from the second fluid phase region 192 to the liquid phase region 190 may flow in the reverse path. The liquid phase and the second fluid phase may flow in a co-current or counter current direction (counter current is shown in FIG. 4). In an alternate embodiment, surface features may be positioned on process microchannel walls 191 and/or 193. Either or both surface features 196 and 198 may be eliminated, and surface features on walls 191 and/or 193 may be added. Any combination of surface features on either or both walls of the capillary plate 194 and/or on either or both of the microchannel walls 191 and 193 may be used.

The capillary plate 194 may be used to keep the liquid and the second fluid phases separate and prevent the formation of a two-phase mixture inside the process microchannel. The capillary plate may prevent the mixing of liquid and second fluid by virtue of surface tension forces. The capillary plate may or may not be required depending upon the application. In the absence of the capillary plate, a surface feature wall may be used to separate the liquid and second fluid phase regions. The surface features on either or both sides of the capillary plate may provide for the movement of liquid and second fluid from bulk to the capillary plate. This movement of bulk fluid towards the capillary plate may improve mass transfer between the liquid and second fluid phases.

In one embodiment, the capillary plate may not be used and the at least two phases may be allowed to mix along the length of the process microchannel. The resulting intimate mixing may increase the surface area for mass transfer and the surface features may enhance mixing. The flow of the two phase may be either co-current or counter current. For co-current flow and for distillation, the flow may need to be phase separated after the mixing and mass transfer in each stage. For counter current flow the phase separation may occur near the product draws or outlet ports and/or near the feed inlet manifolding region. In one embodiment, the phase separation for one or more fluid streams may occur outside the microchannel processing unit or microchannel distillation unit.

Although only one process microchannel is illustrated in FIGS. 3 and 4, there is practically no upper limit to the number of process microchannels that may be used in the microchannel processing unit core (FIGS. 2A-2C) or the microchannel distillation unit 152 (FIG. 2D). For example, one, two, three, four, five, six, eight, ten, twenty, fifty, one hundred, hundreds, one thousand, thousands, ten thousand, tens of thousands, one hundred thousand, hundreds of thousands, millions, etc., of the process microchannels may be used. The process microchannels may be aligned side-by-side or stacked one above another. The process microchannels may be aligned to provide for vertical flow through the channels, or they may be aligned horizontally to provide for horizontal flow through the channels, or they may be aligned at an inclined angle from the horizontal.

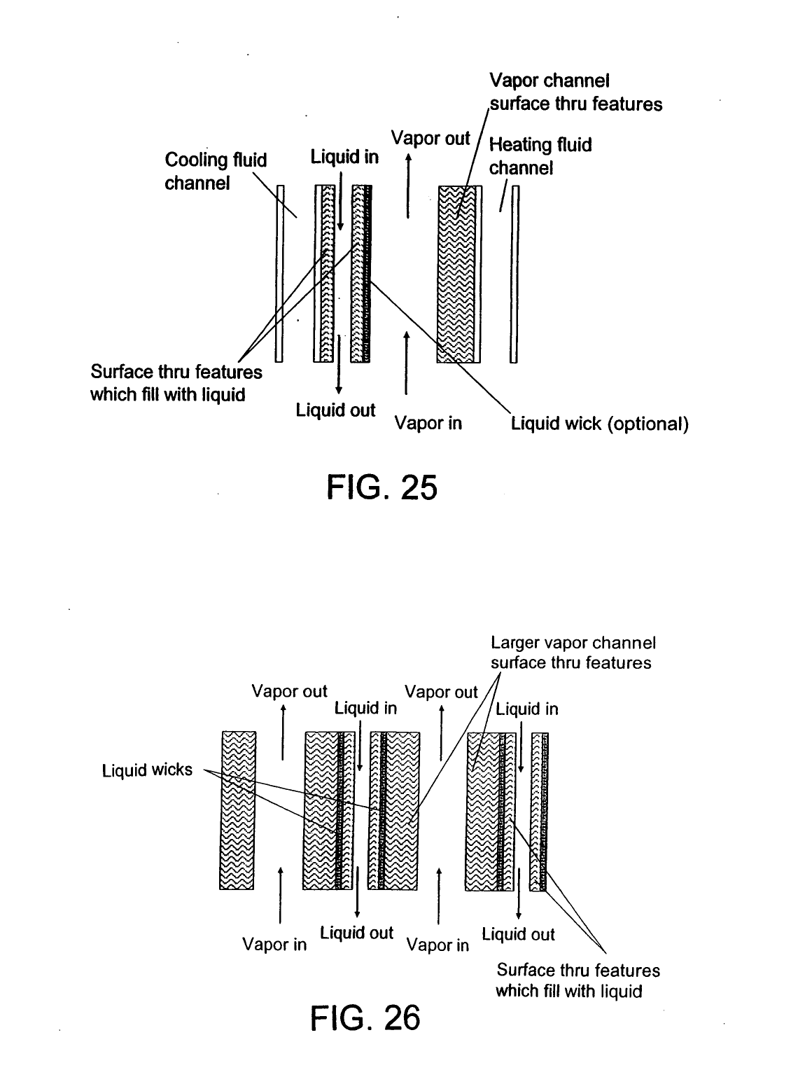

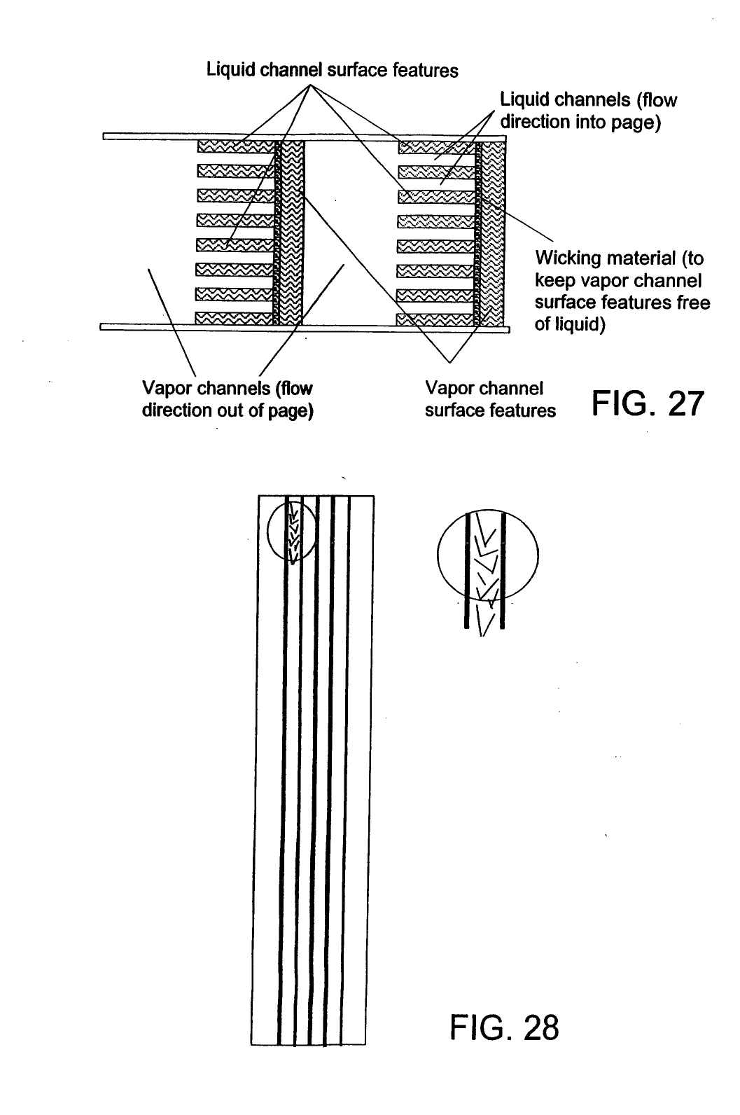

Repeating units that may be used in the microchannel processing unit core 112 or the microchannel distillation unit 152 may include those illustrated in FIGS. 24-27. Each of these comprises a process microchannel that contains surface features on its interior walls and is used to provide for the contacting of a liquid phase with a second fluid phase. Each of the drawings refer to “vapor,” but it is to be understood that any second fluid may be used. The repeating unit illustrated in FIG. 25 includes adjacent heat exchange channels. FIG. 28 shows a microchannel wall that employs dual depth surface features which may be used in the foregoing process microchannels.

The process microchannels may contain one or more surface features in the form of depressions in and/or projections from one or more interior walls of the process microchannels. The heat exchange channels discussed below may also contain such surface features. The surface features may be used to disrupt the flow of the liquid phase and/or the second fluid phase flowing in the process microchannel. These disruptions in flow may enhance mixing and/or mass transfer between the liquid and the second fluid phases. The surface features in the heat exchange channels may enhance heat exchange between the heat exchange channels and the process microchannels. Either or both walls of the capillary plate may contain surface features. The surface features may be in the form of patterned surfaces. The microchannel processing unit core 112 or microchannel distillation unit 152 containing the process microchannels may be made by laminating a plurality of shims together. One or both major surfaces of the shims may contain surface features. Alternatively, the microchannel processing unit core 112 or microchannel distillation unit 152 may be assembled using some sheets (or shims) and some strips, or partial sheets to reduce the total amount of metal required to construct the device. In one embodiment, a shim containing surface features may be paired (on opposite sides of a microchannel) with another shim containing surface features. Pairing often creates better mixing or heat or mass transfer enhancement as compared to channels with surface features on only one major surface. In one embodiment, the patterning may comprise diagonal recesses that are disposed over substantially the entire width of a microchannel surface. The patterned surface feature area of a wall may occupy part of or the entire length of a microchannel surface. In one embodiment, surface features may be positioned over at least about 10%, and in one embodiment at least about 20%, and in one embodiment at least about 50%, and in one embodiment at least about 80% of the length of a microchannel surface. Each diagonal recesses may comprise one or more angles relative to the flow direction. Successive recessed surface features may comprise similar or alternate angles relative to other recessed surface features.

In embodiments wherein surface features may be positioned on or in more than one microchannel wall, the surface features on or in one wall may have the same (or similar) pattern as found on a second wall, but rotated about the centerline of the main channel mean bulk flow direction. In embodiments wherein surface features may be on or in opposite walls, the surface features on or in one wall may be approximately mirror images of the features on the opposite wall. In embodiments wherein surface features are on or in more than one wall, the surface features on or in one wall may be the same (or similar) pattern as found on a second wall, but rotated about an axis which is orthogonal to the main channel mean bulk flow direction. In other words, the surface features may be flipped 180 degrees relative to the main channel mean bulk flow direction and rotated about the centerline of the main channel mean bulk flow. The surface features on or in opposing or adjacent walls may or may not be aligned directly with one another, but may be repeated continuously along the wall for at least part of the length of the wall. Surface features may be positioned on three or more interior surfaces of a microchannel. For the case of microchannel geometries with three or fewer sides, such as triangular, oval, elliptical, circular, and the like, the surface features may cover from about 20% to about 100% of the perimeter of the microchannel.

In one embodiment, a patterned surface may comprise multiple patterns stacked on top of each other. A pattern or array of holes may be placed adjacent to a heat transfer wall and a second pattern, such as a diagonal array of surface features may be stacked on top and adjacent to an open channel for flow. A sheet adjacent to an open gap may have patterning through the thickness of the sheet such that flow may pass through the sheet into an underlying pattern. Flow may occur as a result of advection or diffusion. As an example, a first sheet with an array of through holes may be placed over a heat transfer wall, and a second sheet with an array of diagonal through slots may be positioned on the first sheet. This may create more surface area for adhering an active material such as an adsorbent, wick, etc. In one embodiment, the pattern may be repeated on at least one other wall of the process microchannel. The patterns may be offset on opposing walls. The innermost patterned surfaces (those surfaces bounding a flow channel) may contain a pattern such as a diagonal array. The diagonal arrays may be oriented both “with” the direction of flow (cis orientation) or one side oriented with the direction of flow and the opposing side oriented “against” the direction of flow (trans orientation). By varying surface features on opposing walls, different flow fields and degrees of vorticity may be created in the fluid that travels down the center and open gap.

The surface features may be oriented at angles relative to the direction of flow through the channels. The surface features may be aligned at an angle from about 1° to about 89°, and in one embodiment from about 30° to about 75°, relative to the direction of flow. The angle of orientation may be an oblique angle. The angled surface features may be aligned toward the direction of flow or against the direction of flow. The flow of fluids in contact with the surface features may force one or more of the fluids into depressions in the surface features, while other fluids may flow above the surface features. Flow within the surface features may conform with the surface feature and be at an angle to the direction of the bulk flow in the channel. As fluid exits the surface features it may exert momentum in the x and y direction for an x,y,z coordinate system wherein the bulk flow is in the z direction. This may result in a churning or rotation in the flow of the fluids. This pattern may be helpful for mixing a two-phase flow as the imparted velocity gradients may create fluid shear that breaks up one of the phases into small and well dispersed droplets.

Two or more surface feature regions within the process microchannels may be placed in series such that mixing of the process fluids may be accomplished using a first surface feature region, followed by at least one second surface feature region where a different flow pattern may be used. The second flow pattern may be used to separate one or more liquids or gases from the fluid mixture. In the second surface feature region, a flow pattern may be used that creates a centrifugal force that drives one liquid toward the interior walls of the process microchannels while another liquid remains in the fluid core. One pattern of surface features that may create a strong central vortex may comprise a pair of angled slots on the top and bottom of the process microchannel. This pattern of surface features may be used to create a central swirling flow pattern.

The surface features may have two or more layers stacked on top of each other or intertwined in a three-dimensional pattern. The pattern in each discrete layer may be the same or different. Flow may rotate or advect in each layer or only in one layer. Sub-layers, which may not be adjacent to the bulk flow path of the channel, may be used to create additional surface area. The flow may rotate in the first level of surface features and diffuse molecularly into the second or more sublayers to promote reaction. Three-dimensional surface features may be made via metal casting, photochemical machining, laser cutting, etching, ablation, or other processes where varying patterns may be broken into discrete planes as if stacked on top of one another. Three-dimensional surface features may be provided adjacent to the bulk flow path within the microchannel where the surface features have different depths, shapes, and/or locations accompanied by sub-features with patterns of varying depths, shapes and/or locations.

An example of a three-dimensional surface feature structure may comprise recessed oblique angles or chevrons at the interface adjacent the bulk flow path of the microchannel. Beneath the chevrons there may be a series of three-dimensional structures that connect to the surface features adjacent to the bulk flow path but are made from structures of assorted shapes, depths, and/or locations. It may be further advantageous to provide sublayer passages that do not directly fall beneath an open surface feature that is adjacent to the bulk flow path within the microchannel but rather connect through one or more tortuous two-dimensional or three-dimensional passages. This approach may be advantageous for creating tailored residence time distributions in the microchannels, where it may be desirable to have a wider versus more narrow residence time distribution.

The length and width of a surface feature may be defined in the same way as the length and width of a microchannel. The depth may be the distance which the surface feature sinks into or rises above the microchannel surface. The depth of the surface features may correspond to the direction of stacking a stacked and bonded microchannel device with surface features formed on or in the sheet surfaces. The dimensions for the surface features may refer the maximum dimension of a surface feature; for example the depth of a rounded groove may refer to the maximum depth, that is, the depth at the bottom of the groove.

The surface features may have depths that are up to about 5 mm, and in one embodiment up to about 2 mm, and in one embodiment in the range from about 0.01 to about 5 mm, and in one embodiment in the range from about 0.01 to about 2 mm, and in one embodiment in the range from about 0.01 mm to about 1 mm. The width of the surface features may be sufficient to nearly span the microchannel width (for example, herringbone designs), but in one embodiment (such as fill features) may span about 60% or less of the width of the microchannel, and in one embodiment about 50% or less, and in one embodiment about 40% or less, and in one embodiment from about 0.1% to about 60% of the microchannel width, and in one embodiment from about 0.1% to about 50% of the microchannel width, and in one embodiment from about 0.1% to about 40% of the microchannel width. The width of the surface features may be in the range from about 0.05 mm to about 100 cm, and in one embodiment in the range from about 0.5 mm to about 5 cm, and in one embodiment in the range from about 1 to about 2 cm.

Multiple surface features or regions of surface features may be included within a microchannel, including surface features that recess at different depths into one or more microchannel walls. The spacing between recesses may be in the range from about 0.01 mm to about 10 mm, and in one embodiment in the range from about 0.1 to about 1 mm. The surface features may be present throughout the entire length of a microchannel or in portions or regions of the microchannel. The portion or region having surface features may be intermittent so as to promote a desired mixing or unit operation (for example, separation, cooling, etc.) in tailored zones. For example, a one-centimeter section of a microchannel may have a tightly spaced array of surface features, followed by four centimeters of a flat channel without surface features, followed by a two-centimeter section of loosely spaced surface features. The term “loosely spaced surface features” may be used to refer to surface features with a pitch or feature to feature distance that is more than about five times the width of the surface feature.

The surface features may be positioned in one or more surface feature regions that extend substantially over the entire axial length of a channel. In one embodiment, a channel may have surface features extending over about 50% or less of its axial length, and in one embodiment over about 20% or less of its axial length. In one embodiment, the surface features may extend over about 10% to about 100% of the axial length of the channel, and in one embodiment from about 20% to about 90%, and in one embodiment from about 30% to about 80%, and in one embodiment from about 40% to about 60% of the axial length of a channel.

Each surface feature leg may be at an oblique angle relative to the bulk flow direction. The feature span length or span may be defined as being normal to the feature orientation. As an example, one surface feature may be a diagonal depression at a 45 degree angle relative to a plane orthogonal to the mean direction of bulk flow in the main channel with a 0.015 inch opening or span or feature span length and a feature run length of 0.22 inch. The run length may be the distance from one end to the other end of the surface feature in the longest direction, whereas the span or feature span length may be in the shortest direction (that is not depth). The surface feature depth may be the distance way from the main channel. For surface features with a nonuniform width (span), the span may be the average span averaged over the run length.

In one embodiment, the process microchannel may comprise a mass transfer system comprising a gas-containing open section connected to a liquid-containing microchannel. The liquid-containing microchannel may comprise two major surfaces in which the liquid is mixed by flow past surface features on two major surfaces of the microchannel. Two major surfaces may be opposite one another and comprise diagonal recesses positioned substantially across the entire width of both microchannel surfaces. The microchannel major surfaces may have a length, which is the direction of fluid flow, and width, which is perpendicular to the length.

A surface feature may comprise a recess or a protrusion based on the projected area at the base of the surface feature or the top of the surface feature. If the area at the top of the surface feature is the same or exceeds the area at the base of the surface feature, then the surface feature may be considered to be recessed. If the area at the base of the surface feature exceeds the area at the top of the surface feature, then it may be considered to be protruded. For this description, the surface features may be described as recessed although it is to be understood that by changing the aspect ratio of the surface feature it may be alternatively defined as a protrusion. For a process microchannel defined by walls that intersect only the tops of the surface features, especially for a flat channel, all surface features may be defined as recessed and it is to be understood that a similar channel could be created by protruding surface features from the base of a channel with a cross section that includes the base of the surface features.

The process microchannel may have at least about 20%, and in one embodiment at least about 35%, and in one embodiment at least about 50%, and in one embodiment at least about 70%, and in one embodiment at least about 90% of the interior surface of the channel (measured in cross-section perpendicular to length; i.e., perpendicular to the direction of net flow through the channel) that contains surface features. The surface features may cover a continuous stretch of at least about 1 cm, and in one embodiment at least about 5 cm. In the case of an enclosed channel, the percentage of surface feature coverage may be the portion of a cross-section covered with surface features as compared to an enclosed channel that extends uniformly from either the base or the top of the surface feature or a constant value in-between. The latter may be a flat channel. For example, if a channel has patterned top and bottom surfaces that are each 0.9 cm across (wide) and unpatterned side walls that are 0.1 cm high, then 90% of the surface of the channel would contain surface features.

The process microchannel may be enclosed on all sides, and in one embodiment the channel may have a generally square or rectangular cross-section (in the case of rectangular channel, surface feature patterning may be positioned on both major faces). For a generally square or rectangular channel, the channel may be enclosed on only two or three sides and only the two or three walled sides may be used in the above described calculation of percentage surface features. In one embodiment, the surface features may be positioned on cylindrical channels with either constant or varying cross section in the axial direction.

Each of the surface feature patterns may be repeated along one face of the main channel, with variable or regular spacing between the surface features in the main channel bulk flow direction. Some embodiments may have only a single leg to each surface feature, while other embodiments may have multiple legs (two, three, or more). For a wide-width main channel, multiple surface features or columns of repeated surface features may be placed adjacent to one another across the width of the main channel. For each of the surface feature patterns, the feature depth, width, span, and spacing may be variable or constant as the pattern is repeated along the bulk flow direction in the main channel. Also, surface feature geometries having an apex connecting two legs at different angles may have alternate embodiments in which the surface feature legs may not be connected at the apex.

In one embodiment, it may be desired to hold up liquid in the surface features in a gravitational field (i.e. in applications such as applying uniform coatings to the walls of microchannels). For such embodiments the vertical component (relative to gravity) of the run length of each surface feature leg may be less than about 4 mm, and in one embodiment less than about 2 mm to prevent the liquid in the surface feature from draining out.

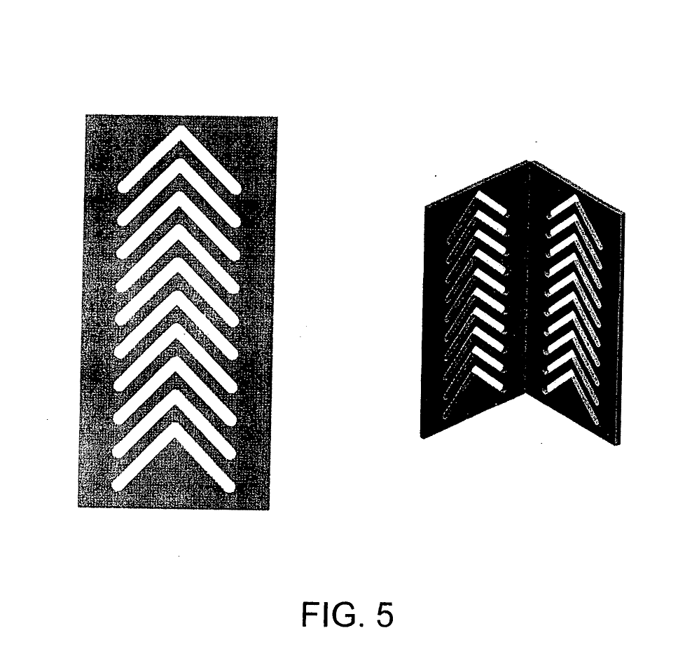

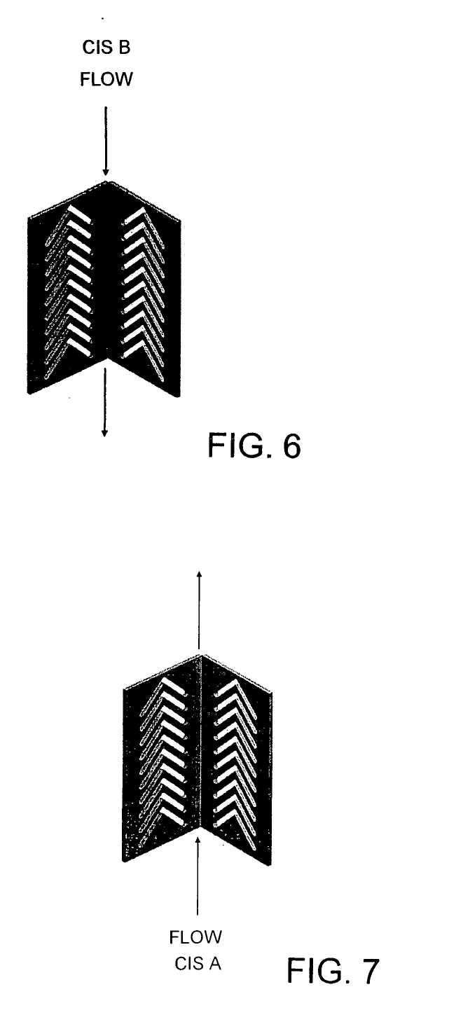

The surface feature geometry SFG-0 (see, FIG. 5) comprises an array of chevrons or v-shaped recesses that may occur along the length of the process microchannel. The chevrons may be either regularly or irregularly spaced with equal or varying distance between successive surface features. Regular (or equal) spacing of the surface features may be useful since the disruptions to the bulk flow in the main channel effected by the presence of each surface feature may reinforce the disruptions effected by the other surface features. A one-sided surface feature may have surface features on only one side of the microchannel. A two-sided surface feature may have surface features on two sides of a microchannel (either on opposite walls or adjacent walls). In some two-sided orientation embodiments, surface feature orientation may be either in the cis orientation or the trans orientation. In the cis orientation with surface features on opposite walls (see, FIG. 6), the surface features may be mirror images on both channel walls. In the trans orientation, the surface features on one face may be symmetric to the surface features on the opposite face about an axis perpendicular to both that face and the main channel bulk flow direction. Flow orientation relative to the surface features on a given wall may be either cis A (flow direction from bottom to top; see, FIG. 7) or cis B (flow direction from top to bottom; see, FIG. 6).

FIG. 6, which shows the top and bottom of the microchannel with angled surface features on two walls, shows how the surface features may be aligned in the microchannel.

In FIG. 7, the top and bottom of the microchannel with angled surface features on two walls, shows how the surface features may be aligned in the microchannel. Typically, the surface features are on opposing walls, but they may be on adjacent walls.

SFG-1 (FIG. 8) contains surface features that alternate in orientation or angle along each microchannel wall. For this geometry, five or more asymmetric chevrons (where one feature leg is longer than a second feature leg) may be placed with the apex of the surface feature stationed one-third of the way in along the microchannel width. The surface features are then followed by two filler features (noting that fewer or more filler features may be used), and then followed by five or more asymmetric features where the apex of the chevron is roughly two-thirds along the width of the microchannel. This pattern may be repeated several times. As shown in FIG. 8, the pattern on the opposing microchannel wall is in the trans-orientation, where the surface features are not mirror images.

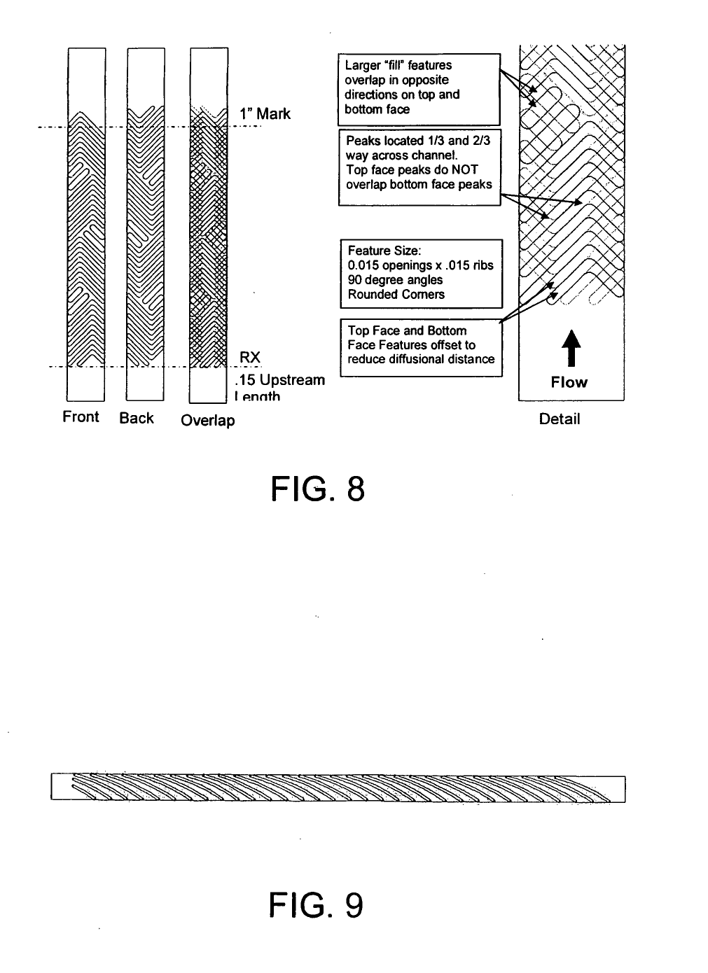

SFG-2 (FIG. 9) comprises an air foil design, where the angle is continuously changing along the surface feature run length. The flow in the main channel adjacent to the surface features may be from left to right or from right to left as shown in FIG. 9. Flow disturbance at the leading edge of each surface feature may be minimized as a result of the aerodynamic shape of each surface feature.

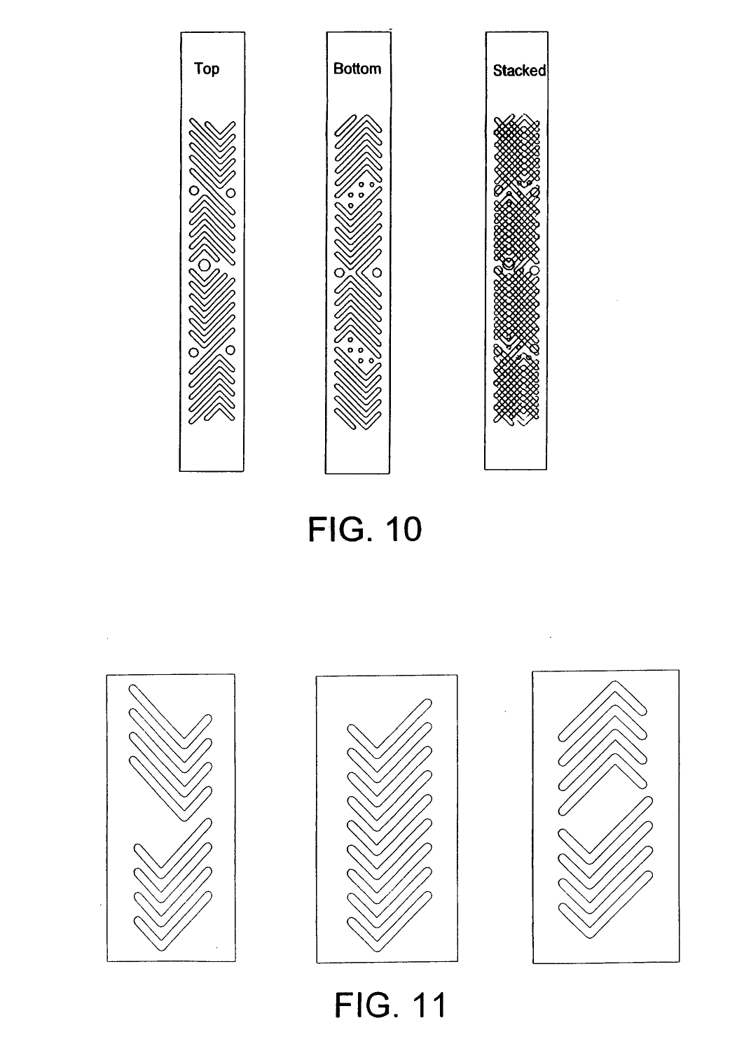

The SFG-3 surface feature pattern is shown in FIG. 10, which includes a view of both top and bottom faces, and how the two overlap when seen from above. This pattern may be repeated as many times as necessary to fill the desired length. The main characteristic of SFG-3 is the repetition of the “checkmark” shape.

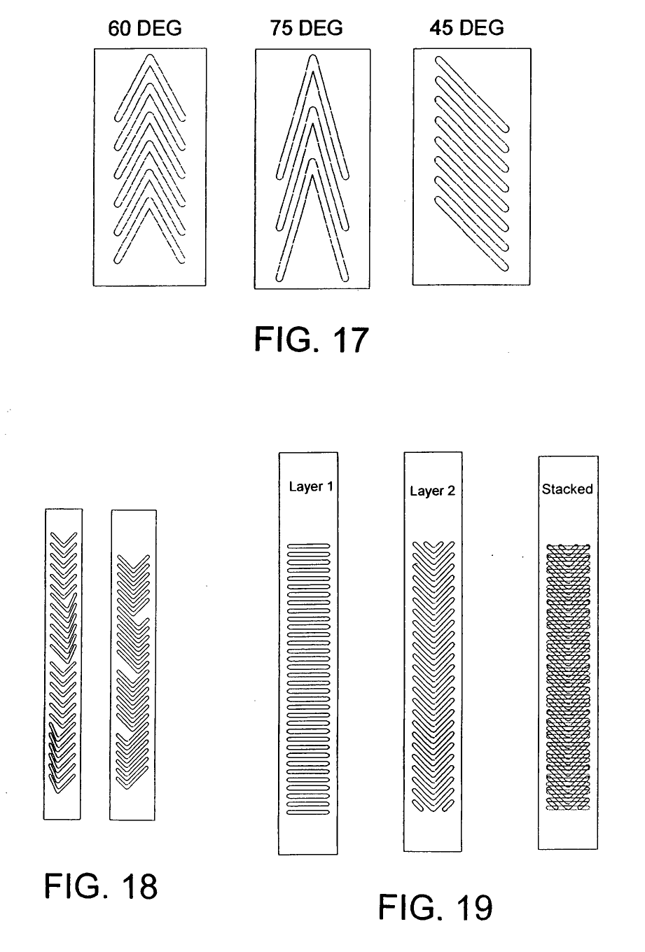

The surface feature pattern SFG-4 is a simple diagonal slot with only one feature leg per surface feature. This is shown in the right hand side of FIG. 17 and is labeled “45 DEG”.

SFG-5 (FIG. 11) is represented by a series of checks, where the apex of the check is such that the run length of one leg of the surface feature is roughly half of the run length of the other leg. Groups of four or more of these “check” shaped surface features may be arranged in many different combinations, including the three shown in FIG. 11. These groups of checks may have different orientations relative to one another, or all may have the same orientation, forming a continuous pattern of checks along the surface. Each combination or variety of the SFG-5 pattern may yield different mixing characteristics.

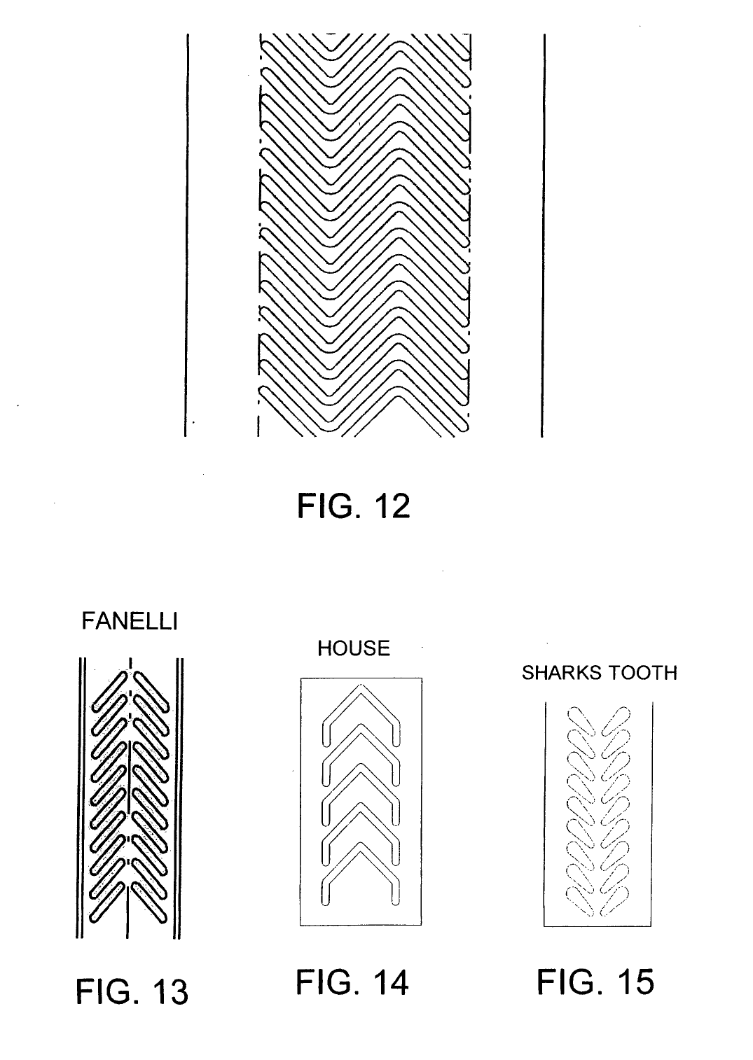

SFG-6 (FIG. 12) contains three surface feature legs and has two changes in the angle of orientation from positive to negative with respect to the direction of flow. This imparts aspects of both an “A” and a “B” type flow direction to the flow in the main channel, as two of the feature legs may converge with respect to each other along the bulk flow direction and two of the feature legs may diverge with respect to each other along the bulk flow direction.

Cis A refers to an alignment of a two or more sided microchannel with surface features where the surface features on both top and bottom are aligned in the same direction with respect to flow, and the surface feature legs may converge along the flow direction.

Cis B refers to an alignment of a two or more sided microchannel with surface features where the surface features on both top and bottom are aligned in the same direction with respect to flow, and the surface feature legs diverge along the flow direction.

Trans refers to an alignment of a two or more sided microchannel with surface features where the surface features on opposite walls are not aligned, but rather a second wall is first taken as a mirror image and then rotated 180 degrees (so that the top view of the pattern appears upside down relative to the first wall) to create offsetting features. The second and opposing wall may not be a perfectly rotated mirror image, as filler features may be added to create more net area of the microchannel that contains surface features, and since the surface features on opposite walls may be somewhat offset from one another along the direction of bulk flow.

Fanelli (see, FIG. 13) refers to a discontinuity or small disconnection of the legs of the surface features that are otherwise connected. The discontinuity may be less than about 20% of the surface feature run length. FIG. 13 shows a Fanelli for a SFG-0 feature pattern, where the apex is removed to help alleviate either dead spots or reduced velocity regions in the main channel flow path that result from a change in angle.

House (see, FIG. 14) refers to an entrance leg to a surface feature where one or more legs runs parallel with the main channel bulk flow direction before turning at an oblique angle to the direction of flow. The angle may optionally be more rounded than that shown in FIG. 14.

A sharks tooth pattern (FIG. 15) represents a single legged surface feature with a varying span from one end to the other. The leg may be at any angle relative to the main channel bulk flow direction, and multiple teeth at different angles may populate a microchannel wall.

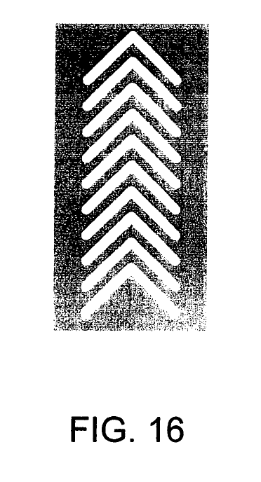

FIG. 16 shows a surface feature with 45 degree angle, where the angle is defined relative to a horizontal plane that bisects the microchannel cross section orthogonal to the main flow direction.

FIG. 17 shows surface features with a 60 degree angle for the SFG-0 pattern, a 75 degree angle for the SFG-0 pattern, and a 45 degree angle for the SFG-4 pattern.

Other embodiments of multiple-legged surface feature geometries may have different angles and or lengths for each leg, or for some of the legs, or groupings of five or more identical surface features as shown in FIG. 18. Repetition of groupings of surface features also provides potential advantages during fabrication. For example, when stamping features from thin sheets, stamping tools can be made to stamp multiple features at once.

Layered surface features may be formed in one or more walls of a main channel. The layered surface feature wall may be formed by stacking adjacent layers with different surface feature geometries in them (see, FIG. 19), and aligning the columns of surface features such that the two stacked together make a more complex three dimensional feature. FIG. 19 shows a top view of different surface feature patterns which, when stacked in adjacent layers, form a layered surface feature. For layered surface features, the surface features in all layers except the layer farthest from the main channel may be through surface features. Alternately, the identical surface features made as through surface features in a thin sheet may be made deeper by stacking sheets of identical surface features directly on top of one other and aligning the surface features in each sheet.

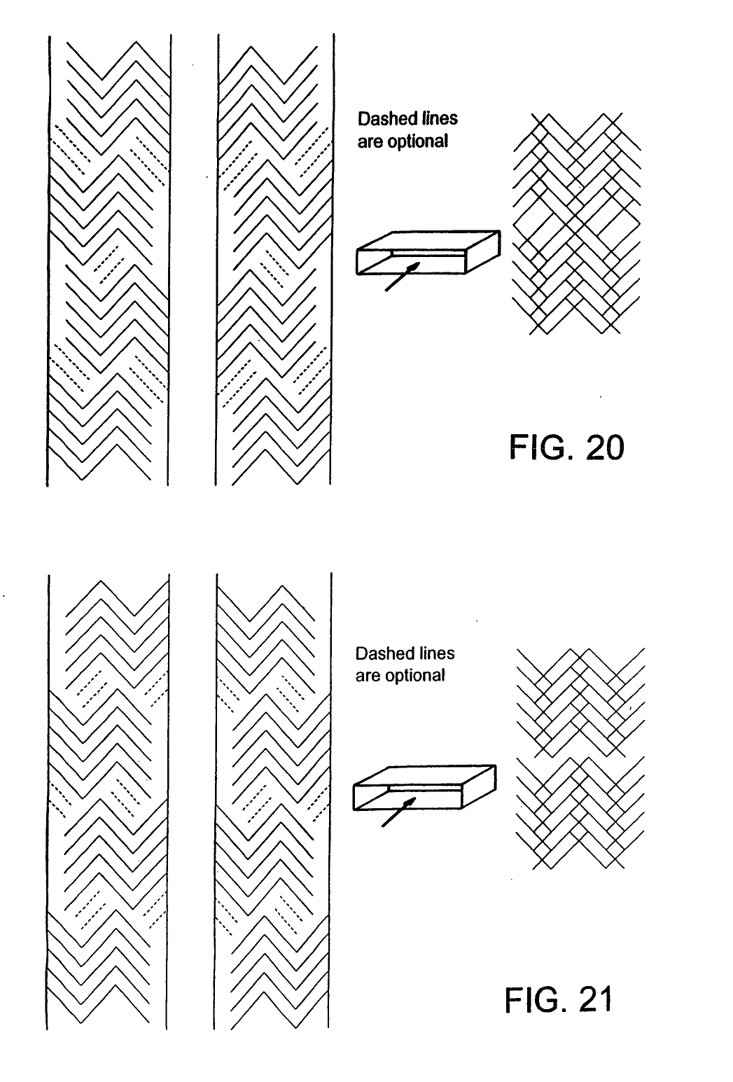

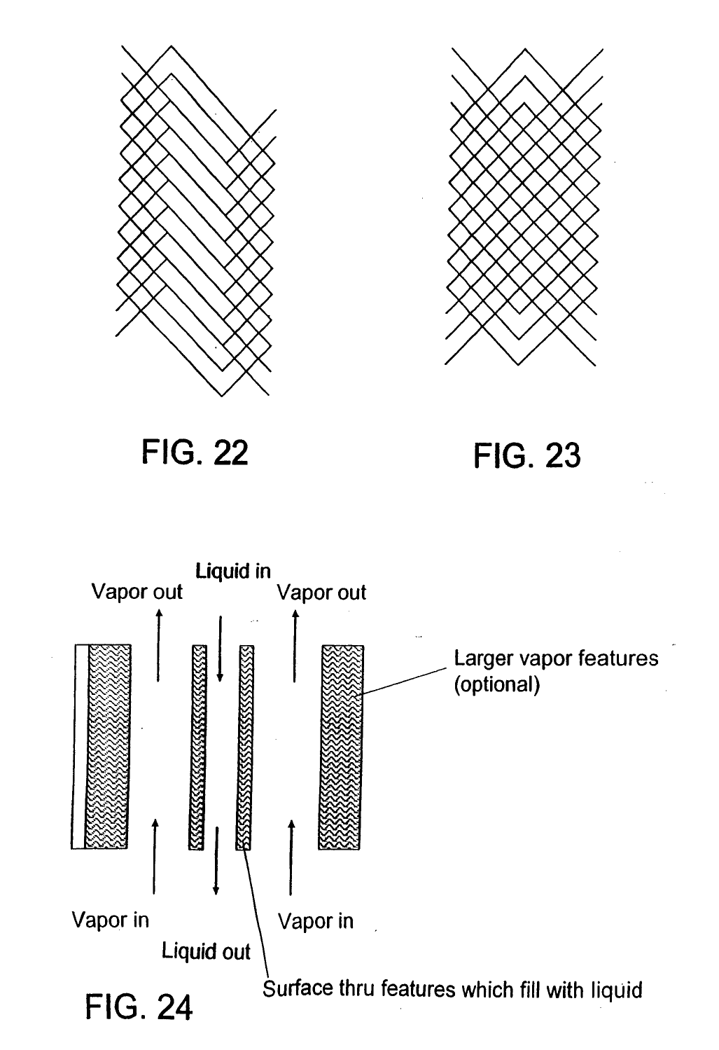

The surface features shown on the left in each of FIGS. 20 and 21 may be positioned in the vapor phase region of the process microchannel, and the surface features shown on the right may be positioned in the liquid phase region. Next to each of these figures are schematic illustrations showing the surface features as they may overlap and complement one another. FIGS. 22 and 23 show alternate embodiments of these surface features. Each of these figures show the complementing nature of these surface features.

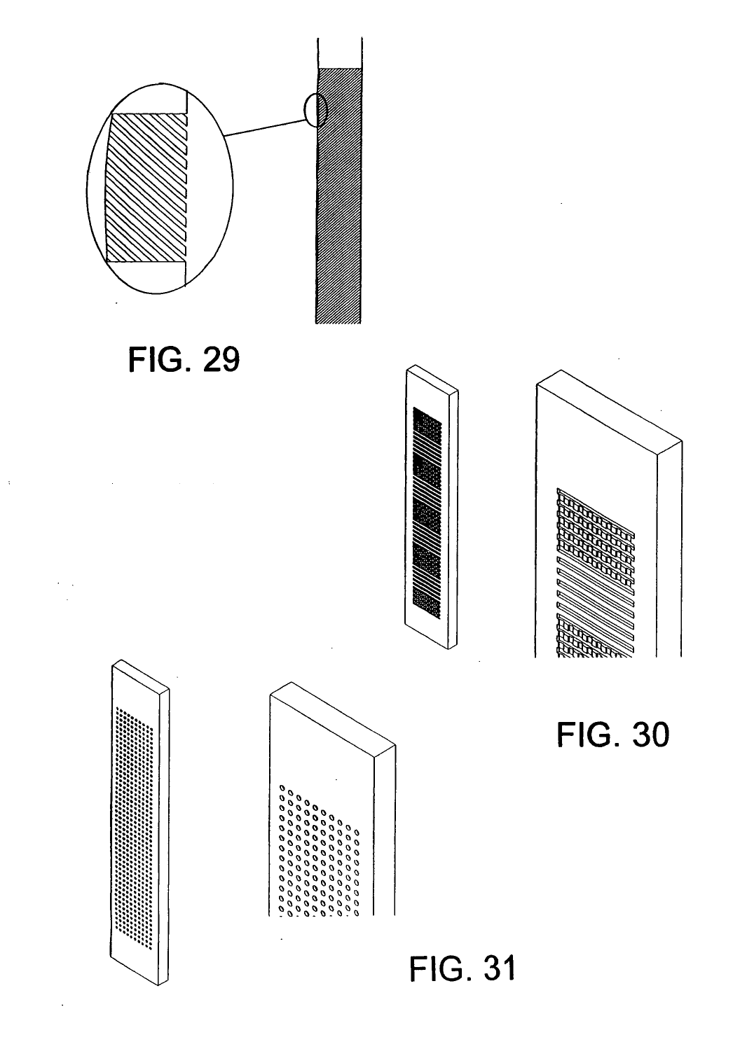

The shim illustrated in FIG. 29 may be used to form a major surface of a process microchannel. This surface may be paired (on opposite sides of the microchannel) with a shim of the same or substantially similar structure with diagonal strips (the strips may be recessed) that are either aligned, staggered or crossed with respect to the opposing surface. Pairing may create better mixing than in channels where surface features are only on one major surface. The patterning of the surface features may comprise diagonal recesses that are positioned over substantially the entire width of the microchannel surface.

The pattern of surface features shown in FIG. 30 introduces a spatially varying depth for the surface features. This may be advantageous for some applications where changing the depth of the surface feature within a surface feature may create more flow rotation or vorticity such that the external mass transfer resistance between fluids may be reduced.

The surface feature pattern shown in FIG. 31 may be advantageous as an underlayer surface pattern that sits beneath at least one or more other surface pattern sheets to increase the available surface area for a mass exchange agent.

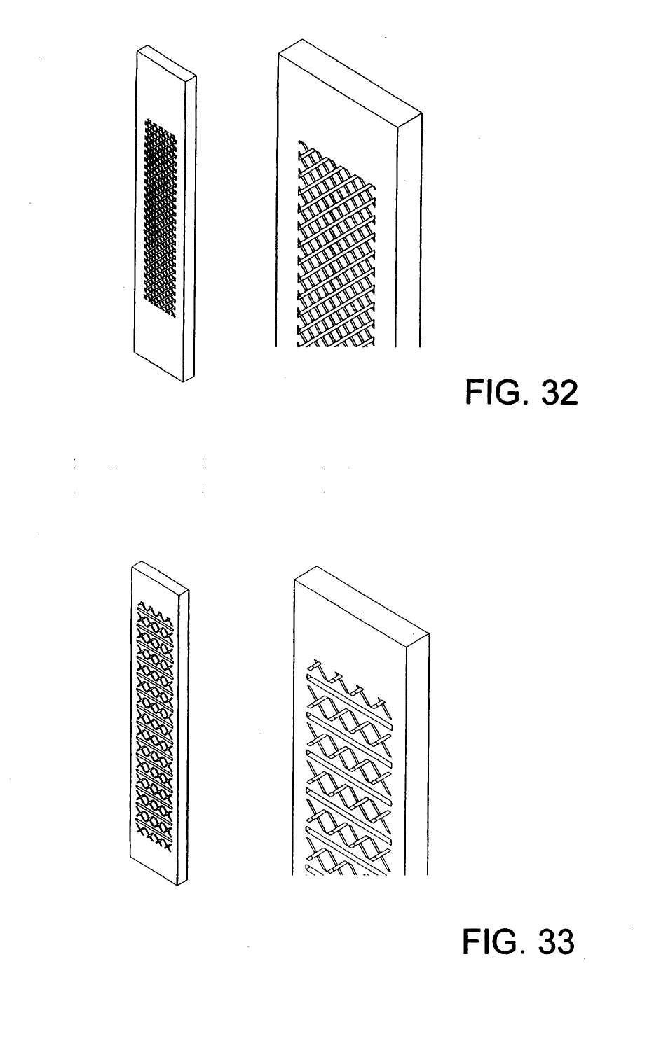

The surface feature pattern shown in FIG. 32 may be advantageous for inducing flow rotation in a center channel adjacent to a surface pattern sheet. Greater flow rotation may further reduce external mass transfer resistance.

The surface feature pattern shown in FIG. 33 introduces both angled features and a horizontal feature. The surface feature geometry may vary along the length of the process microchannel. This design may be advantageous as an underlayer surface pattern sheet that is used to both hold more mass exchange agent while also creating more depth to angled surface features that may sit adjacent to this sheet. A second and angled sheet may be adjacent to the flow path and induce flow rotation. The varying depths of angled surface features may create more turbulence or apparent turbulence in the flow paths.

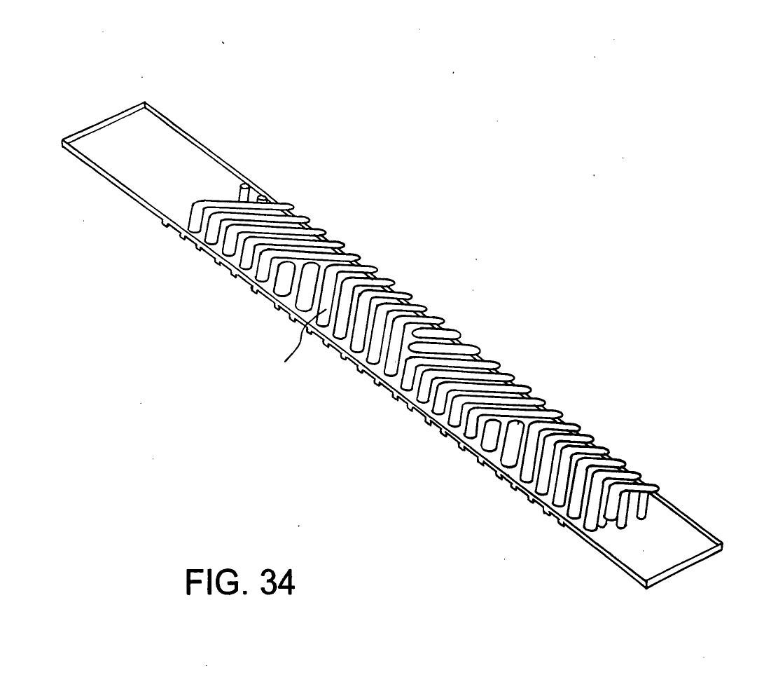

The surface features shown in FIG. 34 may provide for convective flow in the process microchannel in a direction perpendicular to the direction of bulk flow and thereby improve mass transfer.

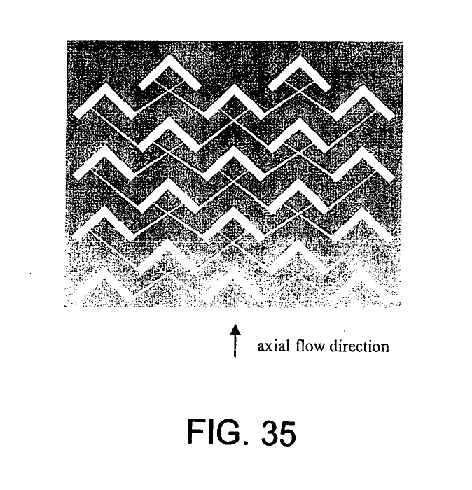

FIG. 35 shows surface features in the form of inter-connected oblique angles that may project from one or more interior walls of the process microchannel.

The surface features when added to the walls of a microchannel, may modify the laminar flow pattern that is typically formed within a microchannel. The creation of regular flow patterns with rotation, swirling, vorticity, and other movement orthogonal or angled with the direction of bulk flow may be advantageous for increasing heat transfer efficiency, reducing mass transport resistance, enhancing mixing, enhancing mass and/or energy transport between phases, and/or promoting separation of phases such as separating a gas from a liquid or liquid from a gas.

The process microchannels and/or heat exchange channels (discussed below) may have their interior walls coated with a lipophobic coating (the same coating may also provide hydrophobic properties) to reduce surface energy. Teflon may be an example of a coating material that may exhibit both lipophobic and hydrophobic tendencies. In one embodiment, fluids may not wet surfaces coated with the lipophobic coating. As such, the fluids may slip past the surface and thus negate or reduce the usual no-slip boundary condition of fluids against a wall. As the fluids slip, the local friction factor may decrease as a result of reduced drag and the corresponding pressure drop may be reduced per unit length of the channels. The local heat transfer rate may increase as a result of forced convection over a coated surface as opposed to conductive heat transfer through a stagnant film. The effect of the coating may have a different impact on different types of non-Newtonian fluids. For the case of pseudoplastic (power law) fluid without yield may appear Newtonian above shear rates that are fluid dependent. The viscosity of the fluid may be higher when the shear rate is below a certain value. If the shear rate is locally larger because of the coated wall, then the fluid may be able to shear droplets more easily, move with less energy (lower pumping requirements), and have better heat transfer properties than if the coating were not used. For the case of pseudoplastic (power law) fluid with yield may still have a yield stress, at the wall the yield stress may be greatly reduced with the use of the lipophobic coating. Heat transfer and frictional properties may be enhanced if the apparent yield is low when the coating is used as compared to when the coating is not used. The shear-related effects may be more pronounced for non-Newtonian fluids than for Newtonian fluids.

The microchannel processing unit core 112 and the microchannel distillation unit 152 may further comprise a heat source and/or heat sink in thermal contact with the process microchannels. The heat source and/or heat sink may comprise one or more heat exchange channels adjacent to and/or in thermal contact with the process microchannels. The heat exchange channels may be microchannels. The heat source and/or heat sink may be used to provide cooling and/or heating to the process microchannels. Various combinations of heating and cooling may be employed to provide for desired temperature profiles within the process microchannels and along the length of the process microchannels.

The heat source and/or heat sink may comprise one or more heat exchange channels containing a heat exchange fluid. The heat source may comprise a non-fluid heating element such as an electric heating element or a resistance heater. The heat sink may comprise a non-fluid cooling element such as a Peltier electronic element. A heat exchange fluid may flow in and through heat exchange channels in the microchannel processing unit core 112 or the microchannel distillation unit 152. Heat transfer between the process fluids and the heat source and/or heat sink may be effected using convective heat transfer. In one embodiment, heat transfer may be enhanced using a heat exchange fluid wherein the heat exchange fluid undergoes an exothermic or endothermic reaction and/or a full or partial phase change. Multiple heat exchange zones may be employed along the length of the process microchannels to provide for different temperatures at different points along the lengths of the process microchannels. This may provide the advantage of tailoring the heating and/or cooling profile in the process microchannels.

The heat exchange channels may be microchannels or they may have larger dimensions. Each of the heat exchange channels may have a cross section having any shape, for example, a square, rectangle, circle, semi-circle, etc. Each of the heat exchange channels may have an internal height or gap of up to about 10 mm, and in one embodiment in the range from about 0.05 to about 10 mm, and in one embodiment from about 0.05 to about 5 mm, and in one embodiment from about 0.05 to about 2 mm. The width of each of these channels may be of any dimension, for example, up to about 3 meters, and in one embodiment from about 0.01 to about 3 meters, and in one embodiment from about 0.1 to about 3 meters. The length of each of the heat exchange channels may be of any dimension, for example, up to about 10 meters, and in one embodiment from about 0.01 to about 10 meters, and in one embodiment from about 0.01 to about 5 meters, and in one embodiment from 0.01 to about 2.5 meters, and in one embodiment from about 0.01 to about 1 meter, and in one embodiment from about 0.02 to about 0.5 meter, and in one embodiment from about 0.02 to about 0.25 meter. The length may be in the range from about 15 cm to about 15 m. The heat exchange channels may have cross sections that are rectangular, or alternatively they may have cross sections having any shape, for example, a square, circle, semi-circle, trapezoid, etc. The shape and/or size of the cross section of the heat exchange channel may vary over its length. For example, the height or width may taper from a relatively large dimension to a relatively small dimension, or vice versa, over the length of the microchannel.

The separation between adjacent process microchannels, heat exchange channels may be in the range from about 0.05 mm to about 50 mm, and in one embodiment about 0.1 to about 10 mm, and in one embodiment about 0.2 mm to about 2 mm.

The heat exchange fluid may be any fluid. These may include air, steam, liquid water, steam, gaseous nitrogen, other gases including inert gases, carbon monoxide, molten salt, oils such as mineral oil, and heat exchange fluids such as Dowtherm A and Therminol which are available from Dow-Union Carbide.

The heat exchange fluid may comprise a stream of the first and/or second reactant. This may provide process pre-heat and increase in overall thermal efficiency of the process.

The heat exchange channels may comprise process channels wherein an endothermic process or an exothermic process is conducted. These heat exchange process channels may be microchannels. Examples of endothermic processes that may be conducted in the heat exchange channels include steam reforming and dehydrogenation reactions. Steam reforming of an alcohol that occurs at a temperature in the range from about 200° C. to about 300° C. is an example of an endothermic process suited for an exothermic reaction such as an FT synthesis reaction in the same temperature range. The incorporation of a simultaneous endothermic reaction to provide an improved heat sink may enable a typical heat flux of roughly an order of magnitude above the convective cooling heat flux. Examples of exothermic processes that may be conducted in the heat exchange channels include water-gas shift reactions, methanol synthesis reactions and ammonia synthesis reactions. The use of simultaneous exothermic and endothermic reactions to exchange heat in a microchannel reactor is disclosed in U.S. patent application Ser. No. 10/222,196, filed Aug. 15, 2002, which is incorporated herein by reference.

The heat exchange fluid may undergo a partial or full phase change as it flows in the heat exchange channels. This phase change may provide additional heat removal from the process microchannels beyond that provided by convective cooling. For a liquid heat exchange fluid being vaporized, the additional heat being transferred from the process microchannels may result from the latent heat of vaporization required by the heat exchange fluid. An example of such a phase change may be an oil or water that undergoes boiling or partial boiling. In one embodiment, about 80% by weight of the heat exchange fluid may be vaporized, and in one embodiment about 50% by weight may be vaporized, and in one embodiment about 30% by weight may be vaporized, and in one embodiment about 3% by weight may be vaporized. In one embodiment, from about 5% to about 50% by weight may be vaporized.

The microchannel processing unit 110 and the microchannel distillation assembly 150 may be used in combination with one or more storage vessels, pumps, valves, manifolds, microprocessors, flow control devices, and the like, which are not shown in the drawings, but would be apparent to those skilled in the art.

The microchannel processing unit 110 and the microchannel distillation assembly 150 may contain a plurality of process microchannels and heat exchange channels aligned side by side or stacked one above the other. The process microchannels and/or heat exchange channels may be provided in layers of each, with each layer containing a plurality of channels. For each heat exchange channel, one or more process microchannels may be used. Thus, for example, one, two, three, four, five, six or more process microchannels may be employed with a single heat exchange channel. Alternatively, two or more heat exchange channels may be employed with each process microchannel. The heat exchange channels may be used for heating and/or cooling. In one embodiment, each process microchannel may be positioned between adjacent heat exchange channels. In one embodiment, two or more process microchannels may be positioned adjacent each otherto form a vertically or horizontally oriented stack of process microchannels, and a heat exchange channel may be positioned on one or both sides of the stack. Each combination of process microchannels and heat exchange channels may be referred to as a repeating unit.

The microchannel processing unit 110 and the microchannel distillation assembly 150 may be constructed of any material that provides sufficient strength, dimensional stability and heat transfer characteristics for carrying out the inventive process. Examples of suitable materials may include steel (e.g., stainless steel, carbon steel, and the like), aluminum, titanium, nickel, and alloys of any of the foregoing metals, plastics (e.g., epoxy resins, UV cured resins, thermosetting resins, and the like), monel, inconel, ceramics, glass, composites, quartz, silicon, or a combination of two or more thereof. The microchannel processing unit 110 and the microchannel distillation assembly 150 may be fabricated using known techniques including wire electrodischarge machining, conventional machining, laser cutting, photochemical machining, electrochemical machining, molding, water jet, stamping, etching (for example, chemical, photochemical or plasma etching) and combinations thereof. The microchannel reactor may be constructed by forming layers or sheets with portions removed that allow flow passage. A stack of sheets may be assembled via diffusion bonding, laser welding, diffusion brazing, and similar methods to form an integrated device. The microchannel reactor may have appropriate manifolds, valves, conduit lines, etc. to control flow of the reactants and product, and the flow of heat exchange fluid. These are not shown in the drawings, but can be readily provided by those skilled in the art.

The microchannel processing unit core 112 and the microchannel distillation unit 152 may be made by a process that includes laminating or diffusion bonding thin sheets or shims of any of the above-indicated materials (e.g., metal, plastic or ceramic) so that each layer has a defined geometry of channels and openings through which to convey fluids. After the individual layers are created, they may be stacked in a prescribed order to build up the lamination. The layers may be stacked side-by-side or one above the other. The completed stack may then be diffusion bonded to prevent fluids from leaking into or out of the microchannel reactor or between streams. After bonding, the device may be trimmed to its final size and prepared for attachment of pipes and manifolds. An additional step for the process microchannels that contain the catalyst may be to integrate the catalyst into the device prior to final assembly.

Feature creation methods may include photochemical etching, milling, drilling, electrical discharge machining, laser cutting, and stamping. A useful method for mass manufacturing is stamping. In stamping, care should be taken to minimize distortion of the material and maintain tight tolerances of channel geometries, for example, less than about ±0.5 mm displacement of feature location. Preventing distortion, maintaining shim alignment and ensuring that layers are stacked in the proper order are factors that should be controlled during the stacking process.

The stack may be bonded through a diffusion process. In this process, the stack may be subjected to elevated temperatures and pressures for a precise time period to achieve the desired bond quality. Selection of these parameters may require modeling and experimental validation to find bonding conditions that enable sufficient grain growth between metal layers.

The next step, after bonding, may be to machine the device. A number of processes may be used, including conventional milling with high-speed cutters, as well as highly modified electrical discharge machining techniques. A full-sized bonded microchannel reactor unit or sub-unit that has undergone post-bonding machining operations may comprise, for example, tens, hundreds or thousands of shims.

The process microchannels and heat exchange channels may have rectangular cross sections and be aligned in side-by-side vertically oriented planes or horizontally oriented stacked planes. These planes may be tilted at an inclined angle from the horizontal. These configurations may be referred to as parallel plate configurations. Various combinations of process microchannels and heat exchange channels may be employed. Combinations of these rectangular channels may be arranged in modularized compact repeating units for scale-up.

The cross-sectioned shape and size of the process microchannels may vary along their axial length to accommodate changing hydrodynamics within the channel. For example, with mass transport between phases, the fluidic properties of each phase may change over the course of a process run. Surface features may be used to provide a different geometry, pattern, angle, depth, or ratio of size relative to the cross-section of the process microchannel along its axial length to accommodate these hydrodynamic changes.

The process microchannel and the heat exchange channel may comprise circular tubes aligned concentrically. The process microchannel may be in an annular space and the heat exchange channel may be in the center space or an adjacent annular space. The process microchannel may be in the center space and the heat exchange channel may be in an adjacent annular space.

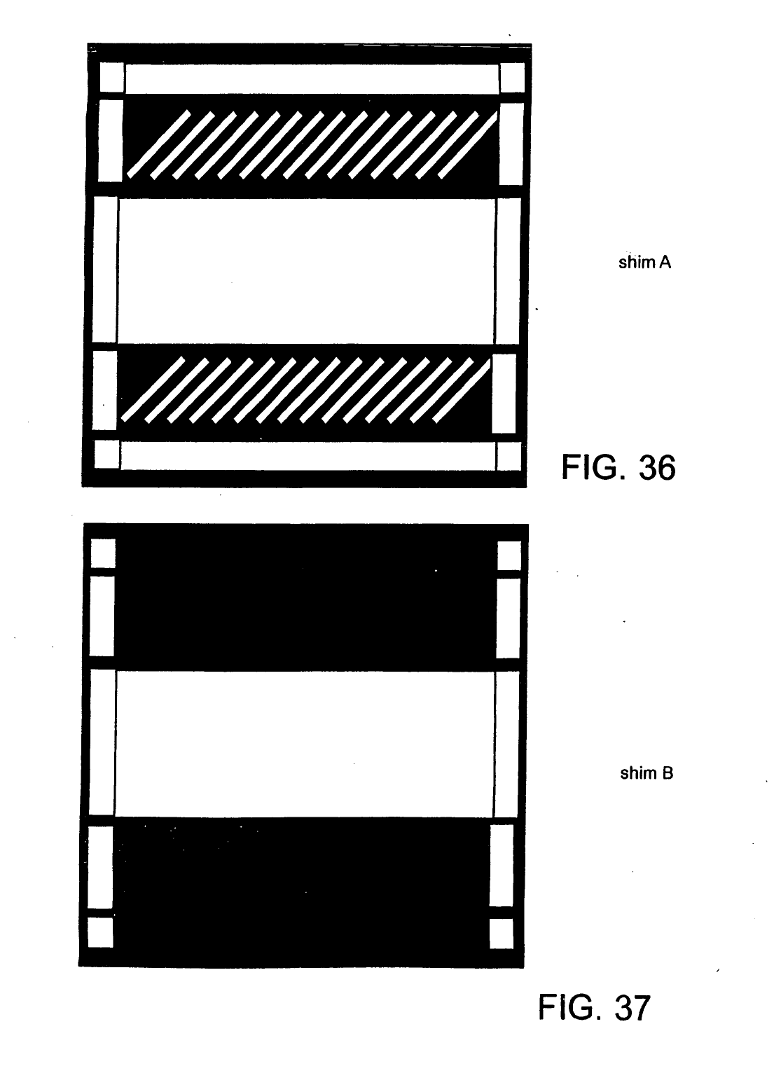

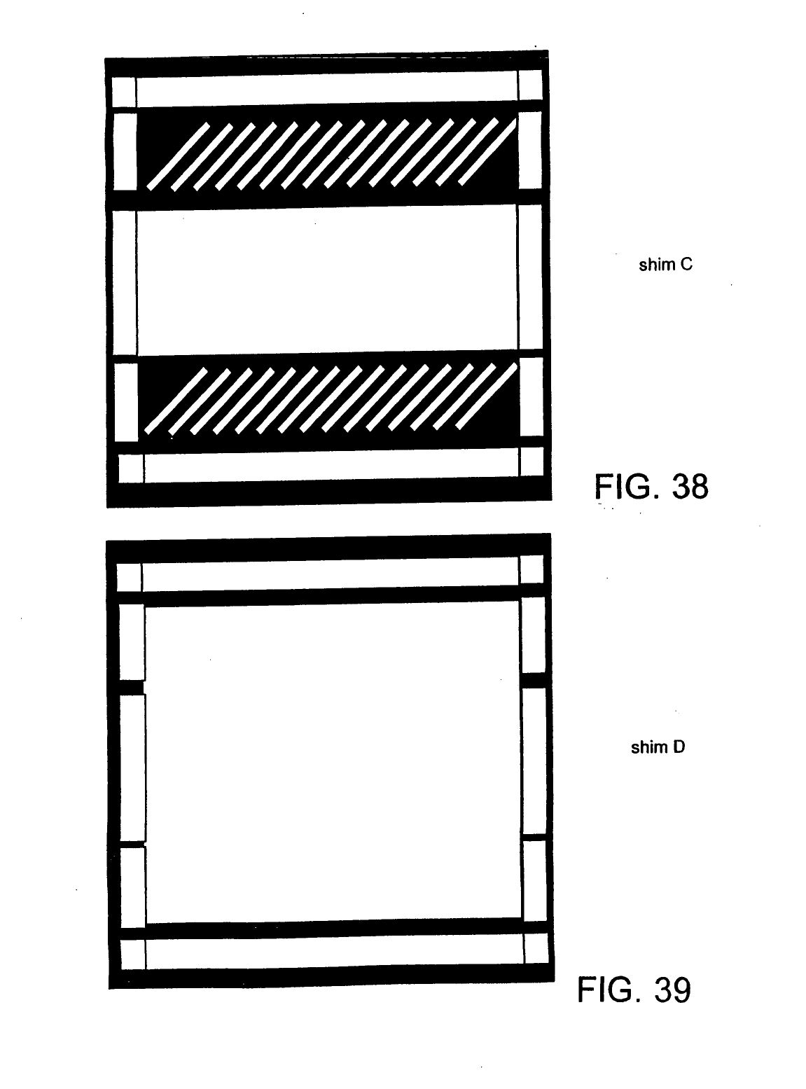

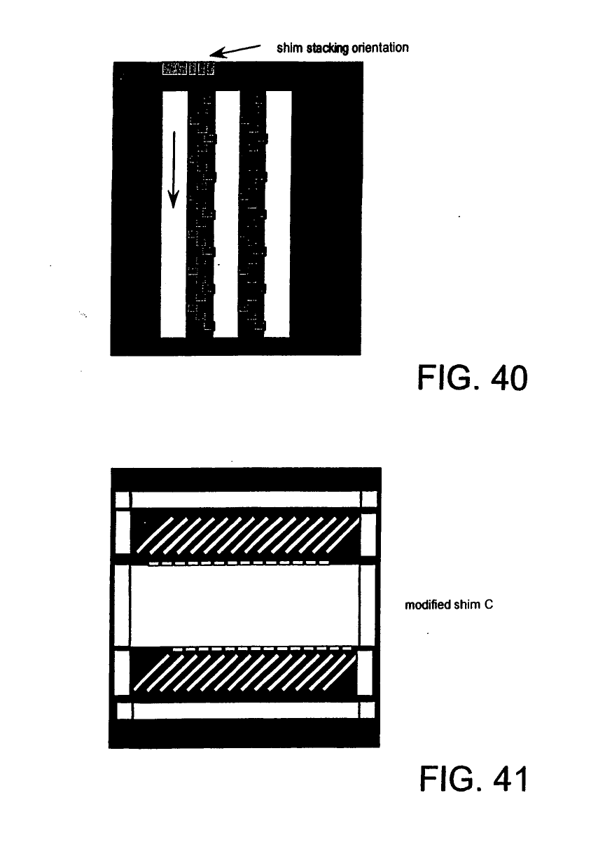

The process microchannels may be assembled using shims A, B, C and D which are illustrated in FIGS. 36-39. The shims may be assembled (and subsequently bonded) using the following sequence: D, A, B, C, D, and so forth. A useful repeating unit may follow the sequence A, B, C, D; and a microchannel processing unit core or a microchannel distillation unit may contain 1, 2, 4, 6, 8, 10 or more of these repeating units. Solid sheets can be used as end plates. These may also be interspersed between repeating units (for example, between sets of at least three repeating units). A liquid may flow from right to left along shim D and between the two surface pattern sheets C and A. The liquid may be held in these regions by capillary forces. The width of the liquid filled channel created by shim D may be such that capillary forces are sufficiently strong enough to retain the fluid in the liquid flow regions of shim D. Liquid may not flow into the central second fluid flow channel. Shim D may have a thickness of about 2 mm or less, and in one embodiment about 1 mm or less. The second fluid may contact the liquid along shim D and may also flow in adjacent shims. The second fluid may flow through the central portion, for example, only the second fluid may flow through shim B.

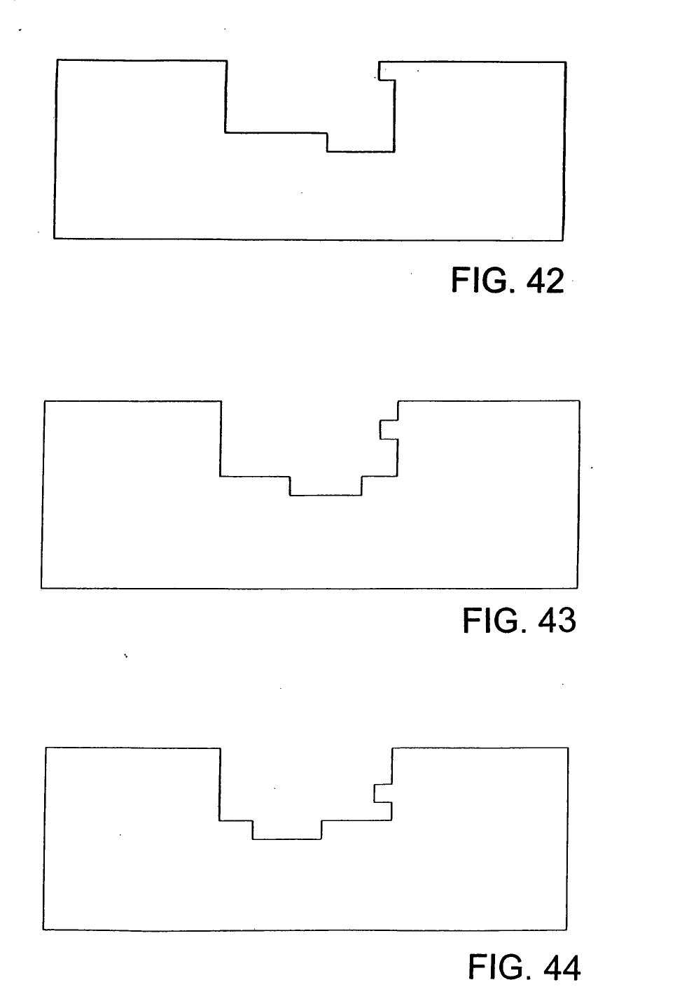

Liquid may be pulled through the channels by suction. Surface features may not be needed for the second fluid flow channel when the second fluid is a gas since diffusion in a gas may be about 1000 times faster. However, surface feature patterns for the second fluid path may be useful (see, for example, modified shim C (FIG. 41) as one embodiment). The surface feature patterns may take the form of recessed zones along the second fluid flow channel in shims A, B and/or C. The recessed zones may be aligned between shims A, B and C such that there may be an angle (albeit created in a step-wise fashion) oblique to the direction of flow to assist in fluid mixing.

FIGS. 42-46 show the creation of different shaped surface features within successively stacked shims such that, when stacked, the resulting channel walls have indentations or protuberances, i.e., surface features. These surface features on the channel walls may be in the form of a desired geometric pattern that may produce a desired enhancement of heat and/or mass transfer within the microchannel. These drawings have an open top to the microchannel only for ease of visualization. The features within a single shim may have identical or different shapes as desired.

When the shims are stacked, the resulting surface features that are created may be diagonal grooves/fins. Since these surface features are created by straight-sided openings in adjacent shims, the resulting surface features in the assembled microchannel (FIG. 46) may have stepwise discontinuities. These may be referred to as “digital” diagonals instead of true, continuous fins or grooves. However, the surface features thus formed may not be limited to diagonal features. They may also form pockets within which coatings may hold up when coated on a vertical wall.

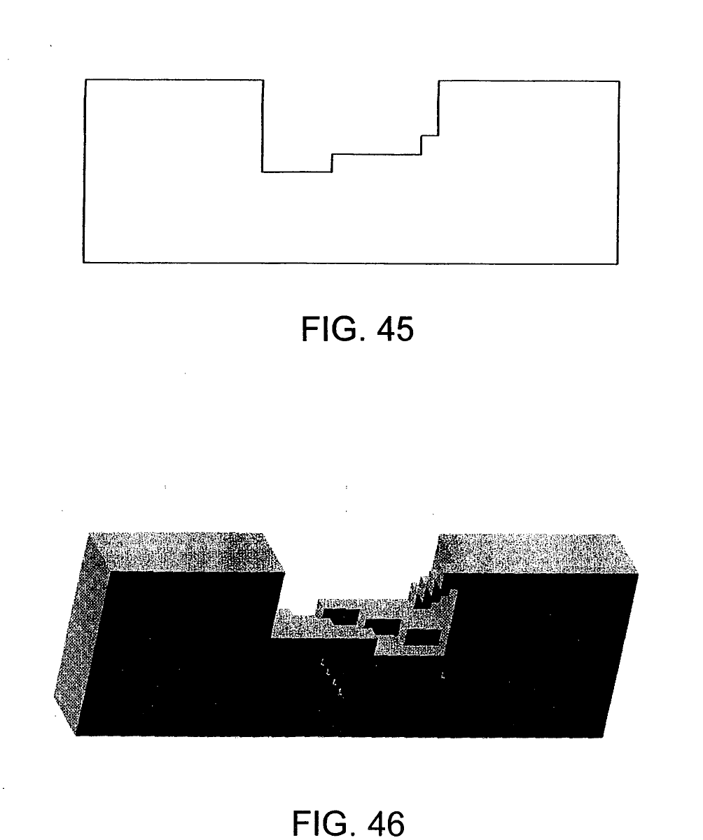

Referring to FIGS. 42-45, shim 1 (FIG. 42) shows a small tab (protuberance) extending leftward from the upper right side of the channel. In the drawing of shim 2 (FIG. 43), the tab is still present and extends the same distance leftward into the channel, but its vertical position has shifted downward. In shim 3 (FIG. 44), the same tab is shifted down even further. Finally, in shim 4 (FIG. 45) the tab has shifted completely to the bottom of the channel and therefore appears only as a stair step in the bottom right corner of the channel. These shims have a finite thickness and thus when they are stacked in successive numerical order, the effect is to create a protuberance or recess that appears to be at a diagonal along the right hand wall. The finite shim thickness means that the diagonal surface feature appears not as a continuous feature with smooth edges but appears as a stair-step, or digitized diagonal. This design and manufacturing technique may be used to create surface features on the walls of channels. These surface features alter the shape and texture of the channel walls and create flow-disturbance features. The concept can be extended to the idea of making indentation features in the channel walls as opposed to protuberance-type features. By varying the thickness of the shims, these types of surface features may be made to appear curved.

Flow is into the page (FIG. 46) into the main channel, and recessed or protruded sections create a structure that approaches a true diagonal feature in a digital or incremental way. The surface features may be formed on one, two or more channel walls, including side walls with this method.

In an alternate embodiment, this digital diagonal approach to creating surface features may be used in a non-orthogonal flow arrangement, where flow is along the shim lines or grains such that depressions in the floor in a digital diagonal manner may emulate a true diagonal surface feature.

In another embodiment, either a digitally diagonal or a layered surface feature groove may be covered for a portion of the length of the channel, thus allowing flow to enter and exit the legs of the surface features, but separating the flow from the main channel during a portion of the run length of the surface feature leg.

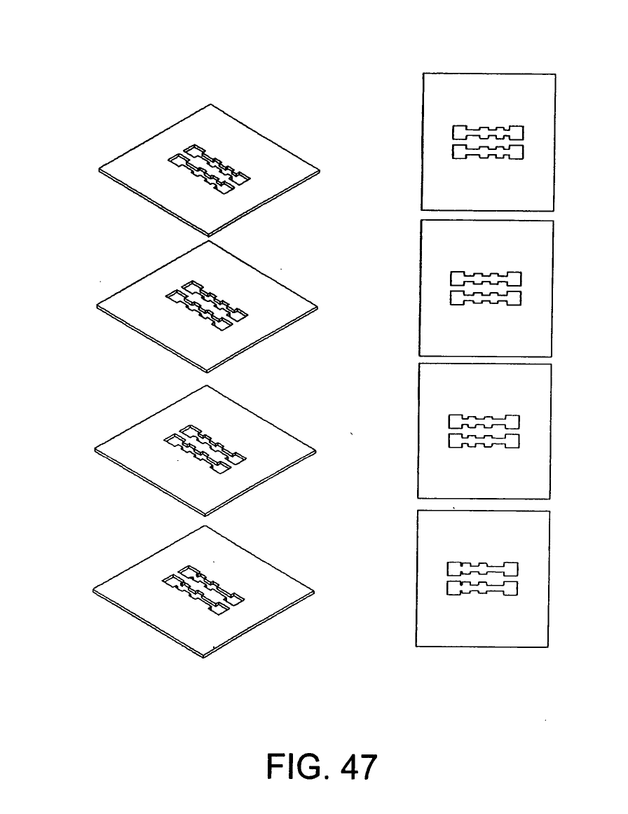

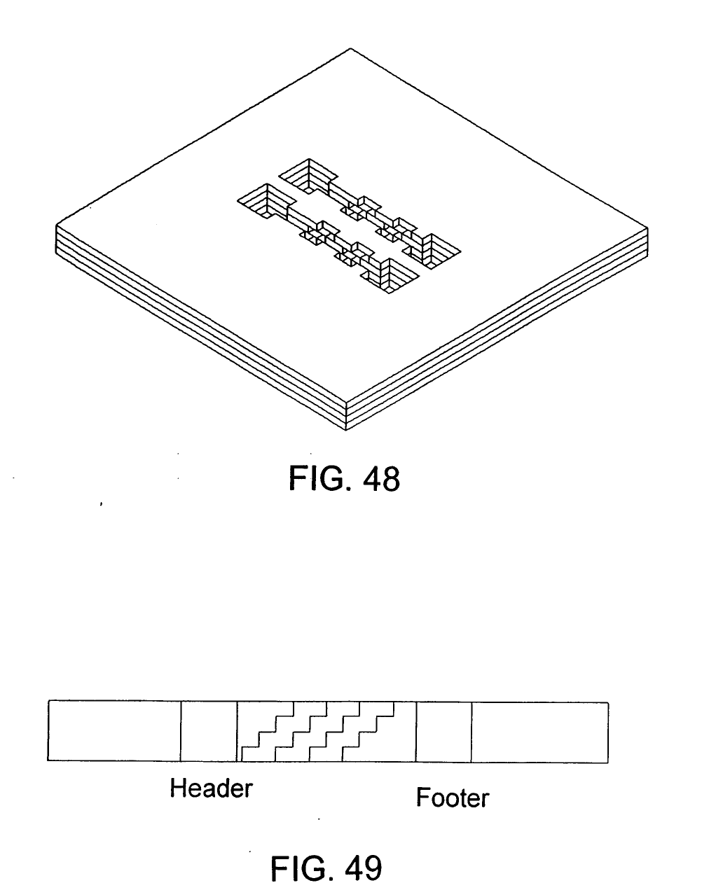

As shown in FIGS. 47-49, surface features may be cut into channels formed by shims and then stacked and joined or bonded. A look at one wall of the microchannel as shown in FIGS. 47-49 represents a diagonal surface feature that is formed in discontinuous parts. The angle of an individual leg is zero and horizontal to the direction of bulk flow. An adjacent leg also has an angle of zero but is off set in lateral position within the channel such that the difference approximates an overall angle when the two or more features are evaluated together. The number of legs in the digital diagonal may be two, three or more. The legs may overlap each other to allow flow to move at a net oblique angle relative to the bulk flow path when the legs are working together.

The second fluid phase may comprise a gas, a liquid, or a mixture thereof. The gas may comprise any gas. In one embodiment, the gas may comprise one or more of air, oxygen, nitrogen, carbon dioxide, steam, ammonia, ozone, chlorine gas, hydrogen, and the like. The gas may comprise one or more oxides of carbon, nitrogen and sulfur. The gas may comprise H₂S, O₂, N₂ and/or one or more noble gases. The gas may comprise one or more gaseous hydrocarbons, for example, hydrocarbons containing 1 to about 5 carbon atoms. These include saturated and unsaturated hyrocarbons. The hydrocarbons include methane, ethane, ethylene, propane, isopropane, propylene, the butanes, the butylenes, the pentanes, cyclopentane, the pentylenes, cyclopentylene, and the like.

The liquid phase and the second fluid phase may comprise any liquid. The liquid and the second fluid phase liquid may be immiscible or partially miscible with each other. One of the liquids may comprise a phase transfer catalyst. The liquid may comprise water, an organic liquid, or a combination thereof. The liquid may comprise one or more liquid hydrocarbons. These may include hydrocarbon compounds containing from 1 to about 24 carbon atoms, and in one embodiment about 5 to about 24 carbon atoms, and in one embodiment about 6 to about 18 carbon atoms, and in one embodiment about 6 to about 12 carbon atoms. The term “hydrocarbon” denotes a compound having a hydrocarbon or predominantly hydrocarbon character. These hydrocarbon compounds may include the following:

(1) Purely hydrocarbon compounds; that is, aliphatic compounds, (e.g., alkane or alkylene), alicyclic compounds (e.g., cycloalkane, cycloalkylene), aromatic compounds, aliphatic- and alicyclic-substituted aromatic compounds, aromatic-substituted aliphatic compounds and aromatic-substituted alicyclic compounds, and the like. Examples include hexane, 1-hexene, dodecane, cyclohexene, cyclohexane, ethyl cyclohexane, benzene, toluene, the xylenes, ethyl benzene, styrene, etc.

(2) Substituted hydrocarbon compounds; that is, hydrocarbon compounds containing non-hydrocarbon substituents which do not alter the predominantly hydrocarbon character of the compound. Examples of the non-hydrocarbon substituents include hydroxy, acyl, nitro, halo, etc.

(3) Hetero substituted hydrocarbon compounds; that is, hydrocarbon compounds which, while predominantly hydrocarbon in character, contain atoms other than carbon in a chain or ring otherwise composed of carbon atoms. The hetero atoms include, for example, nitrogen, oxygen and sulfur.

The liquid may be a natural oil, synthetic oil, or mixture thereof. The natural oils include animal oils and vegetable oils (e.g., castor oil, lard oil) as well as mineral oils such as liquid petroleum oils and solvent treated or acid-treated mineral oils of the paraffinic, naphthenic or mixed paraffinic-naphthenic types. The natural oils include oils derived from coal or shale. The oil may be a saponifiable oil from the family of triglycerides, for example, soybean oil, sesame seed oil, cottonseed oil, safflower oil, and the like. The oil may be a silicone oil (e.g., cyclomethicone, silicon methicones, etc.). The oil may be an aliphatic or naphthenic hydrocarbon such as Vaseline, squalane, squalene, or one or more dialkyl cyclohexanes, or a mixture of two or more thereof. Synthetic oils include hydrocarbon oils such as polymerized and interpolymerized olefins (e.g., polybutylenes, polypropylenes, propylene isobutylene copolymers, etc.); poly(1-hexenes), poly-(1-octenes), poly(1-decenes), etc. and mixtures thereof; alkylbenzenes (e.g., dodecylbenzenes, tetradecylbenzenes, dinonylbenzenes, di-(2-ethylhexyl)benzenes, etc.); polyphenyls (e.g., biphenyls, terphenyls, alkylated polyphenyls, etc.); alkylated diphenyl ethers and alkylated diphenyl sulfides and the derivatives, analogs and homologs thereof and the like. Alkylene oxide polymers and interpolymers and derivatives thereof where the terminal hydroxyl groups have been modified by esterification, etherification, etc., are synthetic oils that may be used. The synthetic oil may comprise a poly-alpha-olefin or a Fischer-Tropsch synthesized hydrocarbon.

The liquid may comprise a normally liquid hydrocarbon fuel, for example, a distillate fuel such as motor gasoline as defined by ASTM Specification D439, or diesel fuel or fuel oil as defined by ASTM Specification D396.

The liquid may comprise one or more oxygenates, for example, fatty alcohols, fatty acid esters, or mixtures thereof. The fatty alcohol may be a Guerbet alcohol. The fatty alcohol may contain from about 6 to about 22 carbon atoms, and in one embodiment about 6 to about 18 carbon atoms, and in one embodiment about 8 to about 12 carbon atoms. The fatty acid ester may be an ester of a linear fatty acid of about 6 to about 22 carbon atoms with linear or branched fatty alcohol of about 6 to about 22 carbon atoms, an ester of a branched carboxylic acid of about 6 to about 13 carbon atoms with a linear or branched fatty alcohol of about 6 to about 22 carbon atoms, or a mixture thereof. Examples include myristyl myristate, myristyl palmitate, myristyl stearate, myristyl isostearate, myristyl oleate, myristyl behenate, myristyl erucate, cetyl myristate, cetyl palmitate, cetyl stearate, cetyl isostearate, cetyl oleate, cetyl behenate, cetyl erucate, stearyl myristate, stearyl palmitate, stearyl stearate, stearyl isostearate, stearyl oleate, stearyl behenate, stearyl erucate, isostearyl myristate, isostearyl palmitate, isostearyl stearate, isostearyl isostearate, isostearyl oleate, isostearyl behenate, isostearyl oleate, oleyl myristate, oleyl palmitate, oleyl stearate, oleyl isostearate, oleyl oleate, oleyl behenate, oleyl erucate, behenyl myristate, behenyl palmitate, behenyl stearate, behenyl isostearate, behenyl oleate, behenyl behenate, behenyl erucate, erucyl myristate, erucyl palmitate, erucyl stearate, erucyl isostearate, erucyl oleate, erucyl behenate and erucyl erucate. The fatty acid ester may comprise: an ester of alkyl hydroxycarboxylic acid of about 18 to about 38 carbon atoms with a linear or branched fatty alcohol of about 6 to about 22 carbon atoms (e.g., dioctyl malate); an ester of a linear or branched fatty acid of about 6 to about 22 carbon atoms with a polyhydric alcohol (for example, propylene glycol, dimer diol or trimertriol) and/or a Guerbet alcohol; a triglyceride based on one or more fatty acids of about 6 to about 18 carbon atoms; a mixture of mono-, di- and/or triglycerides based on one or more fatty acids of about 6 to about 18 carbon atoms; an ester of one or more fatty alcohols and/or Guerbet alcohols of about 6 to about 22 carbon atoms with one or more aromatic carboxylic acids (e.g., benzoic acid); an ester of one or more dicarboxylic acids of 2 to about 12 carbon atoms with one or more linear or branched alcohols containing 1 to about 22 carbon atoms, or one or more polyols containing 2 to about 10 carbon atoms and 2 to about 6 hydroxyl groups, or a mixture of such alcohols and polyols; an ester of one or more dicarboxylic acids of 2 to about 12 carbon atoms (e.g., phthalic acid) with one or more alcohols of 1 to about 22 carbon atoms (e.g., butyl alcohol, hexyl alcohol); an ester of benzoic acid with linear and/or branched alcohol of about 6 to about 22 carbon atoms; or mixture of two or more thereof. The liquid may comprise: one or more branched primary alcohols of about 6 to about 22 carbon atoms; one or more linear and/or branched fatty alcohol carbonates of about 6 to about 22 carbon atoms; one or more Guerbet carbonates based on one or more fatty alcohols of about 6 to about 22 carbon atoms; one or more dialkyl (e.g., diethylhexyl) naphthalates wherein each alkyl group contains 1 to about 12 carbon atoms; one or more linear or branched, symmetrical or nonsymmetrical dialkyl ethers containing about 6 to about 22 carbon atoms per alkyl group; one or more ring opening products of epoxidized fatty acid esters of about 6 to about 22 carbon atoms with polyols containing 2 to about 10 carbon atoms and 2 to about 6 hydroxyl groups; or a mixture of two or more thereof.

The water may be taken from any convenient source. The water may be deionized or purified using osmosis or distillation.

In one embodiment, the liquid phase or the second fluid phase may comprise a critical fluid.

The phase transfer catalyst may comprise one or more crown ethers. These may contain one or more alkali metal cations useful for catalysis. Crown ethers may be heterocyclic compounds that may be referred to as cyclic oligomers of ethylene oxide. A repeating unit of any crown ether is ethyleneoxy, i.e., —CH₂CH₂O—, which repeats twice in dioxane and six times in 18-crown-6. The nine-membered ring 1, 4, 7-trioxonane (9-crown-3) may be called a crown and can interact with cations. Macrocycles of the (—CH₂CH₂O—)ₙ type in which n≧4 may be referred to as crown ethers rather than by their systematic names.

The disclosed distillation process may be used to separate any two or more fluids that have different volatilities. The fluids may have boiling points that vary by up to about 100° C., and in one embodiment up to about 20° C., and in one embodiment up to about 10° C., and in one embodiment up to about 5° C., and in one embodiment up to about 2° C., and in one embodiment up to about 1° C. The process may be suitable for handling difficult separations such as ethane from ethylene wherein the fluids being separated have very similar volatilities. Examples of the separations that may be effected using the disclosed process may include, in addition to ethane from ethylene; styrene from ethylbenzene separation and associated purification of styrene monomer in an ethylbenzene dehydrogenation plant; separation of oxygen from nitrogen in the cryogenic towers of an air separation plant; separation of cyclohexane from cyclohexanol/cyclohexanone in a nylon monomers plant; deisobutanizers in a gasoline alkylation plant; naphtha splitters upstream from a naphtha reforming plant; and the like. The process may be used to separate hexane from cyclohexane. The process may be used to separate benzene from toluene, methanol from water, or isopropanol from isobutanol.

The mass transfer of the liquid phase to the second fluid phase in the process microchannel may be at least about 1% by weight based on the weight of the liquid phase entering the process microchannel, and in on embodiment at least about 5% by weight, and in one embodiment at least about 10% by weight, and in one embodiment at least about 15% by weight, and in one embodiment at least about 20% by weight, and in one embodiment at least about 25% by weight.

In one embodiment, a chemical reaction between the liquid phase and the second fluid phase may be conducted in the process microchannels.

The mass transfer of the second fluid phase to the liquid phase in the process microchannel may be at least about 1% by weight based on the weight of the second fluid phase entering the process microchannel, and in on embodiment at least about 5% by weight, and in one embodiment at least about 10% by weight, and in one embodiment at least about 15% by weight, and in one embodiment at least about 20% by weight, and in one embodiment at least about 25% by weight.

The heat flux for heat exchange in the microchannel reactor may be in the range from about 0.01 to about 500 watts per square centimeter of surface area of the one or more process microchannels (W/cm²) in the microchannel reactor, and in one embodiment in the range from about 0.1 to about 250 W/cm², and in one embodiment from about 1 to about 125 W/cm². The heat flux for convective heat exchange in the microchannel reactor may be in the range from about 0.01 to about 250 W/cm², and in one embodiment in the range from about 0.1 to about 50 W/cm², and in one embodiment from about 1 to about 25 W/cm², and in one embodiment from about 1 to about 10 W/cm². The heat flux for phase change and/or an exothermic or endothermic reaction of the heat exchange fluid may be in the range from about 0.01 to about 500 W/cm², and in one embodiment from about 1 to about 250 W/cm², and in one embodiment, from about 1 to about 100 W/cm², and in one embodiment from about 1 to about 50 W/cm², and in one embodiment from about 1 to about 25 W/cm², and in one embodiment from about 1 to about 10 W/cm².

In a scale up device, for certain applications, it may be required that the mass of the process fluid be distributed uniformly among the microchannels. Such an application may be when the process fluid is required to be heated or cooled down with adjacent heat exchange channels. The uniform mass flow distribution may be obtained by changing the cross-sectional area from one parallel microchannel to another microchannel. The uniformity of mass flow distribution may be defined by Quality Index Factor (Q-factor) as indicated below. A Q-factor of 0% means absolute uniform distribution.

$$Q = \frac{{\dot{m}}_{max} - {\dot{m}}_{min}}{{\dot{m}}_{max}} \times 100$$

A change in the cross-sectional area may result in a difference in shear stress on the wall. In one embodiment, the Q-factor for the process microchannels may be less than about 50%, and in one embodiment less than about 20%, and in one embodiment less than about 5%, and in one embodiment less than about 1%.

In one embodiment, the Q-factor for the process microchannel may be less than about 50%. In one embodiment, the Q-factor may be less than about 5%. In one embodiment, the Q-factor may be less than about 1%.

The superficial velocity for the liquid flowing in the process microchannels may be at least about 0.1 meters per second (m/s), and in one embodiment at least about 0.2 m/s, and in one embodiment at least about 0.5 m/s, and in one embodiment at least about 1 m/s, and in one embodiment in the range from about 0.1 to about 100 m/s, and in one embodiment in the range from about 0.1 to about 20 m/s, and in one embodiment in the range from about 0.1 to about 10 m/s, and in one embodiment in the range from about 0.1 to about 5 m/s.

The superficial velocity for the gas flowing in the process microchannels may be at least about 0.1 m/s, and in one embodiment at least about 1 m/s, and in one embodiment at least about 10 m/s, and in one embodiment in the range from about 0.1 to about 250 m/s, and in one embodiment in the range from about 0.1 to about 5 m/s, and in one embodiment in the range from about 1 to about 20 ms, and in one embodiment in the range from about 10 to about 250 m/s.

In one embodiment, the superficial velocity for the liquid may be at least about 0.01 m/s, and in one embodiment in the range from about 0.01 to about 100 m/s, while the superficial velocity for the gas may be at least about 0.1 m/s, and in one embodiment in the range from about 0.1 to about 250 m/s.

The dynamic pressure for the liquid in the process microchannels may be at least about 0.1 Pa (9.87×10⁻⁷ atm), and in one embodiment at least about 5 Pa (4.93×10⁻⁵ atm), and in one embodiment at least about 25 Pa (0.000248 atm), and in one embodiment in the range from about 0.1 to about 100,000 Pa (9.87×10⁻⁷ to 0.987 atm). The dynamic pressure for the gas in the process microchannels may be at least about 0.5 Pa (4.93×10⁻⁶ atm), and in one embodiment at least about 5 Pa (4.93×10⁻⁵ atm), and in one embodiment at least about 10 Pa (9.87×10⁻⁵ atm), and in one embodiment in the range from about 0.5 to about 200 Pa (4.93×10⁻⁶ to 0.00197 atm).

The liquid may have a viscosity in the range from about 0.001 to about 1000 centipoise, and in one embodiment in the range from about 0.1 to about 500 centipoise. The gas may have a viscosity in the range from about 0.001 to about 1 centipoise, and in one embodiment from about 0.01 to about 0.1 centipoise.

The space velocity (or gas hourly space velocity (GHSV)) for the flow of the process fluid in the process microchannels may be at least about 10 hr⁻¹ (normal liters of feed/hour/liter of volume within the process microchannels). The space velocity may be in the range from about 100 to about 1,000,000 hr⁻¹, and in one embodiment from 10,000 to about 100,000 hr⁻¹.

The temperature of the fluids entering the process microchannels may be in the range from about −200° C. to about 950° C., and in one embodiment about 0° C. to about 600° C., and in one embodiment about 20° C. to about 300° C., and in one embodiment in the range from about 150° C. to about 270° C.

The temperature of the fluids within the process microchannels may range from about −200° C. to about 950° C., and in one embodiment from about 0° C. to about 600° C., and in one embodiment from about 20° C. to about 300° C., and in one embodiment in the range from about 150° C. to about 270° C.

The temperature of the fluids flowing out of the process microchannels may be in the range from about −200° C. to about 950° C., and in one embodiment about 0° C. to about 600° C., and in one embodiment from about 20° C. to about 300° C., and in one embodiment in the range from about 150° C. to about 270° C.

The pressure within the process microchannels may be at least about 5 atmospheres, and in one embodiment at least about 10 atmospheres, and in one embodiment at least about 15 atmospheres, and in one embodiment at least about 20 atmospheres, and in one embodiment at least about 25 atmospheres, and in one embodiment at least about 30 atmospheres. In one embodiment the pressure may range from about 5 to about 250 atmospheres, and in one embodiment from about 10 to about 50 atmospheres, and in one embodiment from about 10 to about 30 atmospheres, and in one embodiment from about 10 to about 25 atmospheres, and in one embodiment from about 15 to about 25 atmospheres.

The pressure drop of the process fluid as it flows in the process microchannels may range up to about 15 atmospheres per meter of length of the process microchannel (atm/m), and in one embodiment up to about 10 atm/m, and in one embodiment up to about 5 atm/m.

The Reynolds Number for the flow of gas or vapor in the process microchannels may be in the range from about 10 to about 8000, and in one embodiment from about 100 to about 2000. The Reynolds Number for the flow of liquid in the process microchannels may be in the range from about 10 to about 4000, and in one embodiment from about 100 to about 2000.

The heat exchange fluid entering the heat exchange channels may be at a temperature in the range from about −200° C. to about 950° C., and in one embodiment from about 0° C. to about 600° C. The heat exchange fluid exiting the heat exchange channels may be at a temperature in the range from about −200° C. to about 950° C., and in one embodiment about 0° C. to about 600° C. The residence time of the heat exchange fluid in the heat exchange channels may be in the range from about 50 to about 5000 ms, and in one embodiment from about 100 to about 1000 ms. The pressure drop for the heat exchange fluid as it flows in the heat exchange channels may range up to about 10 atm/m, and in one embodiment from about 0.01 to about 10 atm/m, and in one embodiment from about 0.02 to about 5 atm/m. The heat exchange fluid may be in the form of a vapor, a liquid, or a mixture of vapor and liquid. The Reynolds Number for the flow of vapor in the heat exchange channels may be from about 10 to about 8000, and in one embodiment from about 100 to about 2000. The Reynolds Number for the flow of liquid in heat exchange channels may be from about 10 to about 8000, and in one embodiment about 100 to about 2000.

A disadvantage of conventional hardware used for vapor-liquid contacting unit operations is that conventional trays and packing may be difficult to operate or operate less efficiently when the process is operated at feed rates below about 50% design capacity. An advantage of the disclosed process relates to an ability to operate the process in a modular fashion for effective operation at a wide range of capacities. The disclosed process may be designed with numerous modules and sections of modules. Turndown operation can be achieved with directing flows to active modules and sections of modules, where the process channels are operating efficiently at close capacity. For example, an overall process may be operating at 50% capacity, but the active process microchannels may be operating at 80-90% capacity.

In one embodiment, the disclosed process may provide for the separation of ethylene from a fluid mixture comprising ethylene and ethane in a distillation unit having a height of up to about 20 meters, and in one embodiment up to about 10 meters, and in one embodiment up to about 5 meters, and in one embodiment up to about 3 meters, with purity levels of ethylene of at least about 95% by volume, and in one embodiment at least about 98% by volume, and in one embodiment at least about 99% by volume.

### EXAMPLE 1

A microchannel processing unit is used to separate ethane from ethylene.

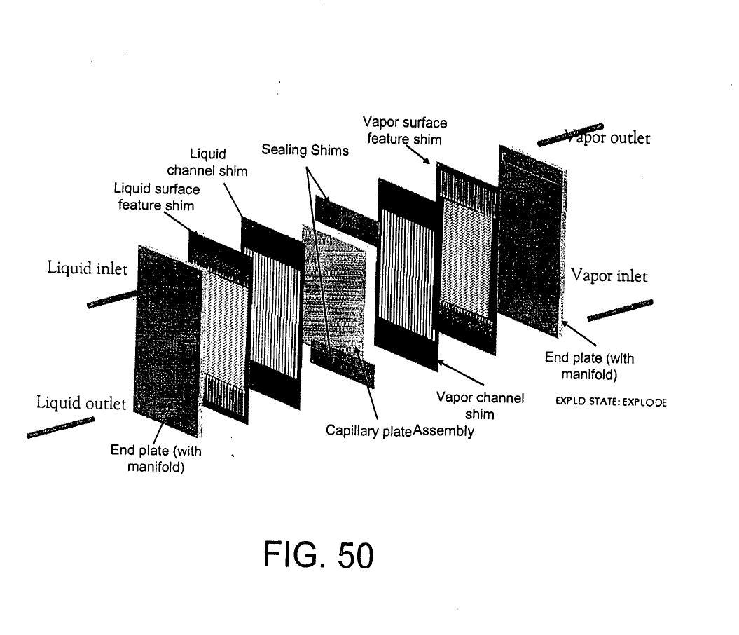

The processing unit is made out of stainless steel 304 plates and stainless steel 304 gshims. FIG. 50 shows an exploded view of the assembly of various shims and plates in the processing unit. The overall size of the end plate is 9.563″×6.033″×0.605″. On either end of the plate is a machined manifold for the distribution of fluid in to the liquid channel. The manifold opening is 0.5″ wide and 0.1″ deep. The inlet and the outlet of the manifold are at diagonally opposite corners of the end plate. The plate is chamfered at 45° on the edges for weldment of the assembly. Slots and holes are designed for alignment of shims and plates during assembly. The end plate next to the vapor surface feature shim has the same dimensions.

The overall size of the liquid channel shim is 9.375″×5.845″×0.005″. There are 20 through slots made in the shim to make the channel shim as shown in FIG. 50. Each channel slot is 0.2″ wide and 5.5″ long and separated from the other slot by 0.050″ wall. The vapor channel shim is the same in overall design except the thickness of the shim is 0.010″ instead of 0.005″.

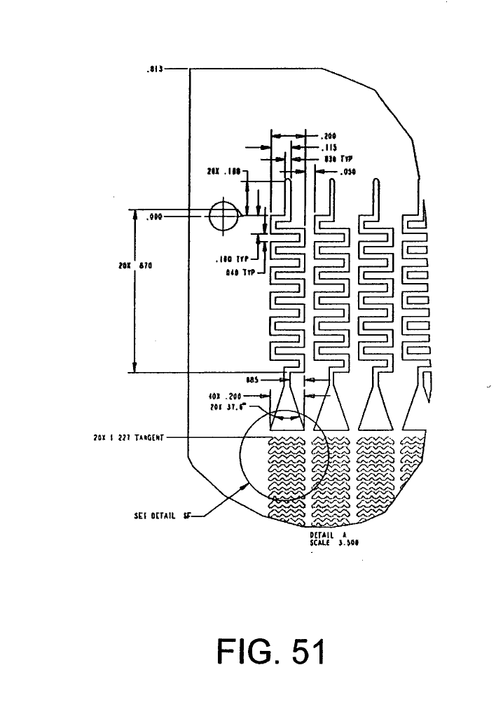

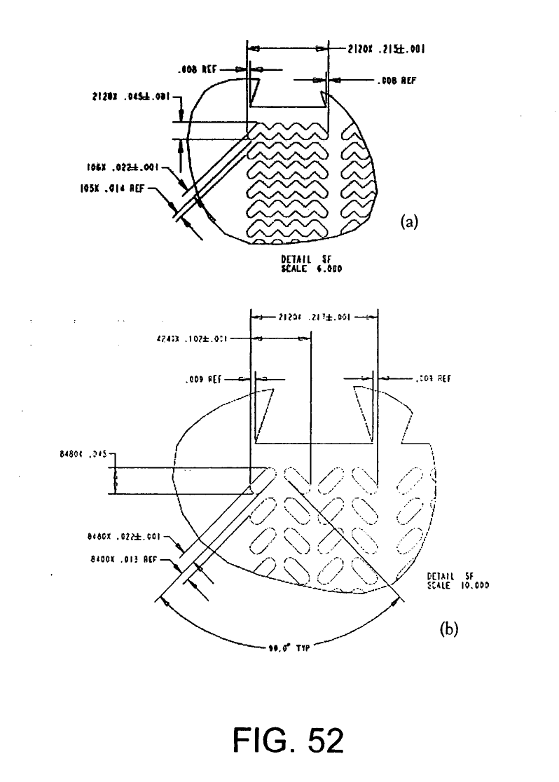

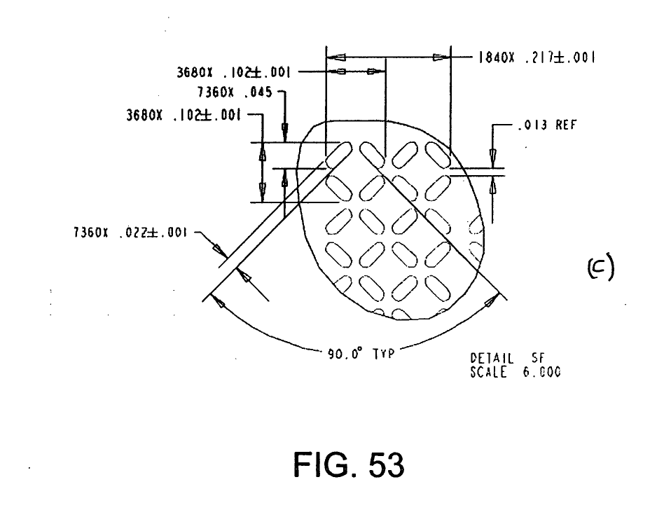

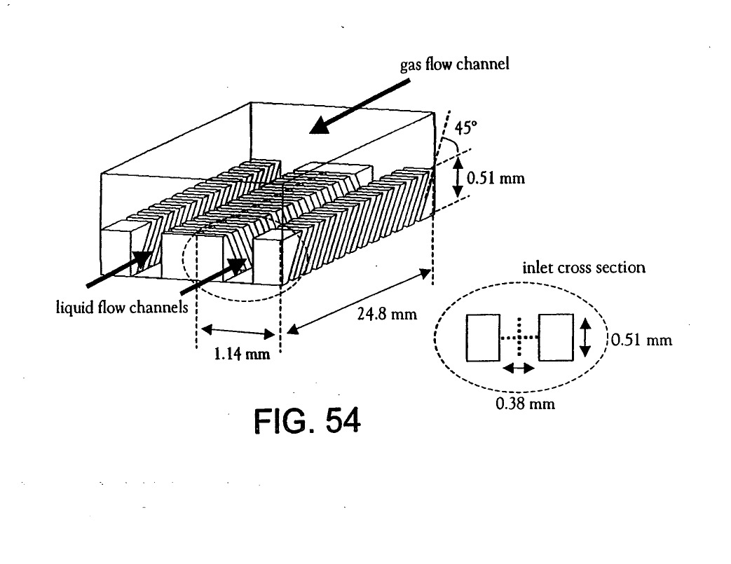

The overall size of the surface feature shim is the same as that of liquid channel shim except that the thickness of the shim is 0.015″. The serpentine shaped features on the upper section of the shim are designed to achieve uniform flow distribution in the channels and are referred to as flow distribution features. Each flow channel has a flow distribution feature. All the flow distribution features are identical in design. The overall of span of the feature (from left bend to right bend ) is the same as the width of the channel (0.2″). The flow channel in every distribution feature is 0.030″ wide and 0.015″ deep (same as the shim thickness). More details of the flow distribution section are shown in FIG. 51. Below the flow distribution features section is the surface feature section. The connection between the flow distribution feature and surface feature section is made as shown in FIG. 51. The overall size of the surface feature section is big enough to cover the channel section in the liquid channel shim. Three different types of surface feature design details are shown in FIG. 52, types (a) and (b), and FIG. 53, type (c). There are a total of 2120 surface features of type (a), 8480 surface features of type (b) and 7360 surface features of type (c). Below the surface feature section is a liquid exit section. The vapor surface feature shim is the same as liquid surface channel shim in dimensions.

The capillary plate is an electroformed wire cloth made out of nickel. The number of meshes is 1000×1000 and wire diameter is 0.00029″. The thickness of the capillary plate is 0.0002″. The overall dimension of the screen is 5.47″×5.375″. The surface feature section from the additional surface feature shims are cut and attached to both sides of the capillary plate to make the capillary plate assembly.

All the shims are made by a photochemical machining method. After fabrication all the shims and plates are arranged in the way shown in FIG. 50. The final assembly is welded together.

The operation of the device is as follows. The liquid flows from the liquid inlet, into the manifold in the liquid end plate, then enters the flow distribution features in the liquid surface feature shim, into the liquid channel in liquid channel shim. In liquid channel shim, it contacts the surface features on the surface feature shim and the surface features on the capillary plate assembly. Mass is transferred through the capillary plate to the vapor side. Then the liquid flows out to exit channels in surface feature shim to the other manifold in liquid end plate and out of the device through an outlet tube. The vapor flows in the same way through the shims and plates.

The flow distribution features create a pressure drop through frictional losses between the fluid and wall that are higher (>2×, >5×, or even >10×) than the pressure drop of the process channel. As such, the restriction in the flow distribution features maintains a nearly uniform flow distribution between all the channels, where the quality index Q (defined below) is less than 30%, and in one embodiment, less than 15%, and in one embodiment, less than 10%. The pressure drop in the process channels is on the order of 0.01 psi to 1 psi for flow lengths in the range of 1 to 50 cm and residence times from 0.1 to 10 seconds. The pressure drop in the flow distribution features is on the order of 0.1 to 10 psi. In a commercial distillation unit, the total channel length may be on the order of 10 to 200 cm.

$$Q = \frac{{\dot{m}}_{max} - {\dot{m}}_{min}}{{\dot{m}}_{max}} \times 100$$

where: \dot{m}ₘₐₓ=Maximum mass flow rate in the channel, kg/s
   \dot{m}ₘᵢₙ=Minimum mass flow rate in the channel, kg/s
   Q=Quality index

In one embodiment, the surface feature sheet may be placed on either side of the contactor sheet such that mass preferentially spends more time in the active surface features and near the mass transfer interface. In one embodiment, there would be no surface feature on any other wall except where mass is exchanged between the two phases.

In one embodiment, active surface features may be placed on the top and bottom of the microchannels and the two phases allowed to freely mix while flowing in a countercurrent manner to increase the interfacial surface area for mass transfer. The gas and liquid may be disengaged in a small axial distance relative to the overall length of the distillation unit to prevent back mixing.

Enhanced contact time between liquid and vapor phases may be important for maximizing mass transfer. Effective application of microchannel technology to large-capacity production processes may call for good performance at intermediate to high laminar Reynolds numbers (ranging from about 50 to about 2200). By placing surface features near the interfacial contact region bulk mixing and interfacial contact time may be enhanced.

The studies described below involve numerical simulations of flow through channels. All analyses are performed using the CFD package Fluent. The example that follows shows enhanced performance at higher Reynolds numbers. A comparison with an alternate design option is included to clarify the benefit of the disclosed configuration. The same fluid density and viscosity are used in all cases, 480 kg/m³ and 8.3×10⁻⁵ kg/m-s, respectively.

The two cases considered focus on comparing the residence time of the liquid in the main channel with its residence time in the surface features. Both cases assume that liquid flows through a modified rectangular channel that is in contact with a vapor phase on one side. In the first case, the side of the channel in contact with the vapor is open, and the liquid flowing past the open sidewall experiences no-stress; all other sidewalls are assumed to be no slip boundaries. In the second case, all four channel sidewalls are assumed to be no slip boundaries, whether corresponding to solid walls or potentially permeable screens. FIGS. 54 and 55-56 show representative system flow configurations.

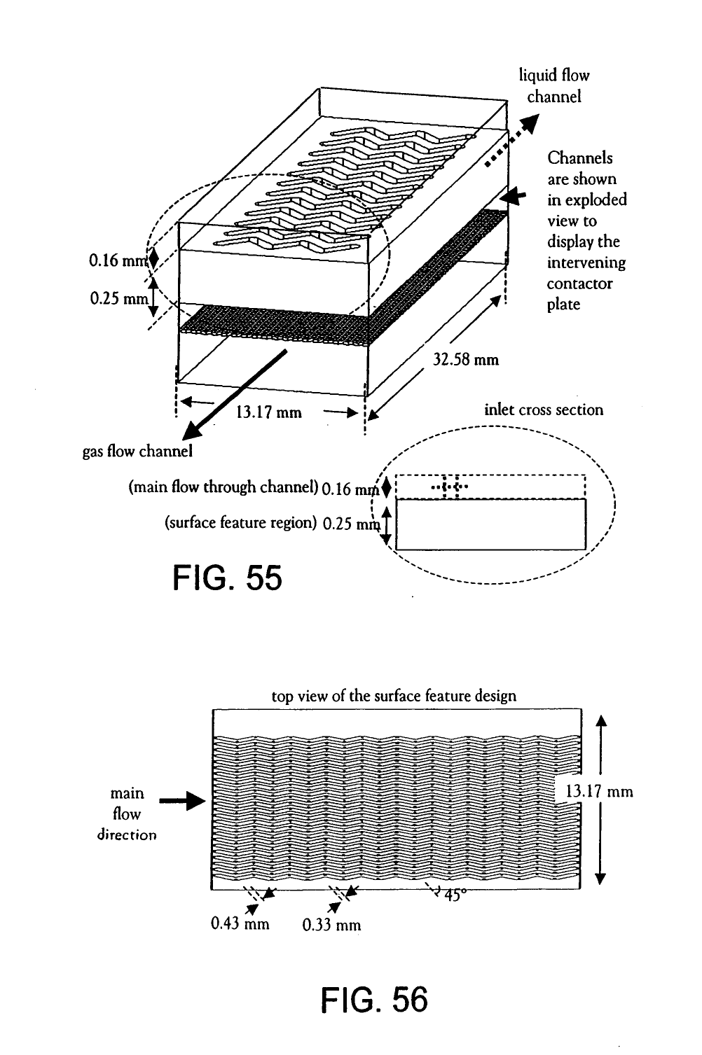

FIG. 55 is a schematic illustration of the first channel configuration, including a liquid flow path open to the vapor phase. The modeled channel section has a total width of 1.14 mm, a height of 0.51 mm, and a length 24.8 mm. 61 surface features are included in the total channel length. For ease of viewing, the schematic illustration does not reflect the number of surface features included in the model. An expanded view of the channel inlet cross section is shown for reference. The dotted cross marks the initial position of the particle tracers monitored for the analysis.

FIGS. 55 and 56 show schematic illustrations of the second channel configuration, including a liquid flow path separated from the vapor phase by a porous screen. The modeled channel section has a total width of 13.17 mm, a height of 0.42 mm (including a 0.16 mm main channel height and a 0.25 mm surface feature region thickness), and a length of 32.58 mm (surface features are not to scale). 24 surface feature sequences are included in the total channel length, as shown in the expanded view in FIG. 56. Each surface section sequence has a 0.33 mm separation distance. The 10 connected chevrons that span the width of the channel have a width of 0.43 mm; their sides are inclined ±45° relative to the main channel flow direction. The expanded view of the channel inlet cross section is also shown for reference. The dotted lines mark the initial positions of the particle tracers monitored for the analysis.

FIG. 54 shows the configuration for a 24.8 mm long channel with an inlet cross-section that is 0.51 mm (in the direction perpendicular to the open wall) by 0.38 mm. Surface features are incorporated in the two opposing, no slip sidewall of the channel, starting 2.54 mm downstream of the inlet plane. The surface features consist of grooves that extend out from the main flow channel, 0.38 mm in the direction perpendicular to the main axis of flow. The grooves are straight and perpendicular to the surface from which they protrude, but incline 45° relative to the open surface. The surface features of one wall are positioned at 90° with respect to the surface features on the opposing wall. Viewed from the channel side, the opposing surface features form a perfect cross. The span of the surface features and their width is 0.127 mm.

FIG. 55 shows the configuration for a 32.5 mm long channel with an inlet cross section that is 13.17 mm by 0.419 mm. 1.75 mm downstream of the inlet plane, one of the two 13.17 mm sidewalls is expanded by 0.254 mm to include connected surface features that span the entire wall width. The surface features have a 0.43 mm width and a 0.33 mm span; they are angled 45° relative to the inlet plane, 90° relative to each other. Inserts in FIG. 55 detail the surface feature configuration.

Analysis for the first configuration involves comparison of the residence time for uniform inlet flow velocities of 0.1 and 0.6 m/s; these correspond to Reynolds numbers of 220 and 1322, respectively. Analysis of the second configuration involves residence time comparisons for inlet flow velocities of 0.1 and 0.2 m/s; these correspond to Reynolds numbers of 95 and 191, respectively. All Reynolds numbers are calculated based on the minimum gap dimension at the inlet plane. Residence times are calculated for representative tracer particles assumed to enter the flow channel at the beginning of the simulation. Their position is monitored and their cumulative residence time in the main channel and surface feature regions are calculated over the course of the simulation. To obtain a representative measure of the behavior of the fluid entering through the whole main channel cross-section, tracer particles are released at the center lines of the inlet planes, as shown in the inserts of FIGS. 54 and 55. For data manageability, results that pertain to the second configuration are limited to tracer particles released in a 2.5 mm section of the 13.2 mm channel width.

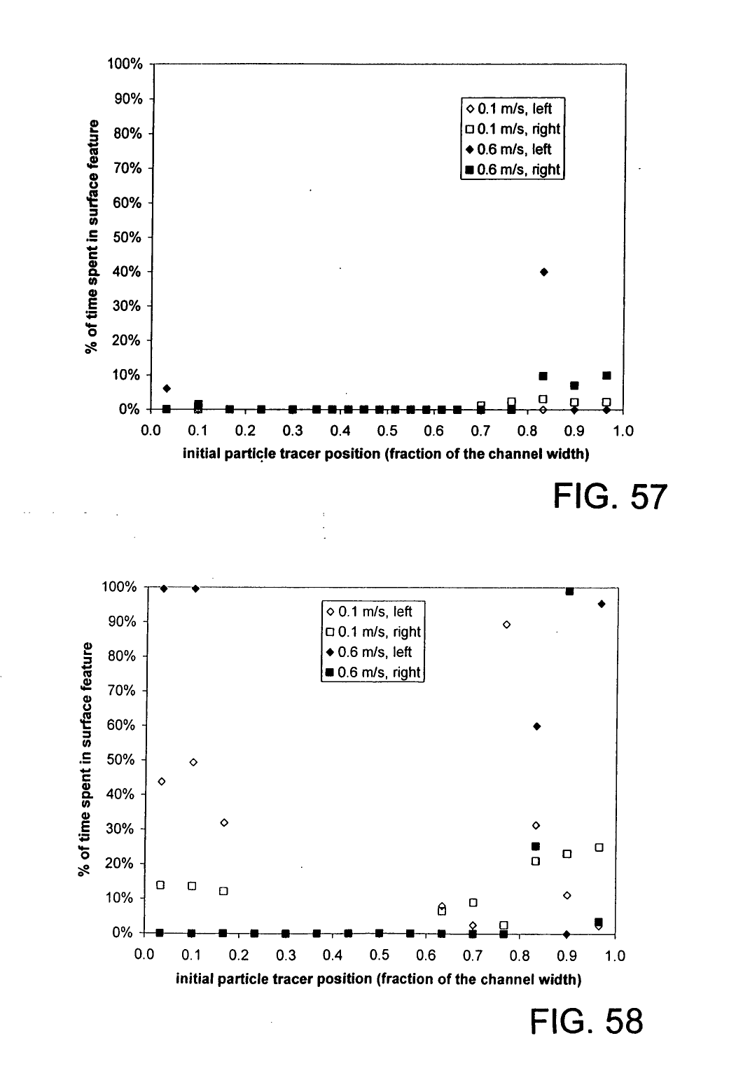

FIGS. 57 through 60 show the relative residence time of tracer particles in the surface features for all velocities and configurations considered. The abscissa marks the initial position of the tracer particles relative to the overall inlet channel dimension in the gap direction or perpendicular to the gap direction, as noted.

As FIGS. 57 and 58 show, the first configuration leads to no penetration into the surface features for particle tracers that originate at the center of the microchannel and some penetration for the particles that originate at the edges of the channel inlet. Tracer particles released along the center line that marks the symmetry plane of the system penetrate the surface features to a greater extent than the particles released along the perpendicular center line. The lower Reynolds number leads to slightly better surface feature penetration.

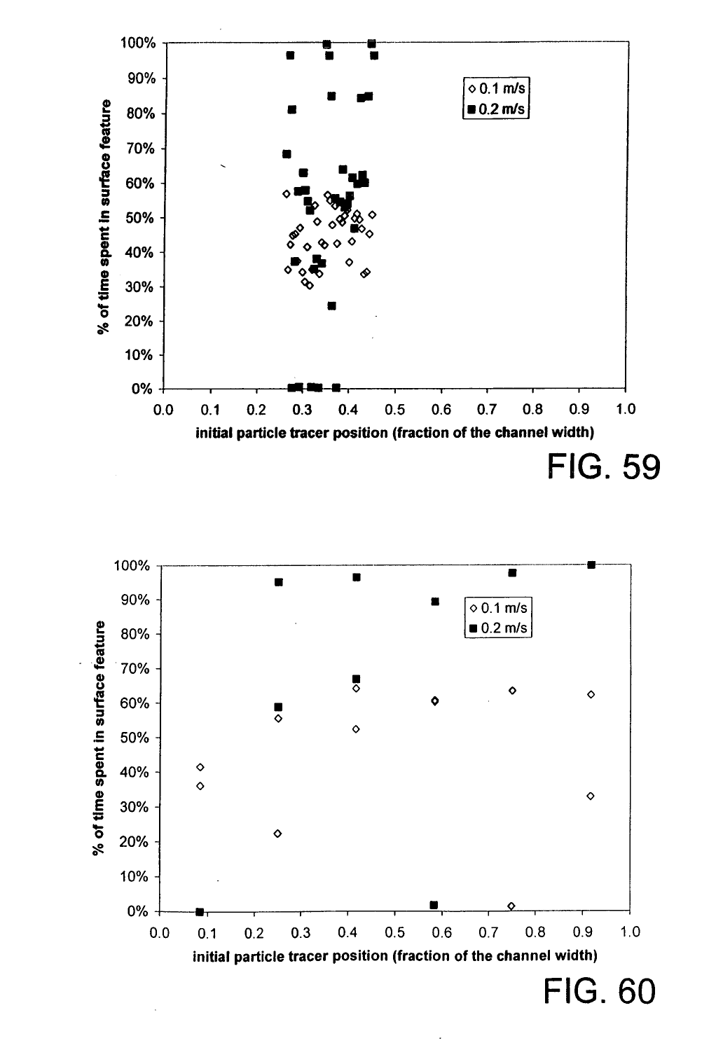

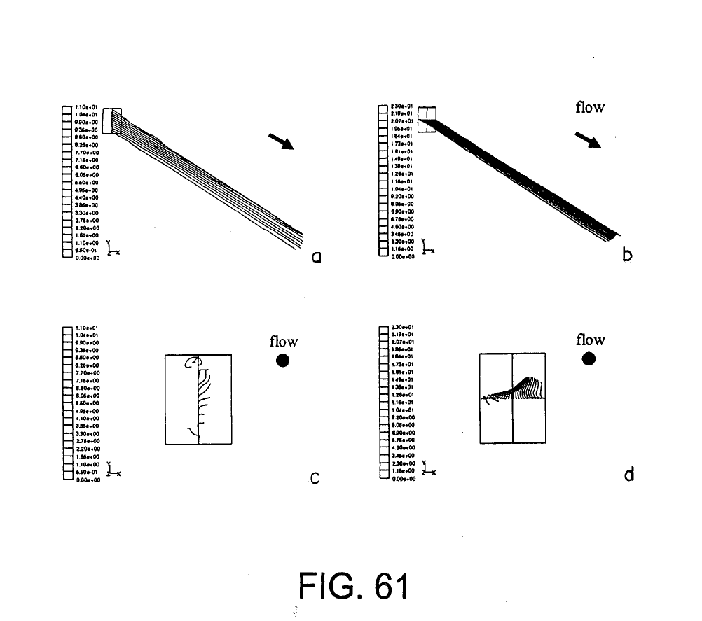

As FIGS. 59 and 60 highlight, in contrast to the first configuration, the second configuration leads to significant penetration into the surface features for particle released from all sections of the inlet plane. Improved penetration is also noted at the higher Reynolds numbers.

Overall, when the transfer surface (whether mass or energy) is integrated as the surface feature backwall and processes involve moderately high laminar Reynolds numbers, transfer can be more efficiently promoted to provide enhanced performance.

For the case of a liquid flow velocity of 0.1 m/s and a gaseous flow velocity of 0.58 m/s, a 2.5 cm length distillation unit for the separation of ethane and ethylene at 28 bar, and 0.3 stages of separation it may be possible to achieve a Liquid Height Equivalent of a Theoretical Plate (HETP) that is less than 8.6 cm. Improved designs with mass transfer occurring within the active surface features may achieve a HETP less than about 5 cm, and in one embodiment less than about 1 cm.

### EXAMPLE 2

The impact of surface features on the mixing of bulk fluid flowing through open and closed channels may be significant. Hence, surface features can be introduced on channel sidewalls to promote either interaction between the bulk fluid and the lateral walls or interaction between the bulk fluid and a free interface (typical of mass transfer processes relevant to distillation, absorption, extraction, and the like.)

The factors that may play a role on the extent of the mixing improvement relative to non-surface-feature modified channels may include:
channel configuration,
   open (e.g., a rectangular channel with only 3 walls),
   closed;
surface feature positioning,
   one surface,
   two opposing surfaces;
rib design, where a rib is defined as a single surface feature
   all cases use a single leg diagonal surface feature configuration (see, “45 DEG” design in FIG. 17),
   size and location of rib interruptions,
   cis (ribs aligned on opposing sides—mirror symmetry) and trans (ribs criss-crossed on opposing sides, e.g., rotationally symmetric) configurations;
rib dimensions,
   angle relative to the flow and/or the free surface,
   depth,
   width,
rib frequency,
flow direction with respect to the ribs,
fluid velocity;
main channel gap size.

The current investigation involves a series of computational fluid dynamics (CFD) simulations of flow through micro-channels intended to highlight some of the key effects. All analyses, performed using the CFD package Fluent™, are presented in terms of visualized flow patterns. Extent of conversion is also calculated and presented for each case as an approximate means of quantifying differences in behavior. The cases considered are listed in Table 1, below. Key parameters and settings are noted for each case. Italicized bold values and cell borders are indicative of comparative sets.

| run | | | | no. of | channel dimensions (mm) | | | rib dimensions (mm) | | | | velocity |
|---|---|---|---|---|---|---|---|---|---|---|---|---|
| id | flow | slip | SF | ribs | gap | tot length | SF length | angle | depth | span | separation | (m/s) |

| | | | | |
|---|---|---|---|---|
| 1 2 3 4 5 6 7 8 9 10 11 12 13 14 | 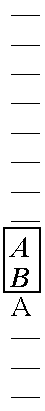 | 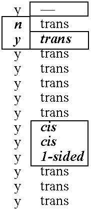 | —60 61 61 31 46 44 44 61 61 61 31 31 30 | |
| # 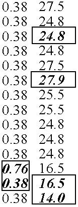 | —22.2 22.2 22.2 22.2 25.1 23.0 23.0 22.2 22.2 22.2 11.5 11.5 11.5 | 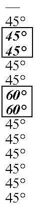 | 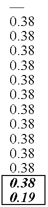 | 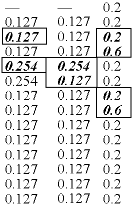 |

The above-indicated Table 1 shows parameter settings for the comparative CFD cases considered. The main channel gap is held constant at 0.51 mm for all cases. For clarity, cases for direct comparison are differentiated by corresponding cell borders and italicized bold writing. SF refers to surface feature; velocity refers to the uniform fluid velocity at the channel inlet. All configurations are as shown in FIG. 17 (45 DEG) and include an initial 2.54 mm without surface features. Slip refers to the upper wall boundary condition. The rib angle is taken with respect to the channel floor.

As indicated in Table 1, in all cases, except Run 2, the upper channel wall is assumed to have a no stress boundary condition. All other surfaces are assumed to be no slip boundaries for all runs. In all cases, fluid density and viscosity are set to 480 kg/m³ and 0.083 cP, respectively. A uniform inlet fluid velocity is imposed throughout. The onset of surface features is consistently held 2.54 mm from the inlet to avoid entrance effects and obtain a well-established flow profile upstream of the surface features. Additional channel details defining flow direction and 1-sided and 2-sided cis and trans configurations are described above.

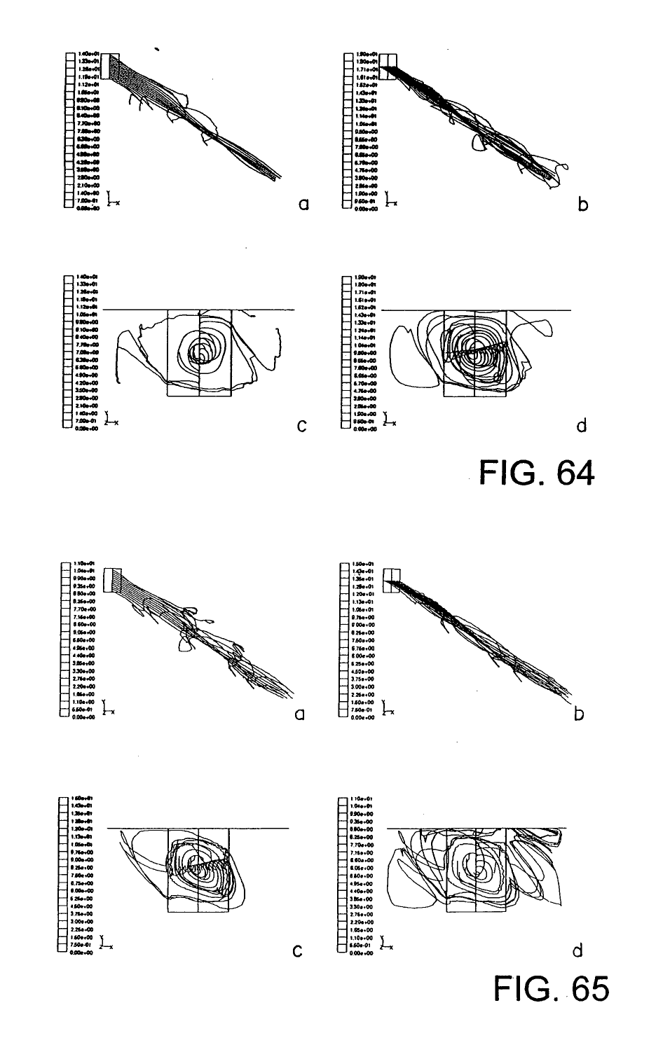

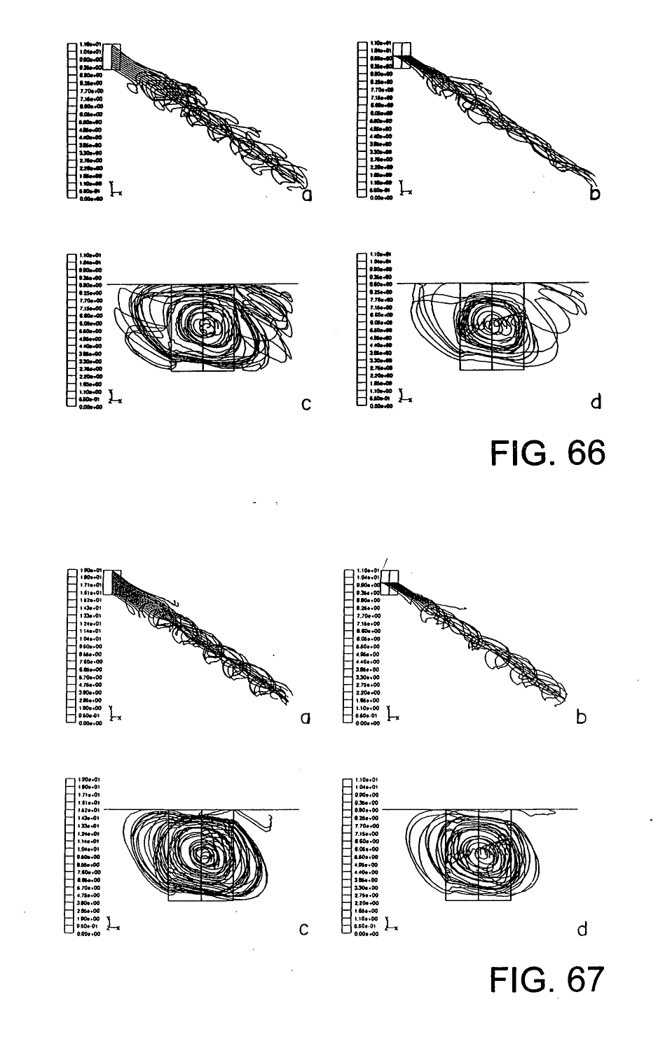

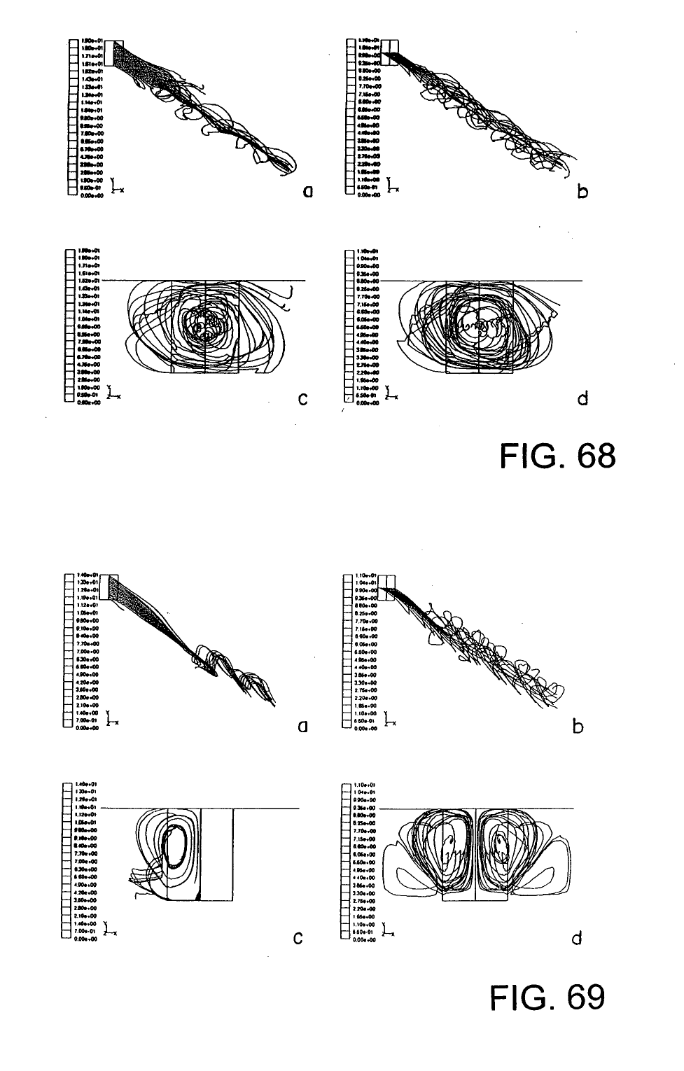

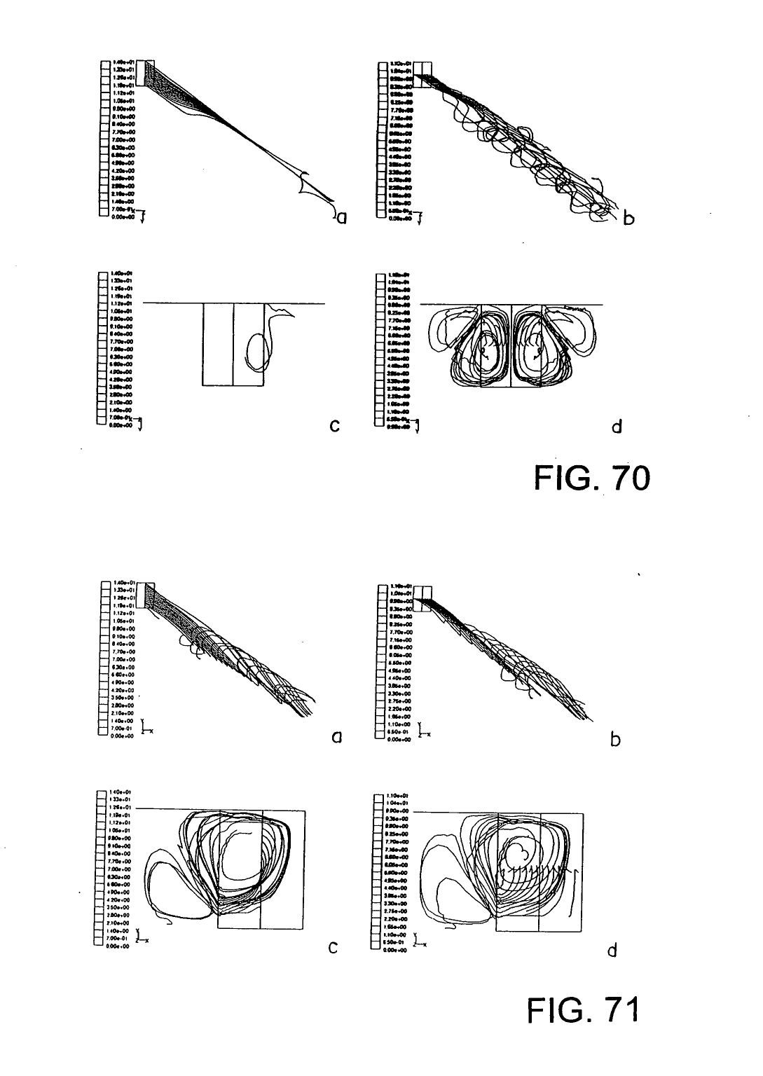

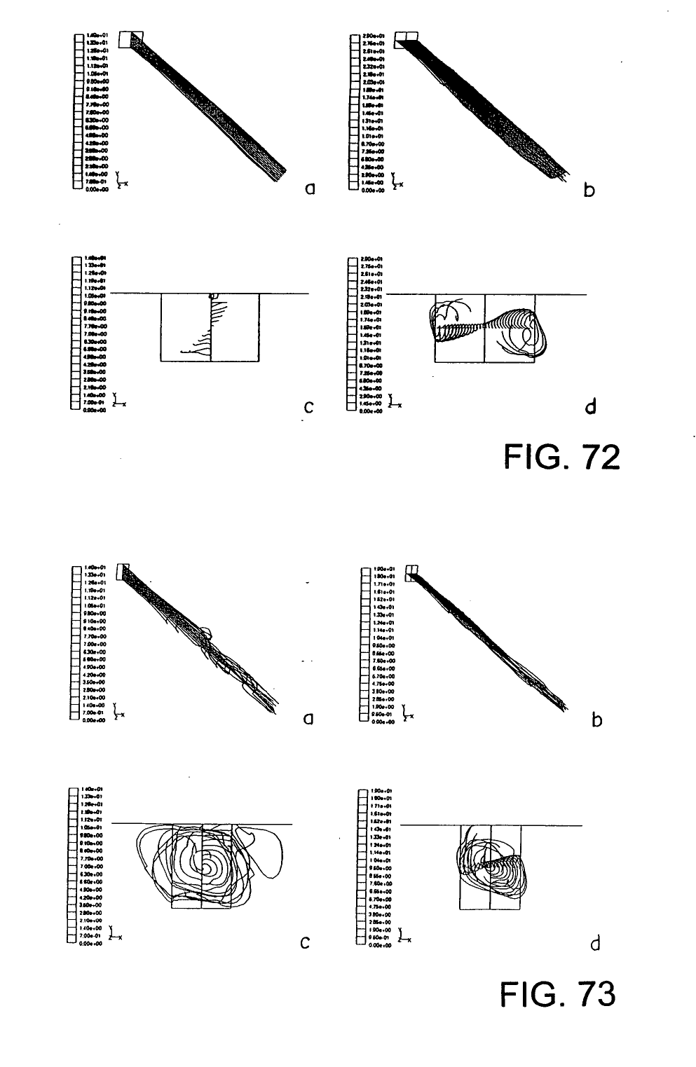

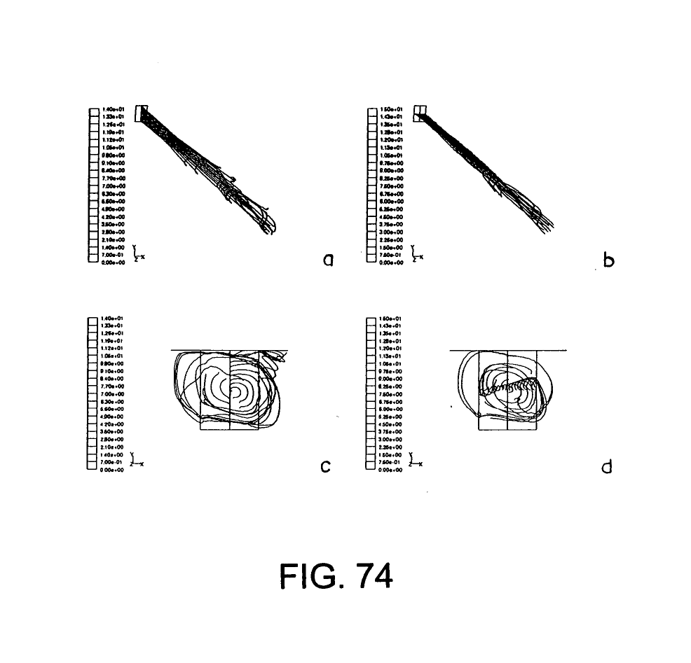

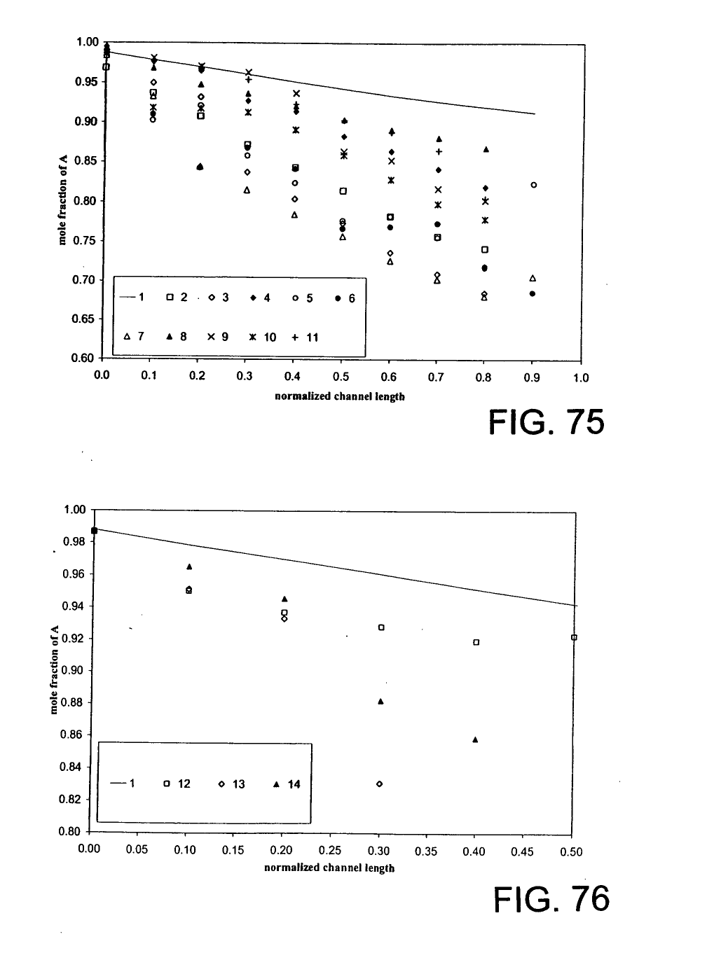

The results for each case listed in Table 1 are presented in FIGS. 61-74 in terms of path line evolution along channel length. Path-lines originating from the inlet vertical and horizontal center-lines are shown for reference. Front and side views are presented for clarification. FIGS. 75 and 76 show extent of conversion along normalized channel length. FIG. 75 presents Runs 1 through 11; FIG. 76 presents Runs 12 through 14 as well as Run 1 results, for reference. The extent of conversion is taken as a representative measure of the extent of interaction of the bulk flow with the upper channel wall where a mass transfer with an adjacent or other phase stream is present. The fluid is assumed to include a single component, material A, at the channel entrance. Upon contact with the upper wall, the entering component is assumed to be immediately converted to a second component, material B, with the same properties as the first component. The zero order, isothermal reaction is defined by a pre-exponential factor of 1×10⁶. A 300° K. temperature and an activation energy of 10 J/kmol are assumed. The components inter-diffuse with a diffusion coefficient of 1×10⁻⁸ m²/sec. Although the extent of conversion becomes less sensitive as conversion increases, it still provides a simple measure by which to estimate and compare configuration performance. However, it is not an absolute indicator of mixing.

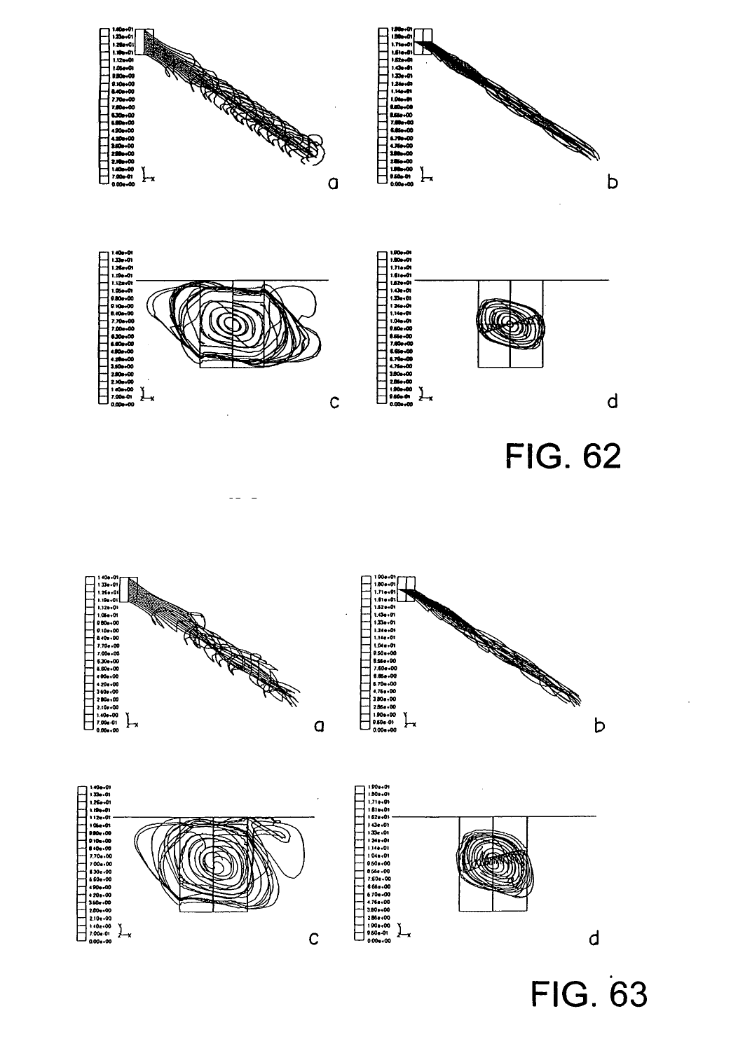

FIGS. 61a through 61d show representative flow profiles for Run 1 (Table 1). Results are shown in terms of path-lines released from the vertical and horizontal inlet center-lines, a and c and b and d, respectively. Figures a and b show the path-lines viewed from the channel side; Figures c and d show the path-lines viewed from the exit plane of the channel. All views are orthographic. The channel inlet is shown for reference. FIGS. 62-74 show similar flow profiles for Runs 2-14, respectively.

FIG. 75 shows concentration measurements indicating degree of conversion of material A in response to contact with the upper channel wall. Measurements begin after the initial 2.54 mm featureless section, which is taken as the zero point of the normalized channel length. The channel length is normalized upon division by 25.4 mm. Legend numbers correspond to the run numbers of Table 1.

FIG. 76 shows concentration measurements indicating degree of conversion of material A in response to contact with the upper channel wall. Measurements begin after the initial 2.54 mm straight, which is taken as the zero point of the normalized channel length. The channel length is normalized upon division by 25.4. Legend numbers correspond to the run numbers of Table 1.

As shown in FIG. 75, the performance of all cases considered is bound by the baseline case of Run 1, which contains no surface features, and Run 7, the more steeply inclined trans surface feature configuration involving low fluid velocity, 0.2 m/sec. Conversion increases relatively linearly as the material proceeds down the channel even for the worst case, which involves no path-line intertwining, as is evident in Fig. 61. This effect is indicative of diffusional mass transfer in a direction perpendicular to the channel flow axis. As profiles for Cases 7 and 3 and 8 and 4 indicate, the effect of surface feature angle between 45 degrees and 60 degrees is rather small for these low velocity (<1 m/s), narrow gap (0.38 mm) cases. The greater effect in extent of mixing may be attributed to flow speed. The impact can also be seen from comparison of FIGS. 63, 64, 67 and 68. For the evaluated velocity difference of 0.2 m/s and 0.6 m/s, improved extent of reaction is calculated for the lower velocity cases. It is easier to mix a lower velocity stream than a higher velocity stream. As the stream velocity increases in the open microchannel, modifications to the surface feature geometry, angle relative to the plane orthogonal to the flow, and depth are particularly useful to increase flow rotation in the bulk flow path. A comparison of FIGS. 62 and 63 and their corresponding profiles in FIG. 75 also shows that the presence of the free surface leads to slightly less orderly motion that enhances interaction and transfer with the upper wall. The free surface implies a slip boundary condition as found when two fluids are moving past each other as opposed to a fluid moving past a stationary wall; a slip boundary condition may also be created if a wall chemistry is changed such that it repels the bulk fluid—such as a hydrophobic coating for an aqueous solution flowing in a microchannel.

According to the curves for Runs 3, 5, and 6, relatively little effect is evident when the rib span and separation are doubled or when the frequency of the ribs is doubled, leaving the rib span unchanged. However, as the corresponding path-line profiles attest, much greater rotation is imparted for both increased rib frequency and decreased surface feature span. Such differences in conclusions highlight the need to identify more sensitive quantitative measures of mixing effectiveness. A comparison of Runs 3, 9, 10, and 11 shows, the trans configuration appears to enhance mixing effectiveness relative to the other alternatives. A significant impact of gap size is noted by comparing Runs 12 and 13, a shorter equivalent of Run 3. The larger the gap, the less the mixing enhancement for a given fixed geometry of surface feature. An increased surface feature depth may increase mixing for larger gap microchannels. Decreasing surface feature depth has a detrimental effect on mixing, although it appears less significant than main channel gap size. As is evidenced by FIG. 76, an initial lag in the onset of mixing appears to exist; in the cases considered it extends approximately 0.2 normalized channel heights past the onset of the surface features.

### EXAMPLE 3

This example is a simulation which shows flow rotation and mixing for gas mixtures; open channel with diagonal recesses on two sides. The addition of surface features to two sides of a microchannel to induce a change from laminarflow in the channel to a strongly mixing flow in the channel is investigated via computational fluid dynamics (CFD) simulations using Fluent. For the simulation, fluid properties are assumed to be constant, with a density of 5.067 kg/m3, and a viscosity of 3.62×10⁻⁵ kg/m-s. A uniform inlet velocity of 12.13 m/s and a no-slip flow condition at all walls were imposed as boundary conditions. A grid size of 315,174 cells is used.

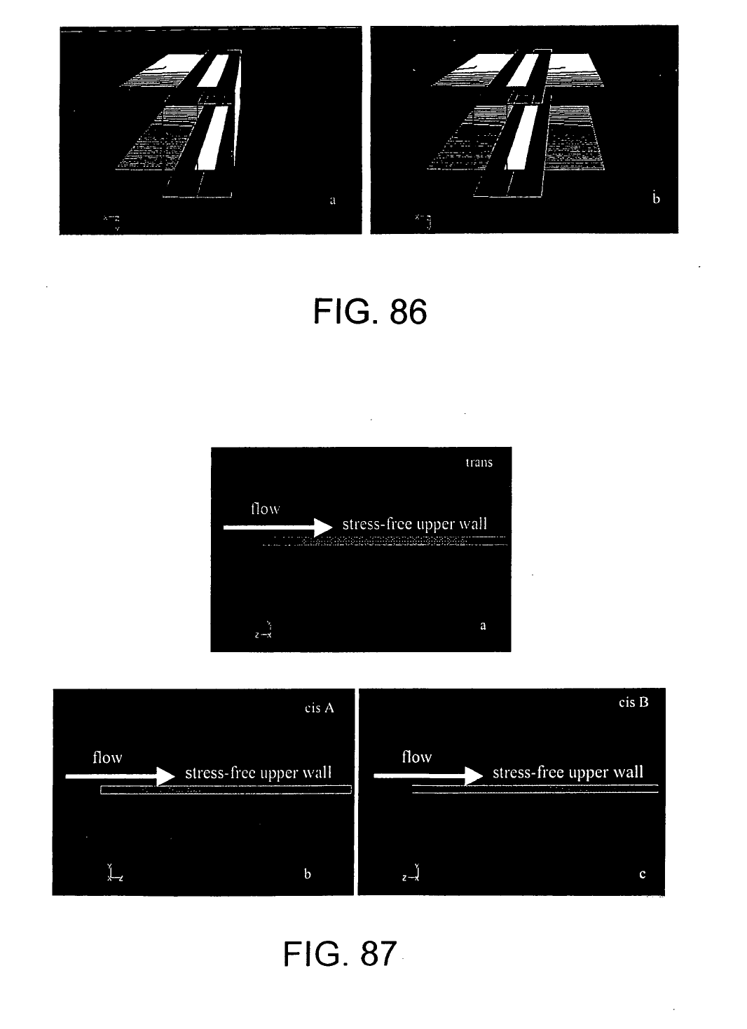

The assumed geometry is a rectangular cross section for the continuous channel, with a width of 4.06 mm, a (gap) height of 0.318 mm (which does not include recess depth), and a length of 63.5 mm. The section from 0 to 3.5 mm downstream from the inlet and the section 5.0 to 0 mm upstream of the outlet contain no surface features (simple rectangular microchannel). The surface features (or grooves) are cut into two opposing walls, each feature being approximately rectangular in cross section. The middle section of the microchannel (from 3.5 mm to 58.5 mm downstream of the inlet) contain the surface features. The surface features span one of the channel walls diagonally at an angle of 63° from the direction of the mean bulk laminar flow, as shown in FIGS. 86 and 87. Each surface feature is about 0.25 mm deep by 0.48 mm wide, by 9 mm long. Surface features are placed parallel to one another with a spacing of 0.48 mm between surface features. The surface features on the opposing wall are exactly the same as those one the first wall, rotated 180° about the channel centerline. The channel geometry is symmetric about the axis of flow extending from the centerpoint of the inlet plane to the centerpoint of the outlet plane.

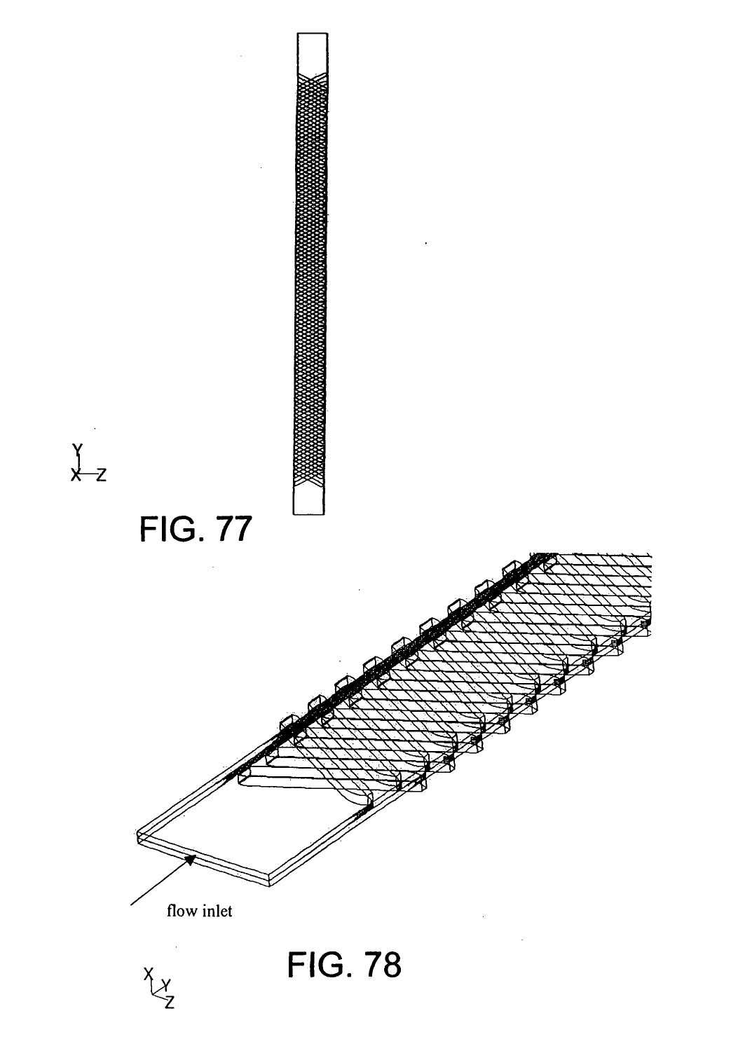

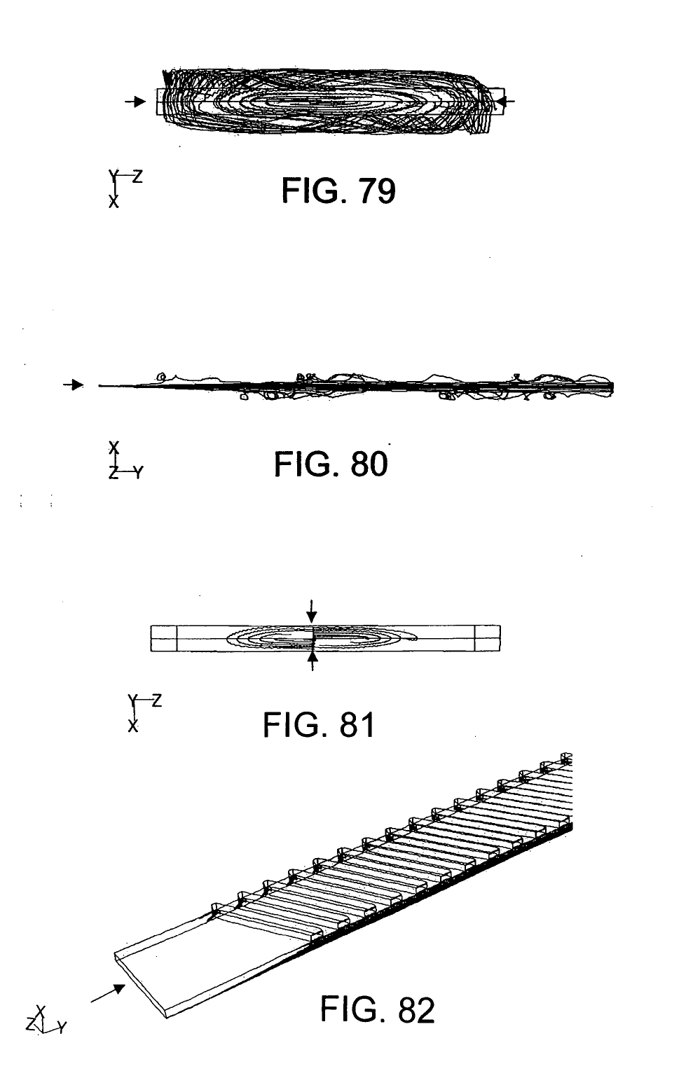

FIG. 77 shows a plan view of the geometry of surface features simulated by CFD where surface features on both upper and lower walls are superimposed. FIG. 78 shows an isometric view of the microchannel with mixing features simulated by CFD, showing the direction of flow entering the channel. FIG. 79 shows typical pathlines of flow beginning along the horizontal centerline (running between the arrows) of the inlet plane looking down the axis of flow from the inlet plane. In classical laminar flow, pathlines flow in a straight line between the inlet and outlet planes (for the view shown in FIG. 79, a classical laminar flow pathlines would not deviate from the centerline between the arrows. In FIG. 80, a side view of the same pathlines of flow beginning along the horizontal centerline of the inlet plane (arrow shows direction of flow) is shown. In FIG. 80, the spread of the flow pathlines from the centerline and the swirling motion in the surface features shows improved mixing and decreased heat and mass transport resistance relative to laminar flow. FIG. 81 shows the pathlines of flow beginning along the vertical centerline of the inlet plane (running between the arrows) looking down the axis of flow from the inlet plane. In FIG. 81, the swirling motion of the flow indicates enhanced mixing and decreased heat and mass transport resistance relative to classical laminar flow.

The results of the CFD simulations show that, unlike laminar flow in a microchannel, the surface features cause the pathlines of the flow in the continuous channel to twist and swirl, spreading toward the walls much faster than would be expected in the case of laminar flow. The calculated pressure drop is 5.2 kPa.

### EXAMPLE 4

Another CFD simulation of surface features was run with a geometry identical to Example 3 except that the surface features on one of the two walls are removed and replaced with a solid wall. The geometry for this case is shown in FIG. 82. As in Example 3, fluid properties are assumed to be constant, with a density of 5.067 kg/m3, and a viscosity of 3.62×10⁻⁵ kg/m-s. An outlet pressure of 1.01 bar is imposed. A uniform inlet velocity of 12.13 m/s and a no-slip flow condition at all walls were imposed as boundary conditions. The CFD simulation mesh size for this Example is 264,948 cells.

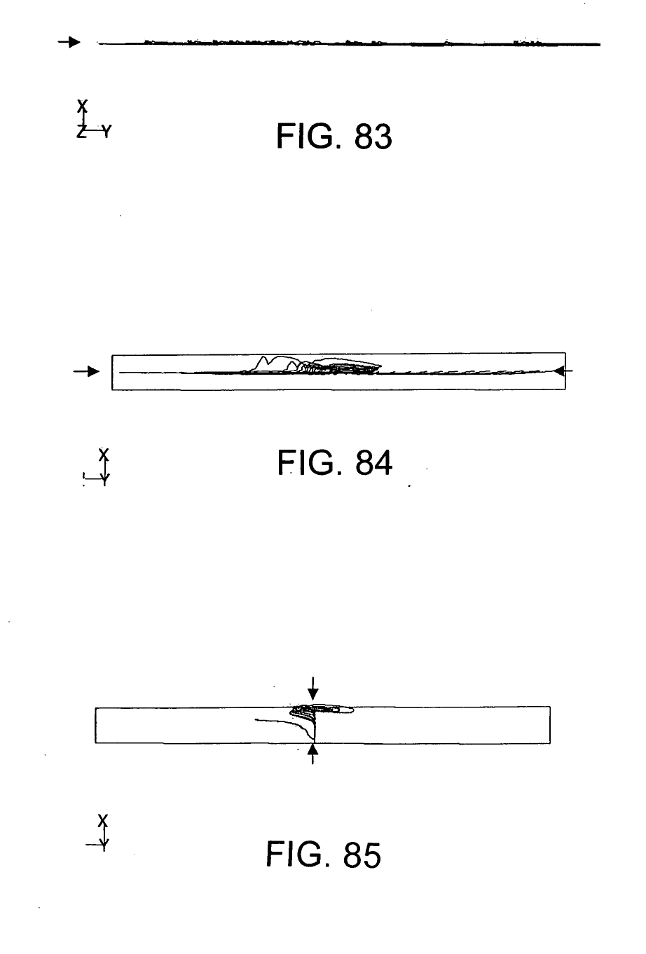

FIGS. 83-85 show the flow pathlines predicted for this Example. FIG. 83 shows pathlines of flow beginning along the horizontal centerline of the inlet plane for this example (arrow shows direction of flow) as viewed from the side. FIG. 84 depicts pathlines of flow for this example beginning along the horizontal centerline (beginning on the inlet plane between the arrows) of the inlet plane looking down the axis of flow from the inlet plane. FIG. 85 shows the predicted pathlines of flow for this example beginning along the vertical centerline (beginning on the inlet plane between the arrows) of the inlet plane looking down the axis of flow from the inlet plane. The mixing and potential mass and heat transport enhancement performance are less significant for this examples as compared to Example 3.

### EXAMPLE 5

The studies described below involve numerical simulations of flow through channels. All analyses are performed using the CFD package Fluent. Channels with a constant inlet cross-section, 0.5 mm tall by 1.3 mm wide, are referenced for the study. The upper channel wall is assumed to have a no stress boundary condition; all other surfaces are assumed to be no slip boundaries. A case involving no slip boundary conditions at all channel walls is also analyzed for reference. In all cases, fluid density and viscosity are set to 480 kg/m³ and 0.083 cP, respectively. Unless otherwise noted, a uniform inlet fluid velocity of 0.2 m/sec is imposed. Runs probe the effect of rib width, surface feature configuration and inlet velocity; all results are referenced for completeness. Some visualized flow pattems are included for clarity.

Representative one-sided and two-sided surface feature configurations are shown in FIGS. 86a and b. In these figures the top surface is an open wall; surface features are on the left and right walls (surface features not shown). Surface features corresponding to straight ribs, 0.38 mm deep, oriented at a 45° angle relative to the channel floor, are introduced 0.25 mm from the fluid inlet plane. The orientation of the surface features relative to the flow is varied as shown in FIGS. 87 through 87c. Cis configurations correspond to matching orientation of the surface features on both sides of the wall (there is a mirror plane of symmetry through the horizontal plane parallel to the featured walls); the trans configuration corresponds to a 180° difference in the orientation angle of the ribs on opposing walls. A and B designations indicate the orientation of the ribs relative to the flow: A refers to the direction of inclination the ribs would assume if they were fixed to the lower channel surface but allowed to move in response to the flowing fluid. B refers to the opposite inclination. Rib width and rib separation are equivalent in all cases considered; it is recognized that rib frequency can also affect mixing effectiveness.

Results are presented in terms of path line evolution along channel length. Path lines originating from the inlet vertical and horizontal center-lines are shown for reference. Front and side views are also presented for clarification.

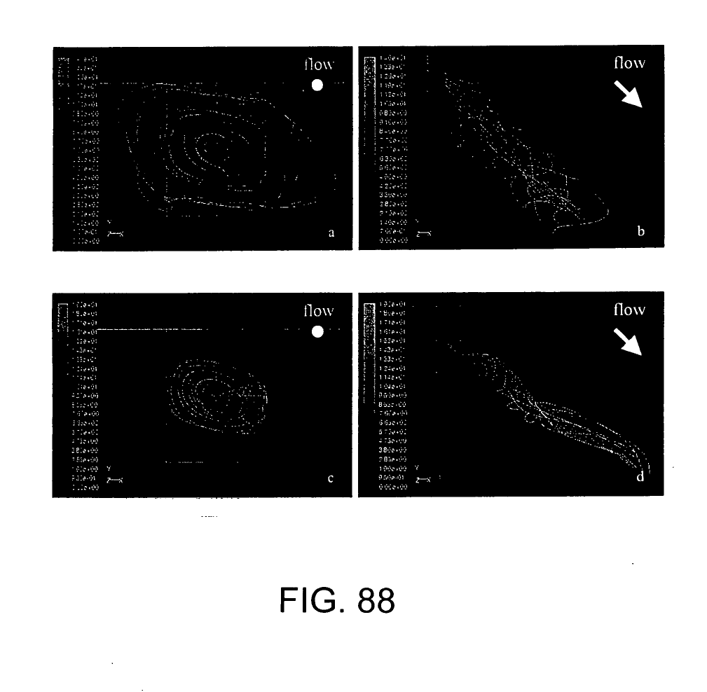

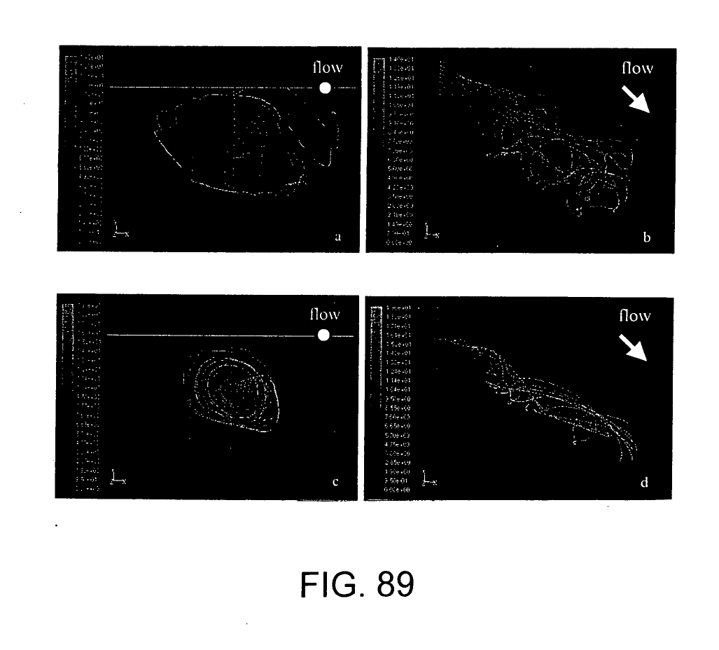

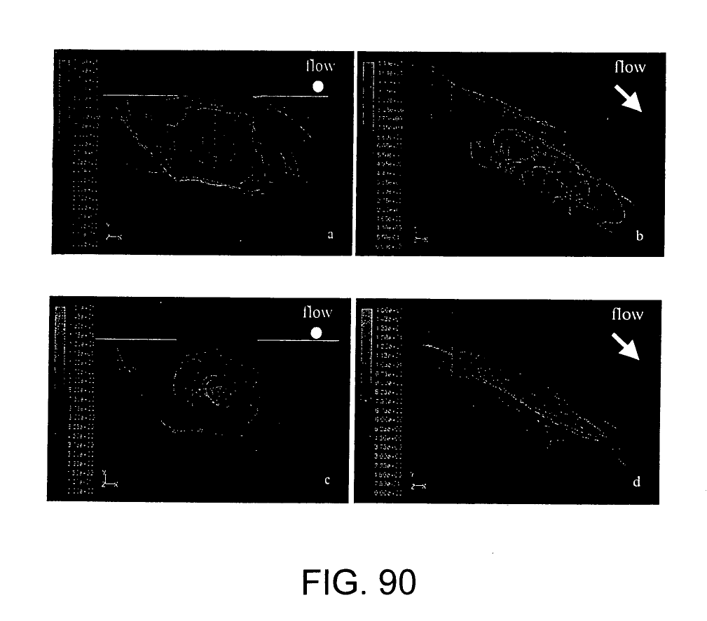

Simulations of fluid flowing through a 2.5 mm long channel with 0.13 mm wide surface feature ribs, placed on both channel side walls, in a trans configuration, show a difference in flow pattern between the closed channel configuration and one in which a no stress boundary condition exists at the upper wall. These are summarized in FIGS. 88 and 89. Uniform wall boundary conditions lead to more uniform and consistent path-lines along the channel length considered.

FIGS. 88 and 89 shown representative results for flow through a 2.5 mm long closed rectangular micro-channel, modified to include lateral surface features consisting of 0.127 mm wide ribs angled at 45° relative to the channel bottom. The 2-sided trans configuration includes 0.38 mm deep ribs. Results, corresponding to a uniform inlet fluid velocity of 0.2 m/s, are shown in terms of path-lines released from the vertical and horizontal inlet center-lines, a and b and c and d, respectively. Figures a and c show the path-lines viewed from the exit plane of the channel; Figures b and d show the path-lines viewed from the channel side. All views are orthographic. The channel inlet is shown for reference. FIG. 88 shows the trans configuration and closed channel.

Simulation results of the fluid flowing through the 2.5 mm long open channel (one side wall is missing) with 0.127 mm wide surface feature ribs, in a two-sided trans configuration, can be compared to results obtained when the rib thickness is increased to 0.254 mm. These are shown in FIGS. 90a through d. The wider ribs capture more of the flow than the thinner ribs; a tighter vortex flow develops for the thinner rib configuration.

FIGS. 90a through d. Representative results for flow through a 2.5 mm long open rectangular micro-channel, modified to include lateral surface features consisting of 0.254 mm wide ribs angled at 45° relative to the channel bottom. The open side of the micro-channel, the upper wall, is defined as a no-stress boundary condition. The 2-sided trans configuration includes 0.38 mm deep ribs. Results, corresponding to a uniform inlet fluid velocity of 0.2 m/s, are shown in terms of path-lines released from the vertical and horizontal inlet center-lines, a and b and c and d, respectively. Figures a and c show the path-lines viewed from the exit plane of the channel; Figures b and d show the path-lines viewed from the channel side. All views are orthographic. The channel inlet is shown for reference.

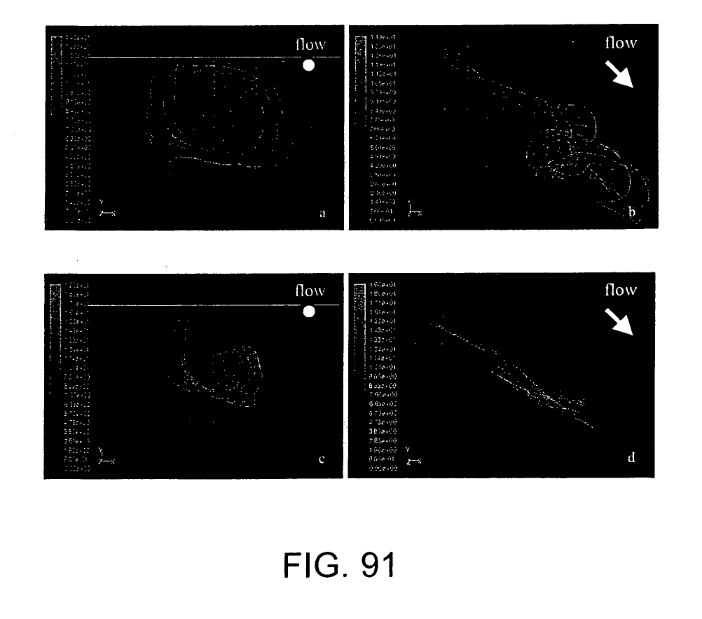

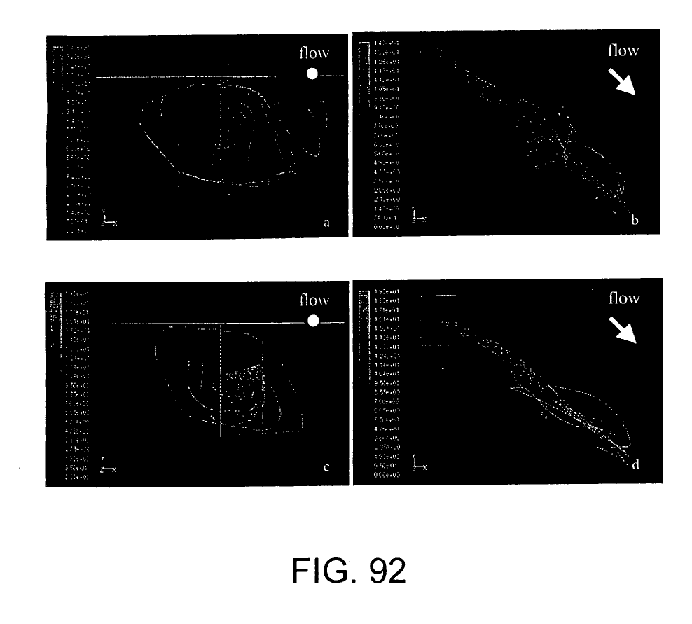

The effect of modifying flow rate can be seen by contrasting results obtained at 0.2 and 0.6 m/sec inlet velocities. FIGS. 91 and 92 show profiles obtained for the 0.127 mm rib width, with the two-sided trans configuration, in a 1.6 mm long channel. For the cases considered, less effective mixing is apparent at the higher flow rates. FIGS. 91a through d show representative results for flow through a 1.6 mm long open rectangular micro-channel, modified to include lateral surface features consisting of 0.127 mm wide ribs angled at 45° relative to the channel bottom. The open side of the micro-channel, the upper wall, is defined as a no-stress boundary condition. The 2-sided trans configuration includes 0.38 mm deep ribs. Results, corresponding to a uniform inlet fluid velocity of 0.2 m/s, are shown in terms of path-lines released from the vertical and horizontal inlet center-lines, a and b and c and d, respectively. Figures a and c show the path-lines viewed from the exit plane of the channel; Figures b and d show the path-lines viewed from the channel side. All views are orthographic. The channel inlet is shown for reference. Here the rib density is two times higher, resulting in more revolutions.

FIGS. 92a through d show representative results for flow through a 1.6 mm long open rectangular micro-channel, modified to include lateral surface features consisting of 0.127 mm wide ribs angled at 45° relative to the channel bottom. The open side of the micro-channel, the upper wall, is defined as a no-stress boundary condition. The 2-sided trans configuration includes 0.38 mm deep ribs. Results, corresponding to a uniform inlet fluid velocity of 0.6 m/s, are shown in terms of path-lines released from the vertical and horizontal inlet center-lines, a and b and c and d, respectively. Figures a and c show the path-lines viewed from the exit plane of the channel; Figures b and d show the path-lines viewed from the channel side. All views are orthographic. The channel inlet is shown for reference.

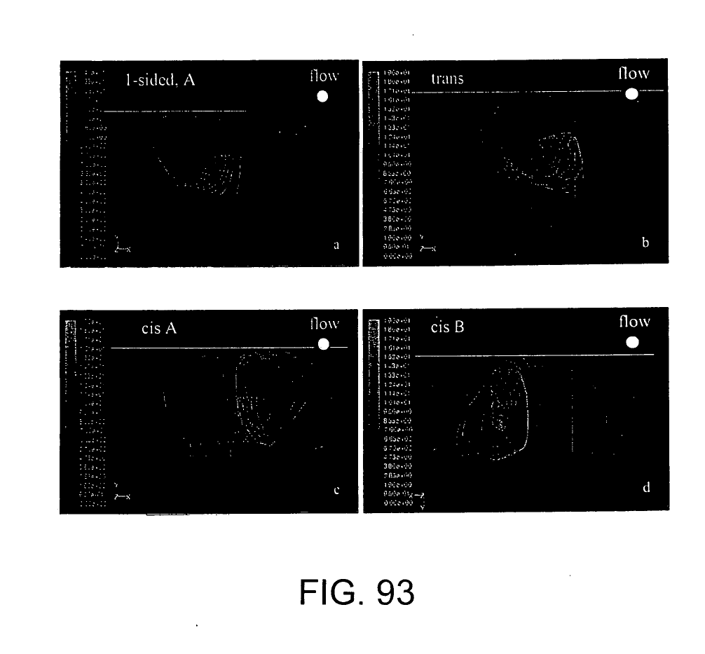

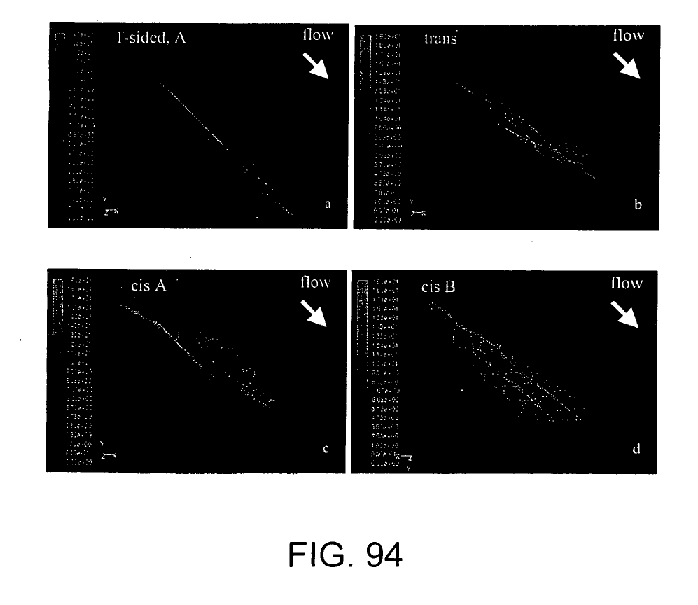

The effect of surface feature positioning and orientation is evident in FIGS. 93 through 96. These contrast the profiles obtained for a 0.2 m/sec fluid velocity in the 1.6 mm long channel, with 0.127 mm thick ribs placed on one channel sidewall, with an A flow pattern, and on both sidewalls, in trans, cis A, and cis B configurations. Two circulating patterns are evident in the cis configurations. A single vortex develops in the other two (trans) cases. The cis orientation creates two vortices—one on each side of the center line; however, flow at the center plane is essentially unmixed (see FIG. 95). The trans configuration mixes throughout the microchannel. FIG. 93a through d shows representative results for flow through a 1.6 mm long open rectangular micro-channel, modified to include lateral surface features consisting of 0.127 mm wide, 0.38 mm deep ribs, angled at 45° relative to the channel bottom. The open side of the micro-channel, the upper wall, is defined as a no-stress boundary condition. All results correspond to a uniform inlet fluid velocity of 0.2 m/s. Path-lines released from the horizontal inlet center-line are viewed from the exit plane of the channel for one-sided, trans, cis A and cis B surface feature configurations. All views are orthographic. The channel inlet is shown for reference. FIGS. 94a through d show representative results for flow through a 1.6 mm long open rectangular micro-channel, modified to include lateral surface features consisting of 0.127 mm wide, 0.38 mm deep ribs, angled at 45° relative to the channel bottom. The open side of the micro-channel, the upper wall, is defined as a no-stress boundary condition. All results correspond to a uniform inlet fluid velocity of 0.2 m/s. Path-lines released from the horizontal inlet center-line are viewed from the side of the channel for one-sided, trans, cis A and cis B surface feature configurations. All views are orthographic. The channel inlet is shown for reference.

FIG. 95a through d shows representative results for flow through a 1.6 mm long open rectangular micro-channel, modified to include lateral surface features consisting of 0.127 mm wide, 0.38 mm deep ribs, angled at 45° relative to the channel bottom. The open side of the micro-channel, the upper wall, is defined as a no-stress boundary condition. All results correspond to a uniform inlet fluid velocity of 0.2 m/s. Path-lines released from the vertical inlet center-line are viewed from the exit plane of the channel for one-sided, trans, cis A and cis B surface feature configurations. All views are orthographic. The channel inlet is shown for reference.

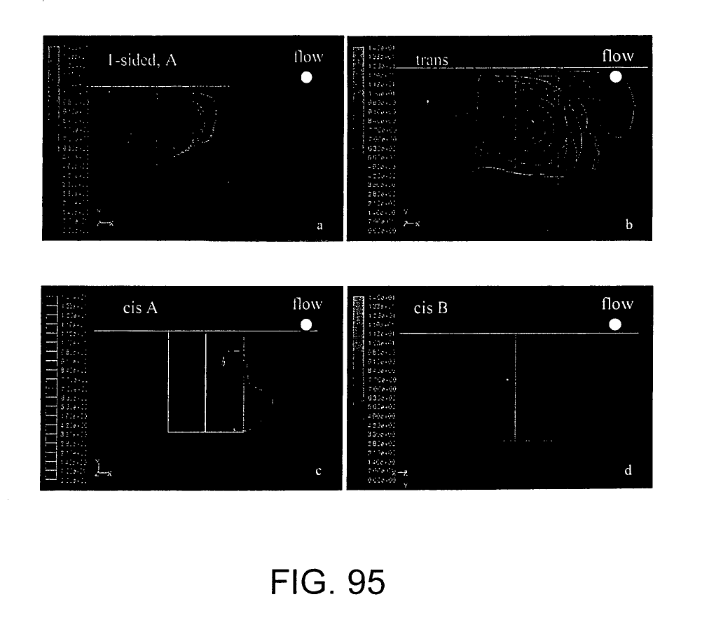

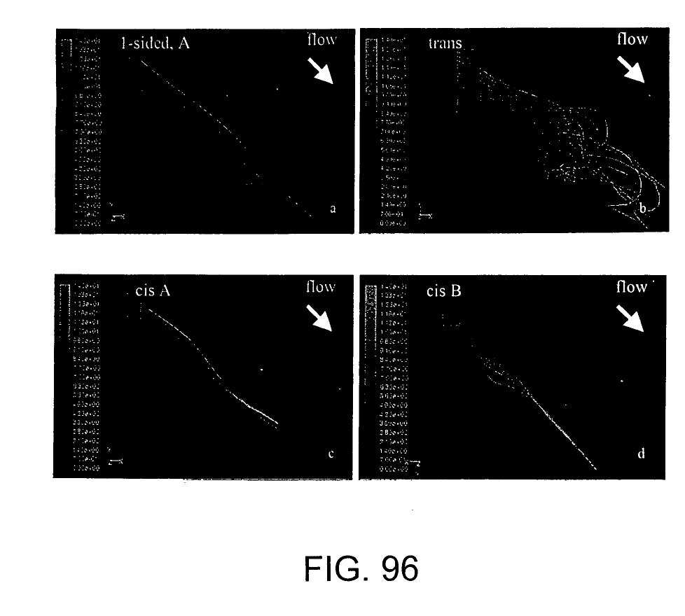

FIG. 96a through d shows representative results for flow through a 1.6 mm long open rectangular micro-channel, modified to include lateral surface features consisting of 0.127 mm wide, 0.38 mm deep ribs, angled at 45° relative to the channel bottom. The open side of the micro-channel, the upper wall, is defined as a no-stress boundary condition. All results correspond to a uniform inlet fluid velocity of 0.2 m/s. Path-lines released from the vertical inlet center-line are viewed from the side of the channel for one-sided, trans, cis A and cis B surface feature configurations. All views are orthographic. The channel inlet is shown for reference.

### EXAMPLE 6

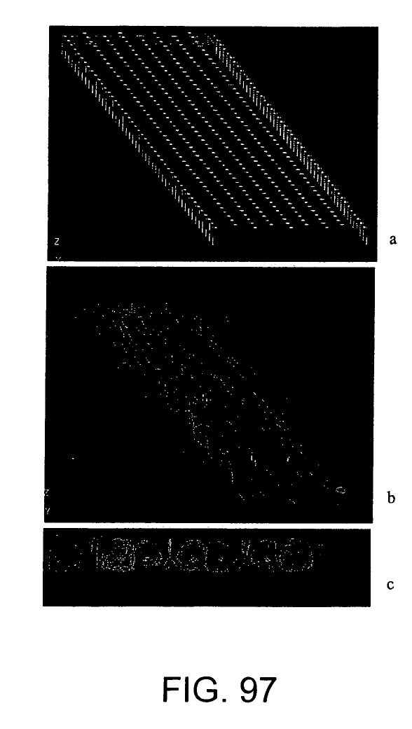

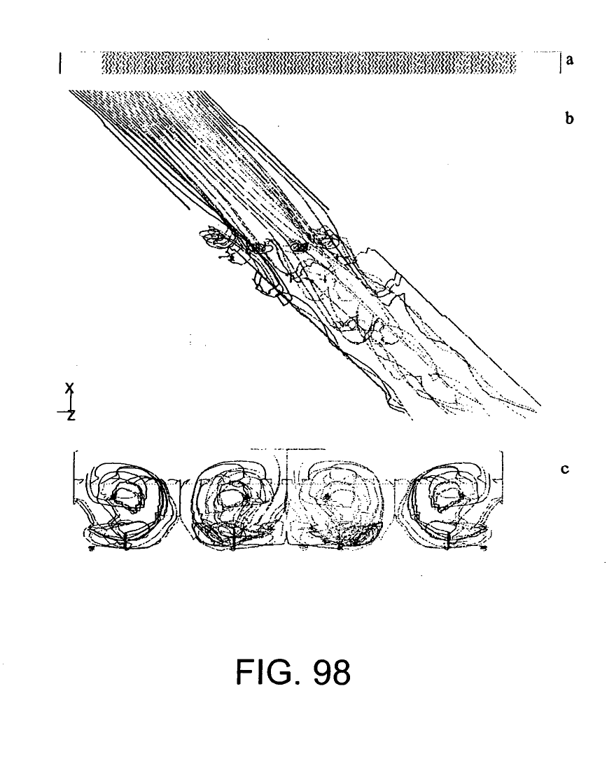

The location and dimensions of contiguous surface feature (chevron configurations) impact both the size and location of the vortical path of a fluid. As shown in FIG. 97a through 97c, in some instances, a vortex forms within each chevron leg in the contiguous surface feature configuration. As can be inferred from FIG. 98a through 98c, in other instances, vortices form about the apex of each chevron.

In FIG. 97, the channel geometry is shown in a. The path-line profile is shown in b and c. These figures show the formation of vortices spanning the chevron legs in each surface feature. FIG. 97b shows path lines released at the center line of the inlet plane gap viewed from an angle. FIG. 97c shows the same path lines viewed from the exit plane.

In FIG. 98, the channel geometry is shown in a, and path line profiles are shown in b and c. The path line profiles show the formation of vortices centered about the chevron apex in each surface feature. FIG. 98b shows path lines released at the center line of the inlet plane gap viewed from an angles. FIG. 98c shows the same path lines viewed from the exit plane.

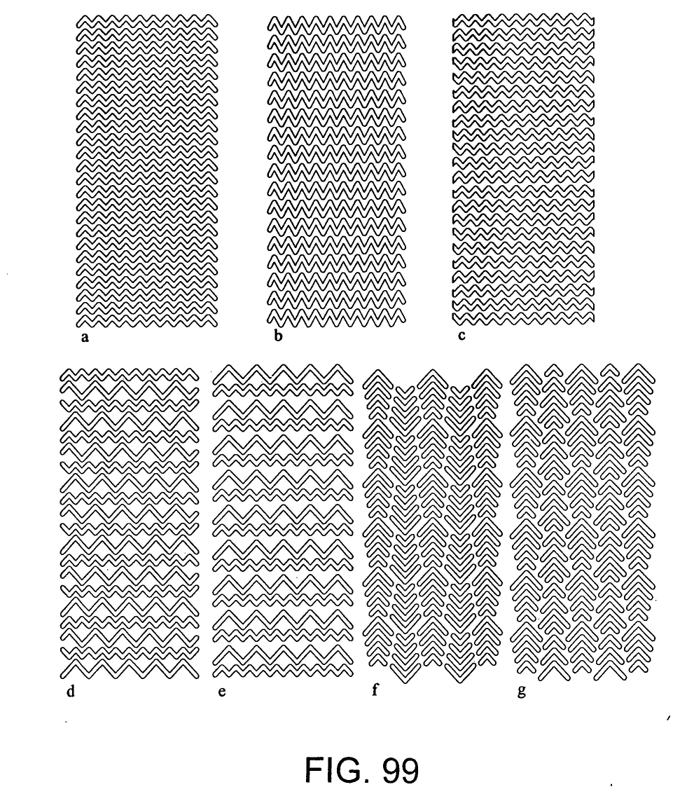

Additional contiguous surface features in the form of chevron configurations may be devised. All of these except FIG. 99b, have a 90° subtending angle. FIG. 99b has a subtending angle of 60°. These configurations allow consideration of the impact of changing the subtended chevron angle, FIGS. 99a and b, the alignment of the surface feature chevrons. FIG. 99a, c, d and e the variation in chevron size along the main flow path, FIG. 99d, e and g, and the orientation of the contiguous chevrons relative to the flow direction, FIG. 99f and g. As shown, the surface features cover the same cross sectional area (approximately 12.7 mm across and 25.4 mm in length) and are 0.25 mm deep. All of these chevron shaped surface features have a 0.38 mm span. The inter-chevron distance varies locally.

These configurations provide enhanced shearing to a flowing fluid (whether it enters the surface features from the main channel or from a partially or completely porous substrate in the rear of the surface features). In all but one case, the subtended angle, between the chevron legs is 90°. In the case shown in FIG. 99b, the subtended angle is 60°, leading to a steeper chevron leg configuration. The steeper chevron leg is intended to more easily thrust high speed/momentum fluid forward and enhance the effectiveness of the mixing as the fluid moves axially along the main channel gap. The undulating position of the chevron apex, shown in FIG. 99b, is intended to shift the fluid laterally and enhance mixing effectiveness and contacting with the wall (shifting the axial momentum slightly to the sides). The changes in the size of the succeeding chevrons, shown in FIGS. 99d and e, may lead to repeated vortex separation and enhanced mixing and intersection of otherwise non-intersecting fluid paths. The offsetting of FIG. 99e relative to 99d may lead to additional flow disruption and mixing. The fishbone-like chevron configurations of FIG. 99f and g may lead to repeated diversion of the fluid path-lines to form relatively randomly intertwining paths for otherwise nonintersecting fluids. Where the alternating chevron orientation may shift vortex center-points laterally, the unidirectionally directed chevron may lead to successive vortex splitting.

While the invention has been explained in relation to specific embodiments, it is to be understood that various modifications thereof will become apparent to those skilled in the art upon reading the specification. Therefore, it is to be understood that the invention disclosed herein is intended to cover such modifications as fall within the scope of the appended claims.

1. A process for contacting a liquid phase and a second fluid phase, comprising:
flowing the liquid phase and/or second fluid phase in a process microchannel in contact with surface features in the process microchannel, the contacting of the surface features with the liquid phase and/or the second fluid phase imparting a disruptive flow to the liquid phase and/or second fluid phase;
contacting the liquid phase with the second fluid phase in the process microchannel; and
transferring mass from the liquid phase to the second fluid phase and/or from the second fluid phase to the liquid phase.

2. The process of claim 1 wherein the liquid phase is in the form of a contiguous liquid phase over at least part of the length of the process microchannel, the second fluid phase is in the form of a contiguous fluid phase over at least part of the length of the process microchannel, the contacting between the liquid phase and the second fluid phase occurring at an interface between the liquid phase and the second fluid phase.

3. The process of claim 1, wherein the process microchannel comprises a first interior wall, a second opposite interior wall, and a gap positioned between the first interior wall and the second interior wall, the surface features being positioned on and/or in the first interior wall, the liquid phase being in the form of a contiguous liquid phase over at least part of the length of the process microchannel, the second fluid phase being in the form of a contiguous fluid phase over at least part of the length of the process microchannel, the second fluid phase contacting the liquid phase at an interface, the bulk flow of the liquid phase being in the gap between the surface features and the interface, the contacting of the surface features by the liquid phase causing at least part of the liquid phase to flow towards the interface.

4. The process of claim 1 wherein the process microchannel comprises a first interior wall, a second opposite interior wall, and a gap positioned between the first interior wall and the second interior wall, the surface features being positioned on and/or in the second interior wall, the liquid phase being in the form of a contiguous liquid phase over at least part of the length of the process microchannel, the second fluid phase being in the form of a contiguous fluid phase over at least part of the length of the process microchannel, the second fluid phase contacting the liquid phase at an interface, the bulk flow of the second fluid phase being in the gap between the surface features and the interface, the contacting of the surface features by the second fluid phase causing at least part of the second fluid phase to flow towards the interface.

5. The process of claim 1 wherein the process microchannel comprises a first interior wall, a second opposite interior wall, and a gap positioned between the first interior wall and the second interior wall, the surface features being positioned on and/or in the first interior wall and the second interior wall, the liquid phase being in the form of a contiguous liquid phase over at least part of the length of the process microchannel, the second fluid phase being in the form of a contiguous fluid phase over at least part of the length of the process microchannel, the second fluid phase contacting the liquid phase at an interface, the bulk flow of the liquid phase being in the gap and being between the first interior wall and the interface, the bulk flow of the second fluid phase being in the gap and being between the second interior wall and the interface, the liquid phase contacting the surface features on and/or in the first interior wall, the contacting of the surface features on and/or in the first interior wall by the liquid phase causing at least part of the liquid phase to flow towards the interface, the second fluid phase contacting the surface features on and/or in the second interior wall, the contacting of the surface features on and/or in the second interior wall by the second fluid phase causing at least part of the second fluid phase to flow towards the interface.

6. The process of claim 1 wherein the liquid phase is in the form of a contiguous liquid phase over at least part of the length of the process microchannel, the second fluid phase is in the form of a contiguous fluid phase over at least part of the length of the process microchannel, a contactor is positioned between the liquid phase and the second fluid phase.

7. The process of claim 6 wherein the contactor has a first surface facing the liquid phase and a second surface facing the second fluid phase, the first and/or second surface of the contactor containing surface features in the form of depressions in and/or projections from the first surface and/or second surface.

8. The process of claim 7 wherein the first surface of the contactor contains surface features in the form of depressions in and/or projections from the first surface.

9. The process of claim 7 wherein the second surface of the contactor contains surface features in the form of depressions in and/or projections from the second surface.

10. The process of claim 1 wherein the liquid phase and the second fluid phase are mixed with each other in the process microchannel.

11. The process of claim 1 wherein the process microchannel comprises a first interior wall and a second interior wall, the second interior wall being positioned opposite the first interior wall, the surface features being positioned on and/or in the first interior wall and/or the second interior wall.

12. The process of claim 1 wherein the surface features are oriented at oblique angles relative to the direction of the bulk flow of the liquid phase in the process microchannel.

13. The process of claim 1 wherein the surface features are oriented at oblique angles relative to the direction of the bulk flow of the second fluid phase in the process microchannel.

14. The process of claim 1 wherein the surface features comprise two or more layers stacked on top of each other and/or intertwined in one or more three-dimensional patterns.

15. The process of claim 1 wherein the surface features are in the form of circles, oblongs, squares, rectangles, checks, chevrons, wavy shapes, or combinations thereof.

16. The process of claim 1 wherein the surface features comprise sub-features where the major walls of the surface features further contain smaller surface features in the form of notches, waves, indents, holes, burrs, checks, scallops, or combinations thereof.

17. The process of claim 1 wherein the surface features comprise a plurality of interconnected oblique angles.

18-23. (canceled)

24. The process of claim 1 wherein heat is exchanged between the process microchannel and a heat source and/or heat sink.

25-46. (canceled)

47. The process of claim 1 wherein the liquid phase is in the form of a contiguous liquid phase flowing in the process microchannel in a first direction, the second fluid phase is in the form of a contiguous fluid phase flowing in a second direction, the first direction being cocurrent with the second direction.

48. The process of claim 1 wherein the liquid phase is in the form of a contiguous liquid phase flowing in the process microchannel in a first direction, the second fluid phase is in the form of a contiguous fluid phase flowing in a second direction, the first direction being counter current with the second direction.

49-50. (canceled)

51. The process of claim 1 wherein the process is a distillation process and one or more components are separated from a fluid mixture comprising the one or more components, the fluid mixture comprising: ethane from ethylene; styrene and ethylbenzene; oxygen and nitrogen; cyclohexane and cyclohexanol and/or cyclohexanone; isobutane and gasoline; hexane and cyclohexane; benzene and toluene; methanol and water; or isopropanol and isobutanol.

52-56. (canceled)

57. The process of claim 1 wherein the superficial velocity of the liquid phase is at least about 0.1 m/s.

58-59. (canceled)

60. The process of claim 1 wherein the process comprises a distillation process, absorption process, stripping process, rectification process, or a combination of two or more thereof.

61. The process of claim 1 wherein the liquid phase and/or the second fluid phase comprises one or more mass transfer catalysts.

62-69. (canceled)

70. A process for contacting a liquid phase and a second fluid phase, comprising:
flowing the liquid phase in a process microchannel in contact with surface features in the form of depressions in and/or projections from one or more interior walls of the process microchannel, the contacting of the surface features with the liquid phase imparting a disruptive flow to the liquid phase;
flowing the second fluid phase in the process microchannel; and
contacting the liquid phase with the second fluid phase in the process microchannel, and transferring at least part of the second fluid phase to the liquid phase.

71. A process for contacting a liquid phase and a second fluid phase, comprising:
flowing the liquid phase and/or second fluid phase in a process microchannel in contact with surface features in the process microchannel, the superficial velocity of the liquid phase being at least about 0.1 m/s, the contacting of the surface features with the liquid phase and/or the second fluid phase imparting a disruptive flow to the liquid phase and/or second fluid phase;
contacting the liquid phase with the second fluid phase in the process microchannel; and
transferring mass from the liquid phase to the second fluid phase and/or from the second fluid phase to the liquid phase.

72. A process for contacting a liquid and a second fluid, comprising:
flowing a mixture of the liquid and the second fluid in a process microchannel in contact with surface features in the process microchannel, the contacting of the surface features with the liquid and the second fluid imparting a disruptive flow to the liquid and the second fluid; and
transferring mass from the liquid to the second fluid and/or from the second fluid to the liquid.

73. A process for contacting a liquid and a second fluid, comprising:
flowing a mixture of the liquid and the second fluid in a process microchannel in contact with surface features in the process microchannel, the contacting of the surface features with the liquid and the second fluid imparting a disruptive flow to the liquid and second fluid;
transferring mass from the liquid to the second fluid and from the second fluid to the liquid; and
removing separate streams from the process microchannel, one of the separate streams comprising the liquid, and one of the separate streams comprising the second fluid.
